(19) United States
(12) Patent Application Publication
(10) Pub. No.: US 2013/0060516 A1
(43) Pub. Date: Mar. 7, 2013

(54) TRACE-GENERATING DEVICES AND METHODS THEREOF

(71) Applicants: Yin-Chen CHANG, Hsinchu County (TW); Hsiu-Ping Lin, Taipei City (TW)

(72) Inventors: Yin-Chen CHANG, Hsinchu County (TW); Hsiu-Ping Lin, Taipei City (TW)

(21) Appl. No.: 13/226,477

(22) Filed: Sep. 6, 2011

(51) Int. Cl. G06F 15/00; G01C 19/00; G01C 17/00

(52) U.S. Cl. 702/151

(57) ABSTRACT

A trace-generating device for generating information on trace of motion is disclosed. The device comprises a first module to calculate an initial roll angle (φ) and an initial pitch angle (θ) in response to an output of an accelerometer, a second module to calculate an initial magnetic vector (\vec{m}ₙ) corresponding to a navigation frame of a controlled device located remote to the device in response to an output of an electronic compass, the initial roll angle and the initial pitch angle, and a third module to calculate an estimated pitch angle and an estimated yaw angle in response to the output of the accelerometer, the output of the electronic compass, the initial roll angle and the initial pitch angle from the first module, and the initial magnetic vector from the second module.

### FIELD OF THE INVENTION

The present invention is related to a type of input or control device. In particular, the present invention relates to a type of device and method of processing signals detected by sensory elements to calculate/generate traces of movement.

### BACKGROUND OF INVENTION

For devices having either simple applications or complicated operating systems, such as computer, notebook, Information Appliance, TV gamer, or handheld devices, such as cellular phone, navigator, PDA, portable media player, E-Book, WebPad, walkman, MP3 player, handheld gamer or electronic dictionary, methods for inputting information or controlling the devices have been an important part of the human interface between the devices and the users. Furthermore, perhaps due to inherent limitations of the devices (e.g., the sizes of the devices or the screens of the devices, manufacturing cost or portability), different methods and applications for controlling or inputting information into the different devices have been developed. For example, the commonly used methods for controlling and inputting information into the devices mentioned above may include: performing the start/control/switch functions with predetermined buttons on a remote; using a trackball, a mouse or a joystick to move a cursor on a screen and/or select an option; using a keyboard alone or in combination with a character input method to enter a character/word for display on the screen; or using a touch panel to select an option, move a cursor, or enter information including character input.

In addition, for computers and notebooks, there has been a long history of using a mouse or a keyboard in combination with character input methods as the method for controlling and inputting information into the computers and notebooks. However, in the case of inputting information, such method, in comparison to the writing techniques we've learned since childhood, the handwriting method for inputting information may closer to our learning experiences, and our writing habit. Furthermore, with the method of handwriting, it is not necessary for the user to learn different input methods associated with the computers or notebook in advance (for example, for those desired to use Cangjie as the input method will have to first learn the characters, radical and strokes of the corresponding Cangjie code).

In order to solve the aforementioned problems related to using or setting up keyboards or mouse, well-known methods using touch panel related technology to allow users to press buttons displayed on the touch panel and using handwriting recognition technology to convert input received from the touch panel into characters have been developed. For example, with a cellular phone that has a touch panel, a user may cause the phone to perform specific functions by touching the buttons shown in the screen, through a keyboard shown in the screen (which may include phonics for inputting Chinese character or alphabets for inputting English), or through an area on the screen provided to allow information be handwritten into the phone. Furthermore, the handwritten signals processed by known handwriting recognition techniques are signals in the form of series of coordinates sequences, which result from a user writing on a board or a screen (touch panel) with a finger or a pen. In the known techniques, these coordinates are sampled from the traces of the movements of the finger or the point of the pen. In addition to the X-Y coordinates information, each coordinates sequence may also include the starting and ending point of each trace made by the finger or the point of the pen, and thus the number of strokes written may be determined. Moreover, according to known techniques, the processing of the aforementioned handwriting signals may comprise the step of removing the noise and repeating points or performing a smoothing or size normalization function to the strokes, in order to reduce variation in the handwritten characters. Known handwriting recognition techniques may then perform feature extraction, such as using the shape of the periphery of the input characters to interpret illegible strokes, so that the handwriting recognition techniques may interpret the differences in the strokes that are due to the different writing habit of each user. In addition, known techniques can also use the context before and after, language model or basic probability theories to increase the successful recognition rate of characters, so as to successfully convert handwritings into the corresponding character code for output.

In these examples of well-known techniques, a user may use a computer or a notebook that has a touch panel or a writing pad coupled to the computer or the notebook to input a character or symbol with a finger or a pen. Furthermore, well-known handwriting recognition techniques may allow a user to convert the user's personal handwriting into characters (for example, computer text) through the handwriting recognition technique. Also, through artificial intelligence technologies, the computer or the notebook may learn the personal handwriting in order to increase the recognition rate of the user's handwriting. Such method will allow the user to input information or communicate with the computer or notebook using methods that come more natural to the user.

However, for certain devices, the information input method provided by the above-mentioned technology may not be suitable. Certain devices may be inherently unsuitable for use with keyboards, mouse or touch panels. For example, handheld devices may be limited by its size, and cannot use touch panels with large surface area. This often leads to the problem of the area for receiving the user's handwriting input or key selection input on the displayed keyboard being too small. In order to provide an area with a size appropriate for receiving the user's handwriting input or key selection input on the displayed keyboard, the size of the screen (touch panel) is limited.

In addition, when a microcontroller executes a handwriting recognition software to interpret the received input, the handwriting recognition rate would decrease as the area provided for receiving the user's handwriting input decreases. In other words, the handwriting technology will require higher recognition rate by, for example, using higher number of bits to process the information, or using more computing power to compare the strokes in the database in order to find the matching character. Therefore, when an area for receiving user input is too small, it may cause additional overhead on the application of the technology, recognition error, additional time for performing recognition or additional cost for other software and hardware.

It should be noted that the same problem encountered by the aforementioned techniques may also occur in other handheld devices such as navigation device, personal digital assistant, portable media player, e-book reader, portable computer screen, handheld gaming device or electronic dictionary.

In addition, certain information appliances or devices may be inherently unsuitable for installing keyboards, mouse or large area touch panel thereon due to their designs. For example, for audio-visual equipments, such as a liquid crystal television or a plasma television, a touch panel may not be a good method for inputting information, because such audio-visual equipments are generally positioned at a distance from the user and such distance would cause inconveniences for the user to operate the input device. For example, when a user is watching TV, the user would have to get off the sofa and walk to the TV in order to have “contact” with the touch panel of the TV, interact with the touch panel of the TV or input information using the touch panel. Furthermore, coupling or setting up communication between wired or wireless keyboard or mouse and the TV is also not an ideal method, because space in the living room will be needed to place the mouse and/or keyboard, and the fun factor of the audio-visual equipment will be greatly reduced due to the use of the mouse or keyboard for inputting information. In addition, large area touch panel having the size of a liquid crystal television or a plasma television may inherently have obstacles in cost and yield.

In addition, if a device (such as certain audio-visual device) may only be connected to one projection module or projector as its display device, or may only use its built-in projection module as its display device, it may not be possible to configured the device with a touch panel to allow users to enter information.

Prior art also provides methods of utilizing handwriting recognition technology in a remote comprising input interface. For example, the patent titled “remote control”, Republic of China Patent No. 1236239, or the patent application titled “remote control system for multi-media devices and method thereof”, Republic of China Patent Publication No. 200709073, have disclosed a multi-media control device or a remote (such as a TV remote) comprising a handwriting recognition device. However, such remote control device or remote control may have the same problem encountered by the aforementioned handheld devices (such as the area for input is not large enough, must install touch panel or writing board on the remote, or may be inconvenient to use).

Moreover, keyboard, mouse or handwriting recognition technology via touch panel may be unsuitable for inputting information into certain applications. For example, for a computer in a car, it may be difficult for the driver to use a touch panel to input characters (for example, to enter keywords in a search field on a navigation page, or to enter a web address). Furthermore, the driver may become distracted when trying to enter information on the touch panel and be prone to get into a car accident.

The aforementioned known technology may be inconvenient for some of those with disabilities. For example, some people with disability may have no fingers, thus may not be able to press certain buttons on the keyboard or provide input through a touch panel. Under such circumstances, the aforementioned methods provided by known technology may not be suitable.

Therefore, a system and a method that does not require the user to have physical contacts with the screen but can directly sense a trace in the space may be needed, in order to solve the aforementioned problems.

In addition, related control techniques may be applied to controllers for TV gaming devices or joysticks/3D mouse for playing online games.

In addition to the above, how to accurately sense the trace of an object or a device when the object or the device is moving in a space has been a subject focused by researchers in the field of Human Interface Device.

Prior art such as U.S. Pat. No. 7,414,611 to Liberty discloses a 3D pointing device with orientation compensation. The device, besides using an accelerometer, also requires using at least one rotational sensor to achieve orientation compensation. In order to achieve the orientation compensation, the prior art requires at least two uniaxial rotational sensor, such as two uniaxial yaw gyroscopes configured to be perpendicular with respect to each other (see specification and figures of U.S. Pat. No. 7,414,611), in order to detect the changes in the yaw and pitch angles of the 3D pointing device. In order to achieve even more accurate orientation compensation, the prior art may use a three-axis gyroscope to sense changes in the yaw, pitch and roll angles of the 3D pointing device, in order to determine compensation amount and achieve the goal of orientation compensation.

However, whether using the aforementioned two uni-axial yaw gyroscopes or a single biaxial gyroscope or a single three-axis gyroscope, the cost for the 3D pointing device will increase.

Therefore, it may be necessary to provide a trace-generating device and a method that can achieve orientation compensation for sensing traces of the movements of a human interface device (such as a mouse, a controller, a remote or a cellular phone) without using a gyroscope or using only a single uni-axial gyroscope, which costs relatively less than a biaxial gyroscope or a three-axis gyroscope.

### SUMMARY OF THE INVENTION

Examples of the present invention provides a trace-generating device for generating information on trace of motion. The device comprises a first module to calculate an initial roll angle (φ) and an initial pitch angle (θ) in response to an output of an accelerometer, a second module to calculate an initial magnetic vector (\vec{m}ₙ) corresponding to a navigation frame of a controlled device located remote to the device in response to an output of an electronic compass, the initial roll angle and the initial pitch angle, and a third module to calculate an estimated pitch angle and an estimated yaw angle in response to the output of the accelerometer, the output of the electronic compass, the initial roll angle and the initial pitch angle from the first module, and the initial magnetic vector from the second module.

Some examples of the present invention also provides a trace-generating device for generating information on trace of motion. The device comprises a first module configured to calculate an initial roll angle (φ) and an initial pitch angle (θ) in response to an output of an accelerometer, a second module configured to calculate an initial magnetic vector (\vec{m}ₙ) corresponding to a navigation frame of a controlled device located remote to the device in response to an output of the electronic compass, the initial roll angle and the initial pitch angle, and a third module configured to calculate an estimated pitch angle and an estimated yaw angle in response to an output of a 1-D gyroscope, the output of the accelerometer, the output of the electronic compass, the initial roll angle and the initial pitch angle from the first module and the initial magnetic vector from the second module.

### BRIEF DESCRIPTIONS OF THE DRAWINGS

FIG. 1A is a block diagram of a trace-generating device according to an example of the present invention.

FIG. 1B is a block diagram of a control/input information system having the trace-generating device applied therein according to an example of the present invention.

FIG. 1C is a block diagram of a control/information input system having the trace-generating device applied therein according to yet another example of the present invention.

FIG. 2 is a schematic diagram of coordinate conversion when the trace-generating device is applied to a control/information input system according to an example of the present invention.

FIG. 3A is a block diagram of the trace-calculating module according to an example of the present invention.

FIG. 3B is a plot comparing the measured and actual accelerations in the X_{b} axis direction according to an example of the present invention.

FIG. 3C is a plot comparing the measured and the actual accelerations in the Y_{b} axis direction according to an example of the present invention.

FIG. 3D is a plot comparing the measured and the actual accelerations in the Z_{b} axis direction according to an example of the present invention.

FIG. 3E is a plot comparing the measured and the actual terrestrial magnetisms in the X_{b} axis direction according to an example of the present invention.

FIG. 3F is a plot comparing the measured and the actual terrestrial magnetisms in the Y_{b} axis direction according to an example of the present invention.

FIG. 3G is a plot comparing the measured and the actual terrestrial magnetism in the Z_{b} axis direction according to an example of the present invention.

FIG. 3H is a plot comparing the estimated and the actual terrestrial magnetism in the X_{b} axis direction according to an example of the present invention.

FIG. 3I is a plot comparing the estimated and the actual terrestrial magnetisms in the Y_{b} axis direction according to an example of the present invention.

FIG. 3J is a plot comparing the estimated and the actual terrestrial magnetism in the Z_{b} axis direction according to an example of the present invention.

FIG. 3K is a plot comparing the estimation error and the measurement error of terrestrial magnetism in the X_{b} axis direction according to an example of the present invention.

FIG. 3L is a plot comparing the estimation error and the measurement error of terrestrial magnetism in the Y_{b} axis direction according to an example of the present invention.

FIG. 3M is a plot comparing the estimation error and the measurement error of terrestrial magnetism in the Z_{b} axis direction according to an example of the present invention.

FIG. 3N is a plot comparing the estimated acceleration in the X_{b} axis direction estimated by a Kalman Filter of the present invention and the actual acceleration in the X_{b} axis direction.

FIG. 3O is a plot comparing the estimated acceleration in the Y_{b} axis direction estimated by the Kalman Filter of the present invention and the actual acceleration in the Y_{b} axis direction.

FIG. 3P is a plot comparing the estimated acceleration in the Z_{b} axis direction estimated by the Kalman Filter of the present invention and the actual acceleration in the Z_{b} axis direction.

FIG. 3Q is a plot comparing the measurement error and the estimation error of acceleration in the X_{b} axis direction according to an example of the present invention.

FIG. 3R is a plot comparing the measurement error and the estimation error of acceleration in the Y_{b} axis direction according to an example of the present invention.

FIG. 3S is a plot comparing the measurement error and the estimation error of acceleration in the Z_{b} axis direction according to an example of the present invention.

FIG. 3T is a plot comparing the estimated and actual bias of the accelerometer in the X_{b} axis direction according to an example of the present invention.

FIG. 3U is a plot comparing the estimated and actual scaling factors of the accelerometer in the X_{b} axis direction according to an example of the present invention.

FIG. 3V is a plot comparing the estimated and actual bias of the electronic compass in the X_{b} axis direction according to an example of the present invention.

FIG. 3W is a plot comparing the estimated and actual scaling factors in the X_{b} axis direction of the electronic compass according to an example of the present invention.

FIG. 3X is a plot comparing the estimated yaw angle calculated by the Kalman Filter according to an example of the present invention to the actual yaw angle.

FIG. 3Y is a plot comparing the estimated pitch angle calculated by the Kalman Filter according to an example of the present invention to the actual pitch angle.

FIG. 3Z is a plot comparing the estimated roll angle calculated by the Kalman Filter according to an example of the present invention to the actual roll angle.

FIG. 3a is a plot comparing the trace converged from the Kalman Filter of an example of the present invention to the actual trace of the input device 288.

FIG. 4A is a block diagram of a trace-calculating module according to an example of the present invention.

FIG. 4B is a plot comparing the measured and the actual acceleration in the X_{b} axis direction according to an example of the present invention.

FIG. 4C is a plot comparing the measured and the actual accelerations in the Y_{b} axis direction according to an example of the present invention.

FIG. 4D is a plot comparing the measured and the actual accelerations in the Z_{b} axis direction according to an example of the present invention.

FIG. 4E is a plot comparing the measured and the actual terrestrial magnetisms in the X_{b} axis direction according to an example of the present invention.

FIG. 4F is a plot comparing the measured and the actual terrestrial magnetisms in the Y_{b} axis direction according to an example of the present inventions.

FIG. 4G is a plot comparing the measured and the actual terrestrial magnetisms in the Z_{b} axis direction according to an example of the present invention.

FIG. 4H is a plot comparing the measured and the actual roll angles about the X_{b} axis according to an example of the present invention.

FIG. 4I is a plot comparing the estimated and the actual terrestrial magnetisms in the X_{b} axis direction according to an example of the present invention.

FIG. 4J is a plot comparing the estimated and the actual terrestrial magnetisms in the Y_{b} axis direction according to an example of the present inventions.

FIG. 4K is a plot comparing the estimated and the actual terrestrial magnetisms in the Z_{b} axis direction according to an example of the present invention.

FIG. 4L is a plot comparing the estimation error and the measurement error of terrestrial magnetism in the X_{b} axis direction according to an example of the present invention.

FIG. 4M is a plot comparing the estimation error and the measurement error of terrestrial magnetism in the Y_{b} axis direction according to an example of the present invention.

FIG. 4N is a plot comparing the estimation error and the measurement error of terrestrial magnetism in the Z_{b} axis direction according to an example of the present invention.

FIG. 4O is a plot comparing the estimated acceleration in the X_{b} axis direction estimated by the Kalman Filter according to an example of the present invention to the actual acceleration.

FIG. 4P is a plot comparing the estimated acceleration in the Y_{b} axis direction estimated by the Kalman Filter according to an example of the present invention to the actual acceleration.

FIG. 4Q is a plot comparing the estimated acceleration in the Z_{b} axis direction estimated by the Kalman Filter according to an example of the present invention to the actual acceleration.

FIG. 4R is a plot comparing the measurement error and the estimation error of acceleration in the X_{b} axis direction according to an example of the present invention.

FIG. 4S is a plot comparing the measurement error and the estimation error of acceleration in the Y_{b} axis direction according to an example of the present invention.

FIG. 4T is a plot comparing the measurement error and the estimation error of acceleration in the Z_{b} axis direction according to an example of the present invention.

FIG. 4U is a plot comparing the estimated and actual bias in the X_{b} axis direction of the accelerometer according to an example of the present invention.

FIG. 4V is a plot comparing the estimated and actual scaling factor in the X_{b} axis direction of the accelerometer according to an example of the present invention.

FIG. 4W is a plot comparing the estimated and actual bias in the X_{b} axis direction of the electrical compass according to an example of the present invention.

FIG. 4X is a plot comparing the estimated and actual scaling factors in the X_{b} axis direction of the electrical compass according to an example of the present invention.

FIG. 4Y is a plot comparing the estimated yaw angle calculated by the Kalman filter according to an example of the present invention to the actual yaw angle.

FIG. 4Z is a plot comparing the estimated pitch angle calculated by the Kalman filter according to an example of the present invention to the actual pitch angle.

FIG. 4a is a plot comparing the estimated roll angle calculated by the Kalman filter according to an example of the present invention to the actual roll angle.

FIG. 4b is a plot comparing the trace converged from the Kalman Filter of an example of the present invention to the actual trace of the input device.

FIG. 4c is a 3D plot comparing the trace converged from the Kalman Filter of an example of the present invention to the actual trace of the input device.

FIG. 5A is a block diagram of a control/information input system having the trace-generating device applied therein according to an example of the present invention.

FIG. 5B is a block diagram of an information input system according to another example of the present invention.

FIG. 6A is a block diagram of a control/information input system having the trace-generating device applied therein according to an example of the present invention.

FIG. 6B is a block diagram of a control/information input system having the trace-generating device applied therein according to another example of the present invention.

FIG. 7 is a block diagram of a control/information input system having the trace-generating device applied therein according to an example of the present invention.

FIG. 8 is a block diagram of a control/information input system having the trace-generating device applied therein according to an example of the present invention.

FIG. 9 is a block diagram of a control/information input system having the trace-generating device applied therein according to an example of the present invention.

FIG. 10A is a schematic diagram of a control/information input system having the trace-generating device applied therein according to an example of the present invention.

FIG. 10B is a schematic diagram of the operation of the control/information input system in FIG. 10A.

FIG. 10C is a schematic diagram of another operation of the control/information input system in FIG. 10A.

FIG. 10D is a schematic diagram of applying the trace-generating device to a control/information input system according to an example of the present invention.

FIG. 11A is a schematic diagram of applying the trace-generating device to a control/information input system according to an example of the present invention.

FIG. 11B is a schematic diagram of operating the control/information input system in FIG. 11A.

FIG. 11C is another operational schematic diagram of the control/information input system in FIG. 11A.

FIG. 11D is a schematic diagram of applying the trace-generating device to a control/information input system 800′ according to another example of the present invention.

FIG. 11E is a schematic diagram of applying the trace-generating device to a control/information input system according to yet another example of the present invention.

FIG. 12A is a schematic diagram of the trace-generating device being applied to a control/information input system according to an example of the present invention.

FIG. 12B is a schematic diagram of the operation of the control/information input system.

FIG. 12C is an operation schematic diagram of the control/information input system in FIG. 12A.

FIG. 12D is another schematic diagram of using the trace-generating device in a control/information input system according to an example of the present invention.

FIG. 12E is a schematic diagram of applying the input module in the control/information input system according to an example of the present invention.

FIG. 13A is a schematic diagram of applying the trace-generating device in a control/information input module according to an example of the present invention.

FIG. 13B is a schematic diagram of the operation of the control/information input module in FIG. 13A according to an example of the present invention.

FIG. 13C is a schematic diagram of the operation of the control/information input module in FIG. 13A according to another example of the present invention.

FIG. 14A is a schematic diagram of applying the trace-generating device to a control/information input system according to an example of the present invention.

FIG. 14B is a schematic diagram of the operation of the control/information input system in FIG. 14A according to an example of the present invention.

FIG. 14C is a schematic diagram of the operation of the control/information system in FIG. 14A according to another example of the present invention.

FIG. 15A is a schematic diagram of applying the trace-generating device in a control/information input system according to an example of the present invention.

FIG. 15B is a schematic diagram of the operation of the control/information input system in FIG. 15A according to an example of the present invention.

FIG. 15C is a schematic diagram of the operation of the control/information system in FIG. 15A according to another example of the present invention.

FIG. 16 is a block diagram of applying the trace-generating device to a control/information input system according to an example of the present invention.

FIG. 17 is a block diagram of applying the trace-generating device to a control/information input system according to an example of the present invention.

FIG. 18 is a block diagram of applying the trace-generating device to a control/information input system according to an example of the present invention.

FIG. 19 is a block diagram of applying the trace-generating device to a control/information input system according to an example of the present invention.

FIG. 20 is a block diagram of applying the trace-generating device to a control/information input system according to an example of the present invention.

FIG. 21 is a block diagram of applying the trace-generating device to a control/information input system according to an example of the present invention.

FIG. 22 is a block diagram of applying the trace-generating device in a control/information input system according to an example of the present invention.

FIG. 23A is a schematic diagram of a control/information input system having the trace-generating device applied therein according to an example of the present invention.

FIG. 23B is a schematic diagram of the operation of the control/information input system in FIG. 23A according to an example of the present invention.

FIG. 23C is a schematic diagram of the operation of the control/information input system in FIG. 23A according to another example of the present invention.

FIG. 24A is a schematic diagram of applying the trace-generating device to a control/information input system according to an example of the present invention.

FIG. 24B is a schematic diagram of the operation of the control/information input system in FIG. 20A according to an example of the present invention.

FIG. 24C is a schematic diagram of the operation of the control/information input system in FIG. 24A according to another example of the present invention.

FIG. 25A is a schematic diagram of applying the trace-generating device to a control/information input system according to an example of the present invention.

FIG. 25B is a schematic diagram of the operation of the control/information input system in FIG. 25A according to an example of the present invention.

FIG. 25C is a schematic diagram of the operation of the control/information input system in FIG. 25A according to another example of the present invention.

FIG. 26A is a schematic diagram of applying the trace-generating device to a control/information input system.

FIG. 26B is a schematic diagram of the operation of the control/information input system in FIG. 26A according to an example of the present invention.

FIG. 26C is a schematic diagram of the operation of the control/information input system in FIG. 26A according to another example of the present invention.

FIG. 27A is a schematic diagram of the application of the trace-generating device in a control/information input system.

FIG. 27B is a schematic diagram of the operation of the control/information input system in FIG. 27A according to an example of the present invention.

FIG. 27C is a schematic diagram of the control/information input system in FIG. 27A according to another example of the present invention.

FIG. 28A is a schematic diagram of applying the trace-generating device to a control/information input system according to an example of the present invention.

FIG. 28B is a schematic diagram of the operation of the control/information input system in FIG. 28A according to an example of the present invention.

FIG. 28C is a schematic diagram of the operation of the control/information input system in FIG. 28A according to another example of the present invention.

FIG. 29 is a flow diagram of a method of applying the trace-generating device for controlling/inputting information according to an example of the present invention.

FIG. 30 is a flow diagram of a method of applying the trace-generating device for controlling/inputting information according to another example of the present invention.

FIG. 31 is a flow diagram of a method of applying the trace-generating device for controlling/inputting information according to yet another example of the present invention.

FIG. 32 is a flow diagram of a method of applying the trace-generating device for controlling/inputting information according to still another example of the present invention.

FIG. 33 is a flow diagram of a method of applying the trace-generating device for controlling/inputting information according to yet still another example of the present invention.

FIG. 34 is a flow diagram of a method of applying the trace-generating device for controlling/inputting information according to another example of the present invention.

FIG. 35 is a a flow diagram of a method of applying the trace-generating device for controlling/inputting information according to yet another example of the present invention.

FIG. 36 is a flow diagram of a method of applying the trace-generating device for controlling/inputting information according to still another example of the present invention.

FIG. 37 is a flow diagram of a method of applying the trace-generating device for controlling/inputting information according to yet still another example of the present invention.

FIG. 38 is a flow diagram of a method of applying the trace-generating device for controlling/inputting information according to another example of the present invention.

FIG. 39 is a flow diagram of a method of applying the trace-generating device for controlling/inputting information according to yet another example of the present invention.

FIG. 40 is a flow diagram of a method of applying the trace-generating device for controlling/inputting information according to still another example of the present invention.

FIG. 41 is a flow diagram of a method of applying the trace-generating device for controlling/inputting information according to yet still another example of the present invention.

FIG. 42 is a flow diagram of a method of applying the trace-generating device for controlling/inputting information according to another example of the present invention.

FIG. 43A is a schematic diagram of applying the trace-generating device to a control/information input system according to an example of the present invention.

FIG. 43B is a flow diagram of the operation of the signal processing module 18 of the control/information input system shown in FIG. 43A.

FIG. 44 is a schematic diagram of applying the trace-generating device to a satellite navigation device.

FIG. 45A is a schematic diagram applying the trace-generating device to a wearable airbag protecting system.

FIG. 45B is a schematic diagram of the operation of the wearable airbag protecting system using the trace-generating device according to an example of the present invention.

FIG. 45C is a schematic diagram of the operation of the wearable airbag protecting system using the trace-generating device according to another example of the present invention.

### DETAILED DESCRIPTION

Examples of the present invention will now be described in detail in reference to the figures. Same numbers and symbols are used to denote the same or similar elements in the figures whenever possible.

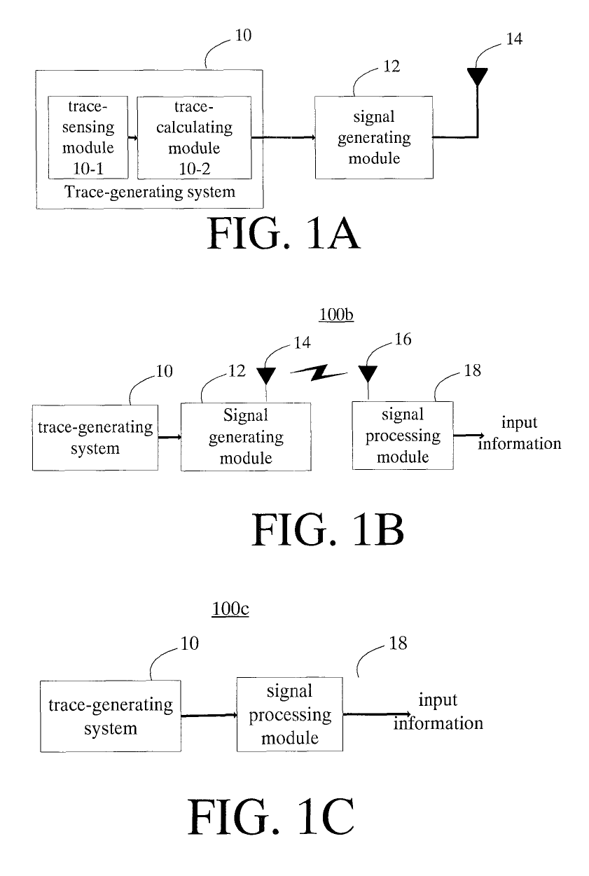

FIG. 1A is a block diagram of a trace-generating device 10 according to an example of the present invention. The trace-generating device 10 may be applied to or arranged on/in a control/input device (e.g., a mouse, a joystick, a controller or a cellular phone). Referring to FIG. 1A, the trace-generating device 10 may include a motion-sensing module 10-1 and a trace-calculating module 10-2. The trace-generating device 10 may be configured to generate trace information by sensing the movements of itself (i.e., the trace-generating device 10 itself). In one example, the trace information may include a set of yaw angle and pitch angle measured at a point of time, or a set of X,Y coordinates converted from the set of yaw angle and pitch angle. Using multiple sets of yaw angles and pitch angles continuously measured over a period of time, the movement of the trace-generating device 10 itself may be described. In one example, the yaw angle and the pitch angle may be converted to X,Y coordinates by calculation.

The motion-sensing module 10-1 may be configured to measure its own (i.e., the motion-sensing module 10-1 itself) state of movement or a force from at least one direction due to the movement of itself or the state of acceleration due to the force. In one example, the motion-sensing module 10-1 may include a micro electro mechanical system (MEMS). The micro electro mechanical system may be configured to sense the movement of the trace-generating device 10. In another example, the micro electro mechanical system may include a MEMS chip, such as an accelerometer, for measuring the magnitude of the accelerations in the X, Y and Z directions due to the force exerted on the micro electro mechanical system or a control/input device (not shown), and sending the values to the trace-calculating module 10-2 for further processing. In one example, the motion-sensing module 10-1 may include at least one of a 2-axis or dual-axis accelerometer and a 3-axis accelerometer for sensing changes in two axes or in three axes of the trace-generating device 10. For specific implementation examples of the accelerometer, one may refer to the MEMS MOVEMENT SENSOR chip, model number LIS331DL by ST Microelectronics. The chip includes a 3-axis accelerometer, which may measure changes in the force experienced in the range of two or eight gravitational accelerations (i.e., between −2g to +2g or −8g to +8g) and separately output the acceleration values in each of the force experiencing directions (directions of the three axis).

The trace-calculating module 10-2 may be configured to calculate the yaw angle and the pitch angle (or further convert them to corresponding X and Y coordinates) based on the magnitude of the accelerations in the X, Y and Z directions measured by the motion-sensing module 10-1.

The trace-generating device 10 may be coupled with a transmit signal generating module 12 and in turn a first antenna 14. The transmit signal generating module 12 may be configure to generate a transmit signal by processing the trace information. In one example, the transmit signal generating module 12 may include a radio frequency signal generating module. The radio frequency generating module 12 may be configured to convert the trace information into a radio frequency signal. In addition, the first antenna 14, coupled with the transmit signal generating module 12, may be configured for transmitting the transmit signal.

In one example, the trace-generating device 10, the transmit signal generating module 12 and the first antenna 14 may be disposed in an input device, a proximal device or a control device (not shown). For example, the input/proximal/control device may include a mouse, a controller, a joystick or a cellular phone. The aforementioned hand-held/proximal devices may communicate with a remote device or a controlled device, so at to transmit/receive packets including information or commands, or to control the remote/controlled device. Furthermore, the remote/controlled device may include at least one of a television (TV), a personal computer (PC), a laptop or a notebook, a digital camera, a camcorder, a projector or a device comprising a a projecting module, a mobile device, a cellular phone, a personal digital assistant (PDA), a navigator, a media player, an E-Book reader, a WebPad, an information appliance, a walkman or an MP3 player, a TV gaming console, a handheld gaming console, an electronic dictionary and a computer in a car.

FIG. 1B is a block diagram of a control/input information system 100b having the trace-generating device 10 applied therein according to an example of the present invention. Referring to FIG. 1B, in addition to the trace-generating device 10, transmit signal generating module 12 and the first antenna 14, the control/information input system 100b may further include a second antenna 16 and a signal processing module 18. The second antenna 16 may be coupled with the signal processing module 18 for receiving the transmit signal transmitted by the first antenna 14 and send the received transmit signal to the signal processing module 18. The signal processing module 18 may be disposed in the aforementioned remote/controlled device, and may be configured to generate input information by processing the received transmit signal. In one example, the input information may include a control command which corresponds to changes of a trace of a movement (changes in the yaw and pitch angles or the XY coordinates) within a period of time. The control command may be, for example, a fast forward/slow movement/play/volume control command from a controller, or a stroke that may be processed using handwriting recognition at a later stage. In one example, interpreting simple traces of movements may be applied to performing simple controls of remote/controlled devices. For example, when the trace-generating device 10 of the present invention is applied to a controller, and the controlled device, such as the signal processing module 18 in a box on a television, determines that two repeating traces to the right have been received, the signal processing module 18 may interpret the received two repeating traces as a control operation by the user of the controller indicating the desire to switch the channel. In the example above, the input information may be used as a channel switching command. In another example, signal processing module 18 may be configured to interpret a single or multiple strokes represented by the changes in the traces of the movements, and provide characters that may correspond to the single or multiple strokes as input information.

In one example, once the input information has been processed by a display driving module of the remote/controlled device described above, the input information may be displayed on a display of the remote/controlled device in the form of a trace or a trace of a movement.

In one example, a user may move the input/proximal/control device to cause the trace-generating device 10 to detect the traces of the movements, and convert the traces into trace information, such as a set of yaw angles and pitch angles or X,Y coordinates measured at different times. Subsequently, the transmit signal generating module 12 converts the trace information into a transmit signal, and sends the transmit signal to the signal processing module 18 by having the first antenna 18 transmit the transmit signal and the second antenna 16 receive the transmit signal. The signal processing module 18 may process the received transmit signal and identify the corresponding control command, in order to control the remote/controlled device. For example, the input/proximal/control device may be a controller, and the remote/controlled device may be a media player. Through appropriate configuration or design, when the user moves the controller to the left, the trace of movement/trace to the left detected by the trace-generating device 10 may be identified by the signal processing module 18 as the user trying to cause the media player to reverse/rewind/slow down. By analogy, one skilled in the art may easily understand other control options (such as fast forwarding/forwarding/stop/play/selecting song title) may be implemented using the same or similar mechanism by appropriately configuring the control/information input system 100b of the present invention. Therefore, the details will be omitted here.

In another example, the user may move the trace-generating device 10 according to his way of writing characters or symbols for inputting information (such as when the user desires to input character or symbols or move the cursor). For example, the trace-generating device 10 may be moved as the user writes each stroke of a character. Subsequently, the trace-generating device 10 may detect the traces of movements of the user writing the strokes, process and convert the traces into digital information and send the digital information to the transmit signal generating module 12. Subsequently, the transmit signal generating module 12 may convert the digital information related to the strokes into a transmit signal, and send the transmit signal to the remote second antenna 16 via the first antenna 14. After the remote second antenna 16 receives the signal, the second antenna 16 sends the received signal to the signal processing module 18. The signal processing module 18 may then perform signal processing on the digital information related to the strokes carried in the transmit signal, in order to restore the strokes. Subsequently, the signal processing module 18 may use all the strokes (or in some cases, only one stroke) within this segment of information input to identify characters that may possibly correspond to the strokes using hand-writing recognition technology (or display multiple characters that may correspond to the strokes for the user to select). In another example, the signal processing module 18 may: process the digital information, which are related to the strokes and carried in the transmit signal, in order to restore the strokes; interpret each stroke using hand-writing recognition technology; and display multiple characters that may possibly correspond to the strokes, in view of the strokes that had already been input, for the user to select.

FIG. 1C is a block diagram of a control/information input system 100c having the trace-generating device 10 applied therein according to yet another example of the present invention. Referring to FIG. 1C, the control/information input system 100c may be similar to the control/information input system 100b illustrated in FIG. 1B, except that the trace-generating device 10 and signal processing module 18 are wired together. In one example, the trace-generating device 10 may be disposed in a mouse or a joy stick, and be connected to the signal processing module 18 of a main device (such as a personal computer or a notebook computer) via wire (such as USB cable and connectors) for performing the aforementioned control or input.

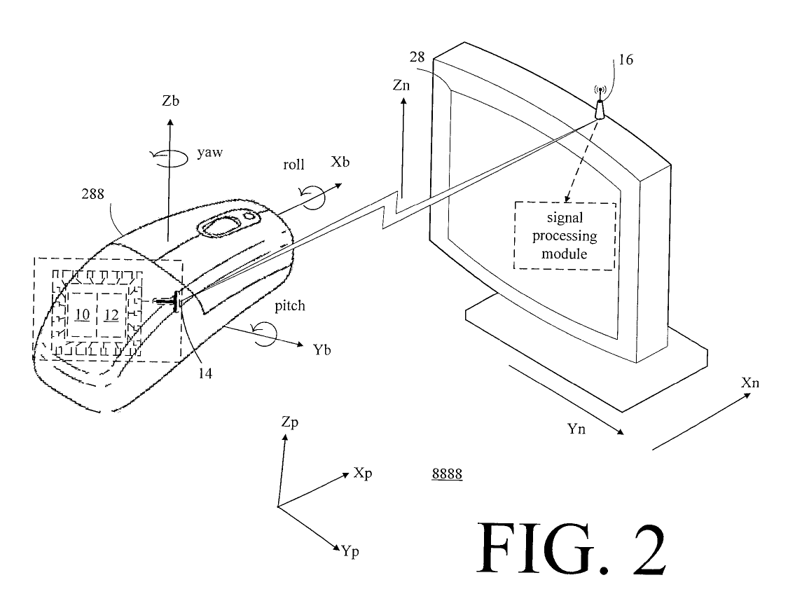

FIG. 2 is a schematic diagram of coordinate conversion when the trace-generating device 10 is applied to a control/information input system 8888 according to an example of the present invention. Referring to FIG. 2, the control/information input system 8888 may include an input/proximal/control device 288 (referred to as “input device 288” hereon) and a remote/controlled device 28. In this example, the input device 288 may include a three-dimensional (3D) positioning device, such as a 3D mouse, a controller, a joystick or a cellular phone. The remote/controlled device 28 may include at least one of a television, a desktop computer, a notebook computer, a digital camera, a camcorder, a projector or a device with a projecting module, a mobile device, a personal digital assistant, a navigator, a media player, a E-book reader, a portable computer display, an information appliance, a portable music player, a TV gaming console, a hand-held gaming console, an electronic dictionary and a computer in a car. Television will be used as an example in this example (the remote/controlled device will be referred to as “television 28” hereon). The frame of reference used in the control/information input system 8888 may include a body frame, a navigation frame and a pseudo frame (not shown). The body frame may be used for describing the movement (path or trace) of the input device 288 in space, and the navigation frame may be used for describing the trace displayed in the television 28. The body frame may be defined by an X_{b} axis, a Y_{b} axis and a Z_{b} axis. The X_{b} axis may describe the direction pointing at or away from the display of the television 28, the Y_{b} axis may describe the left and right directions of the input device 288, and the Z_{b} axis may describe the direction perpendicular to the X_{b} axis and the Y_{b} axis. The navigation frame may include an Xₙ axis, a Yₙ axis and a Zₙ axis. The Xₙ axis may describe the direction that is parallel to the ground and perpendicular to the surface of the display (assuming the display is perpendicular to the ground), the Zₙ axis may describe the direction perpendicular to the ground, and the Yₙ axis may describe the direction perpendicular to the Xₙ axis and the Zₙ axis.

In addition, since the input device 288 is a hand-held device, a user holding the input device 288 may not so hold the device that the Y_{b} axis of its body frame is precisely parallel to the ground. Therefore, the trace-calculating module 10-2 of the present invention may convert the body frame into a pseudo frame including an Xₚ axis, a Yₚ axis and a Zₚ axis, so that the Yₚ axis of the converted pseudo frame may be substantially parallel to the ground. Moreover, one skilled in the art may easily understand that when the trace-generating device 10 of the present invention is being implemented, the Xₚ axis or the Xₙ axis does not need to be precisely perpendicular (pointing) to the display, the Yₚ axis or the Yₙ axis does not need to be precisely parallel to the ground or the Zₚ axis or the Zₙ axis does not need to be precisely perpendicular to the ground. The purpose of having the Yp axis or the Yₙ axis to be substantially parallel to the ground is so that the frame of reference of the trace information generated by the trace-generating device 10 and the traces of movements displayed on the display of the television 28 are substantially the same (since when in use, the Xₚ axis or the Xₙ axis may be substantially perpendicular to the display, the Yₚ axis or the Yₙ axis may be substantially parallel to the ground and the Zₚ axis or the Zₙ axis may be substantially perpendicular to the ground), so that the trace generated from the movement of the input device 288 may be more accurately reflected on the display. Therefore, if the Yₚ axis or the Yₙ axis is only substantially parallel to the ground, but not precisely parallel to the ground, a trace substantially the same as the movement may be reflected on the screen. Thus, whether or not the Xₚ axis or the Xₙ axis is precisely perpendicular (pointing) to the display, the Yₚ axis or the Yₙ axis is precisely parallel to the ground or the Zₚ axis or the Zₙ axis is precisely perpendicular to the ground should not be a limit of the present invention.

Referring to the X_{b} axis, Y_{b} axis and Z_{b} axis of the body frame: roll angle φ may be defined as the rotation angle (in reference to or about) the X_{b} axis, for representing the rotation of the input device 288; pitch angle θ may be defined as the rotation angle (in reference to or about) the Y_{b} axis, for representing the forward and back tilt of the input device 288; and yaw angle Ψ may be defined as the rotation angel (in reference to or about) the Z_{b} axis, for representing the left and right swaying movements of the input device 288.

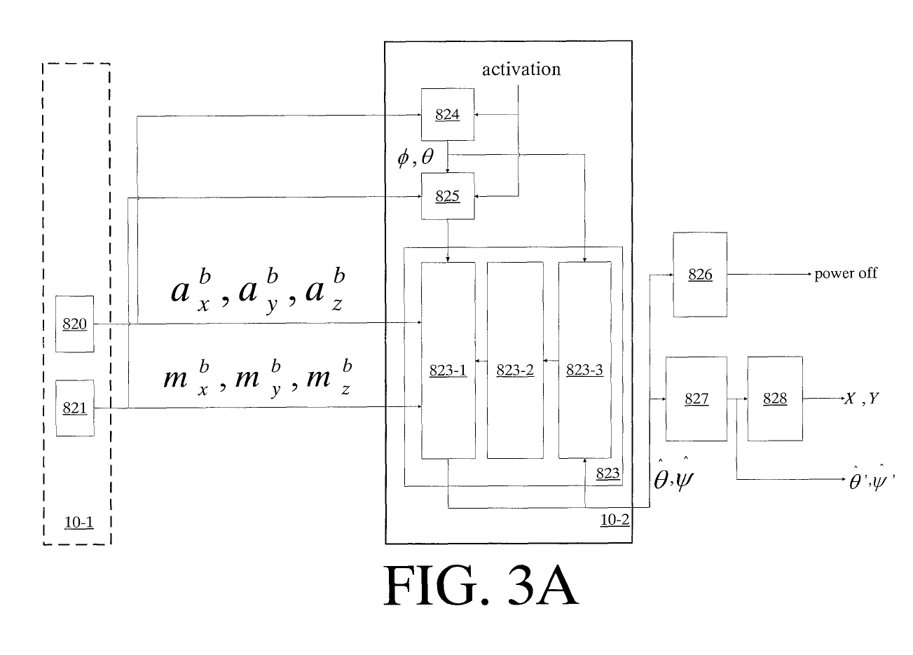

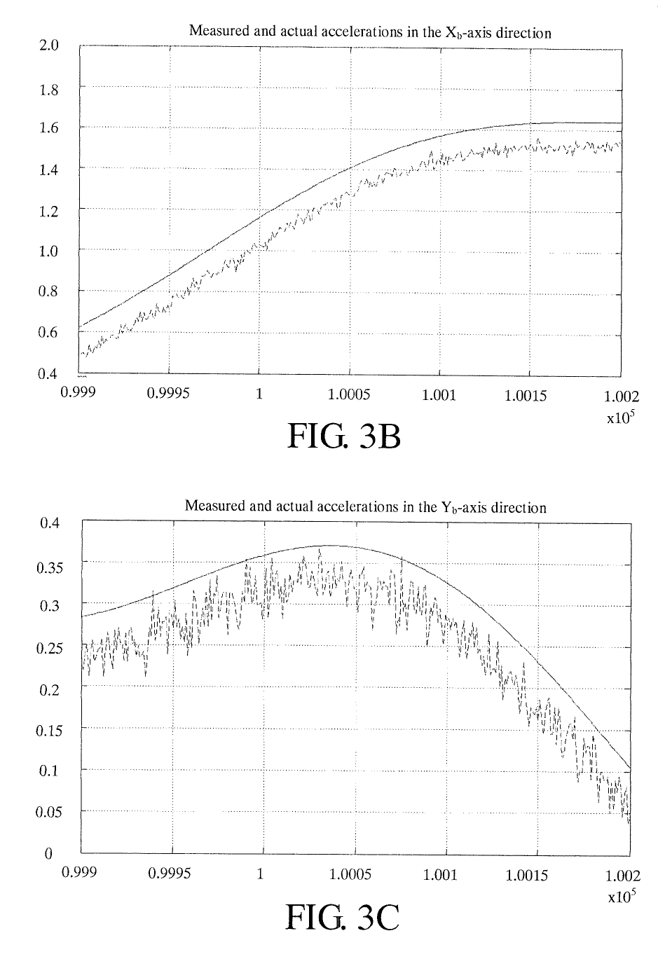

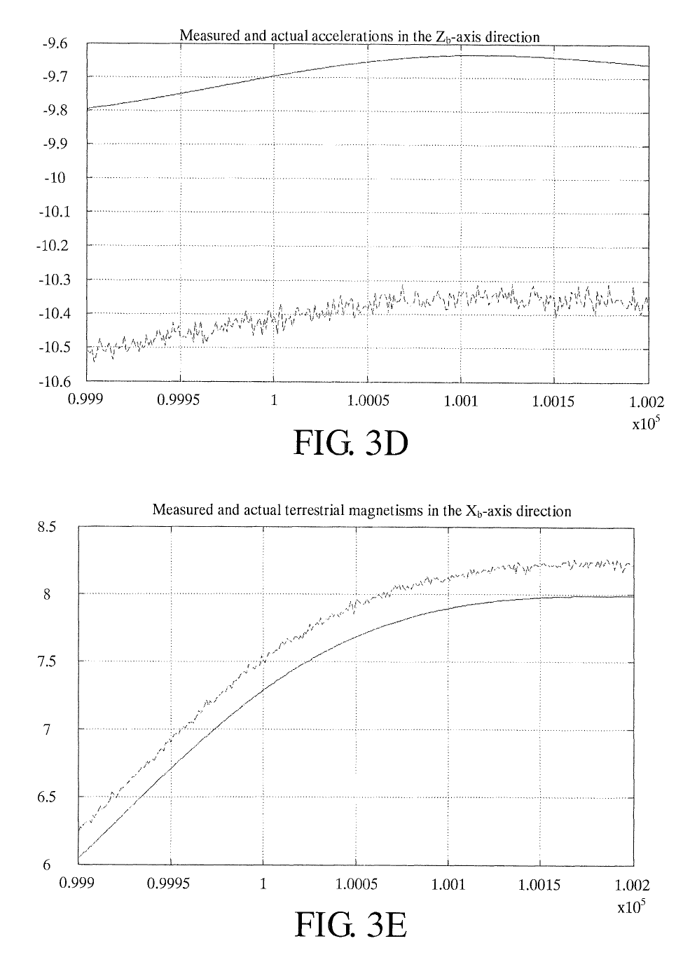

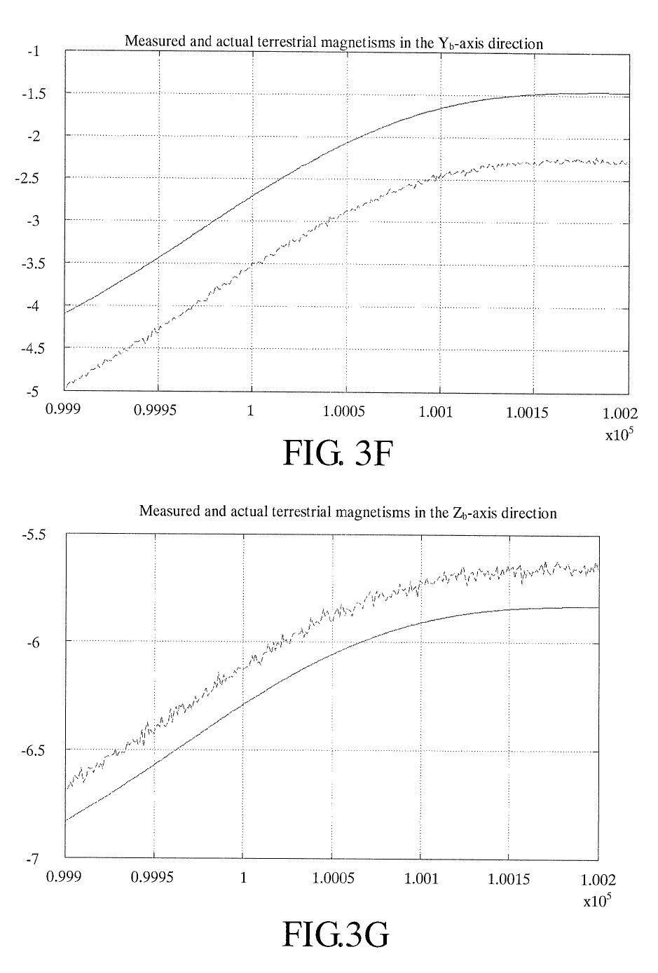

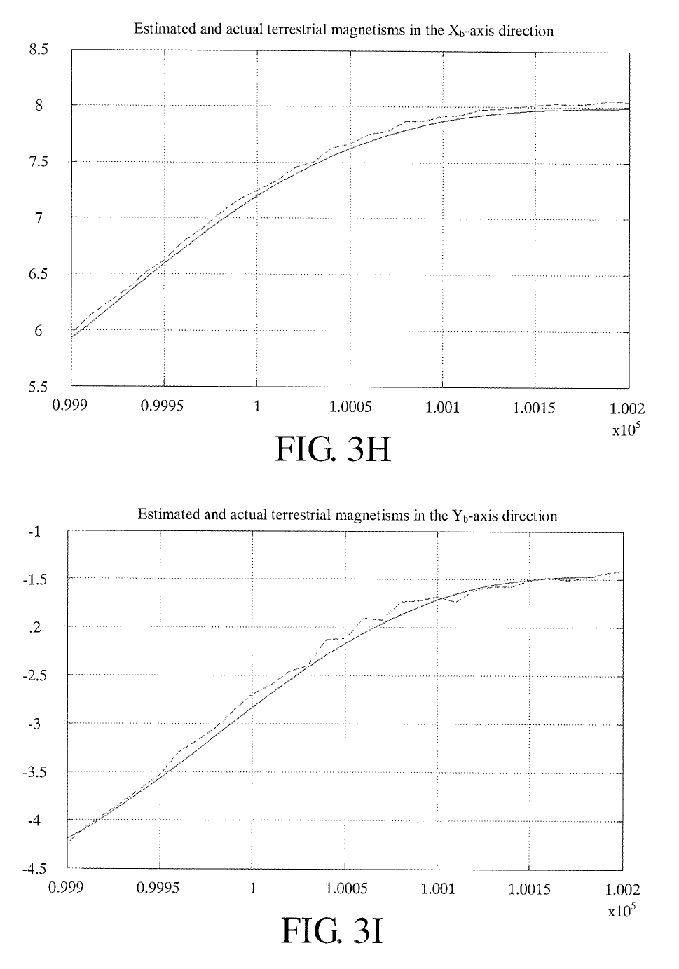

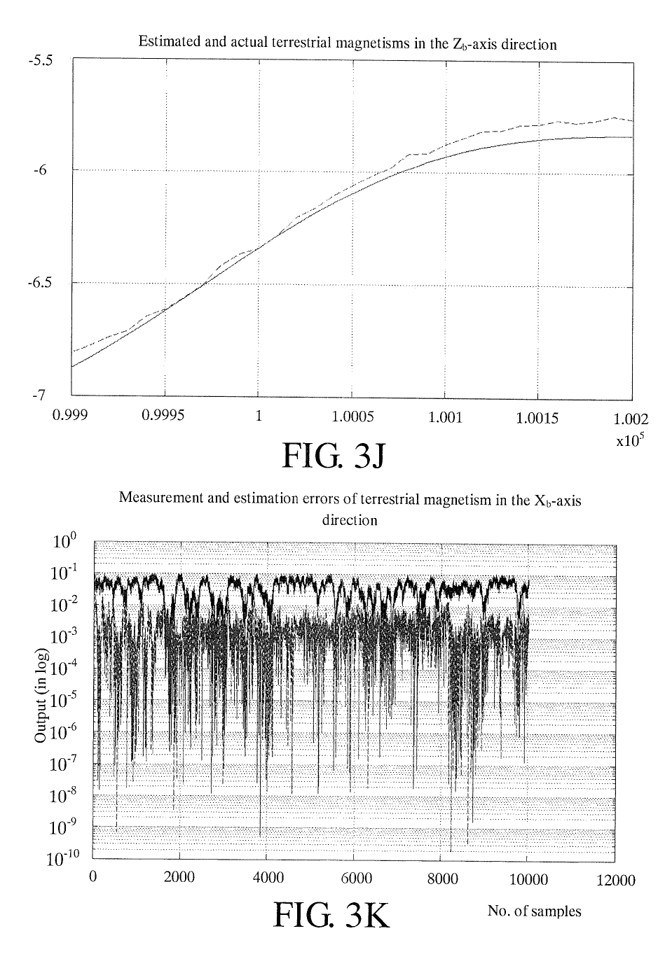

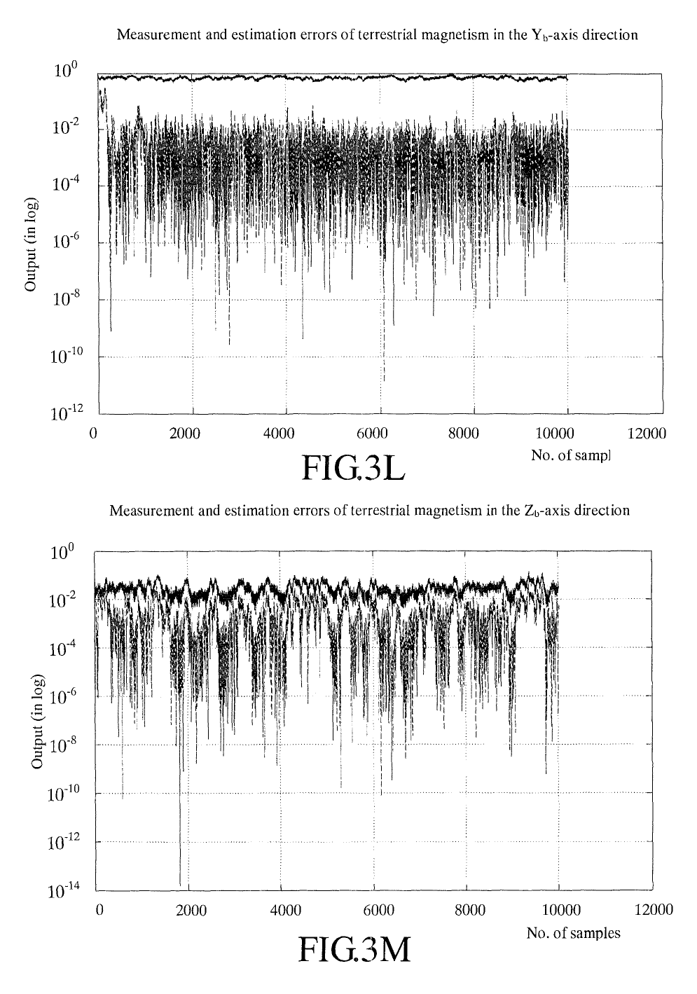

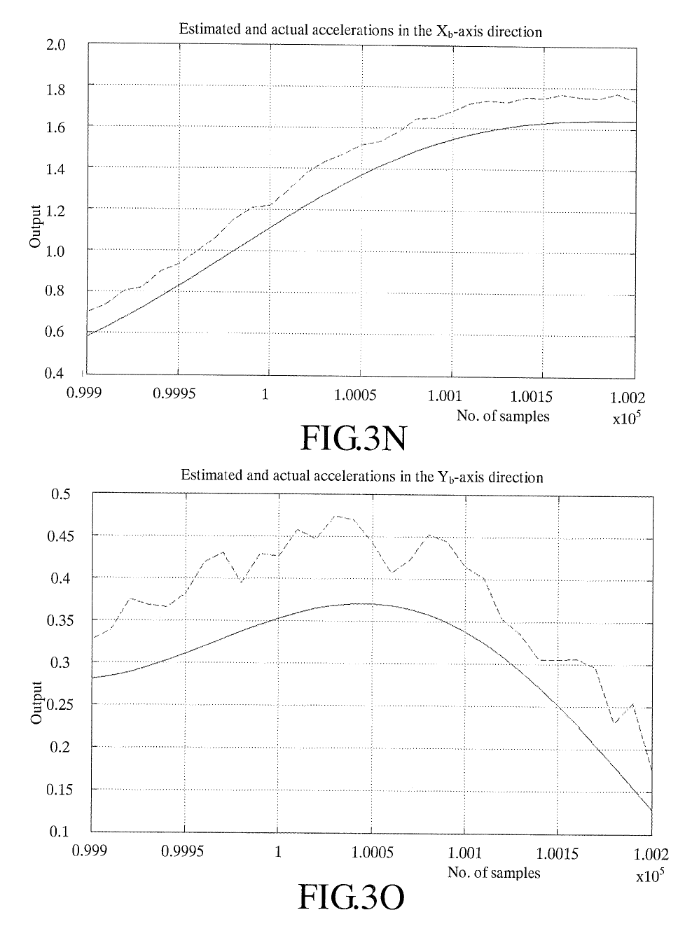

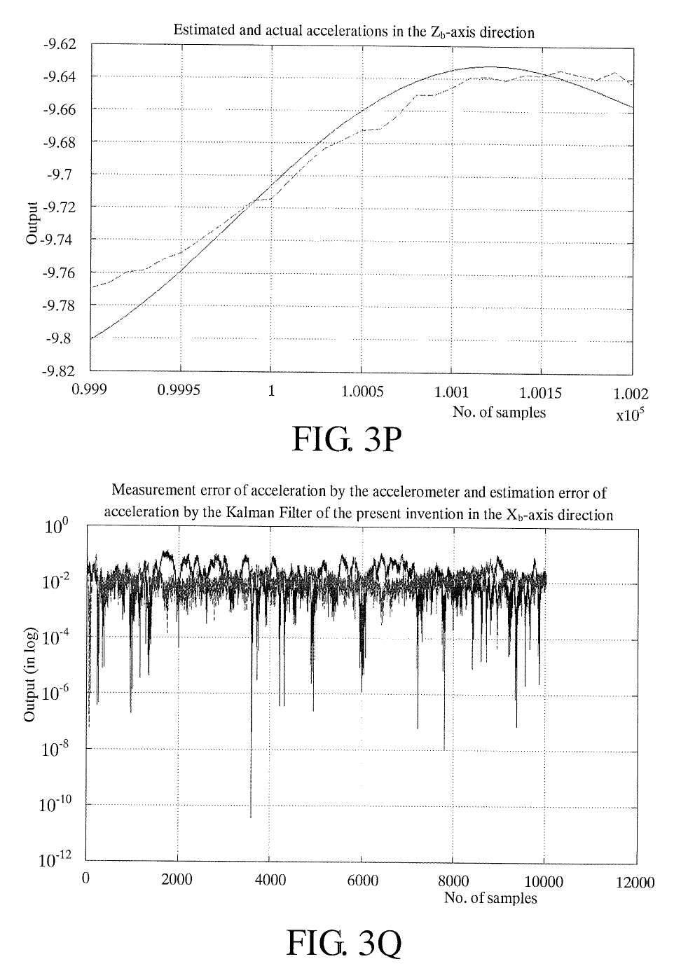

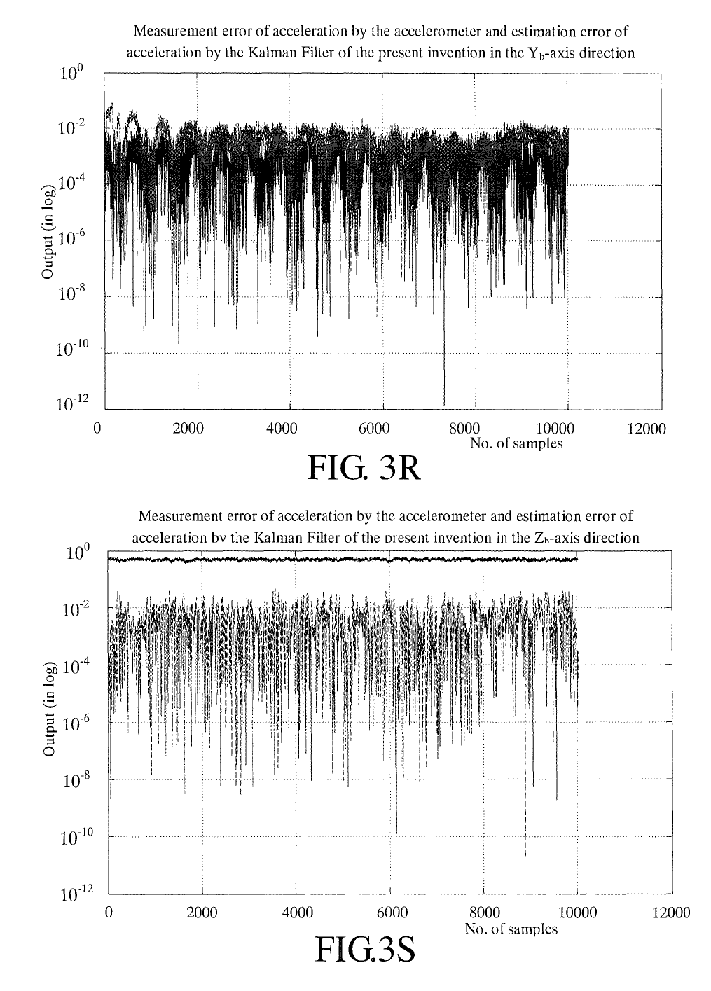

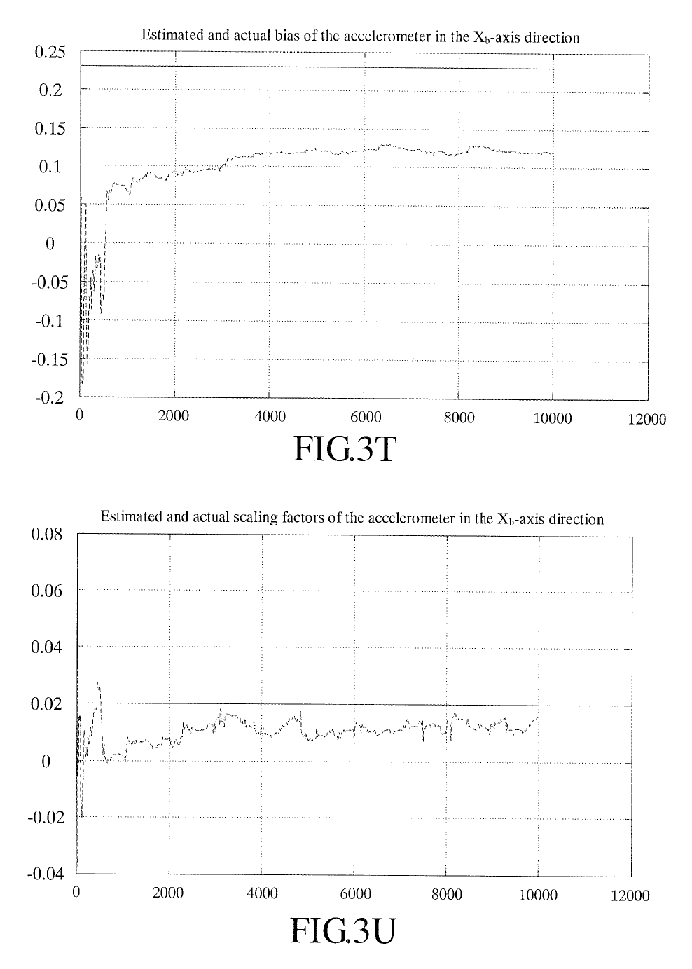

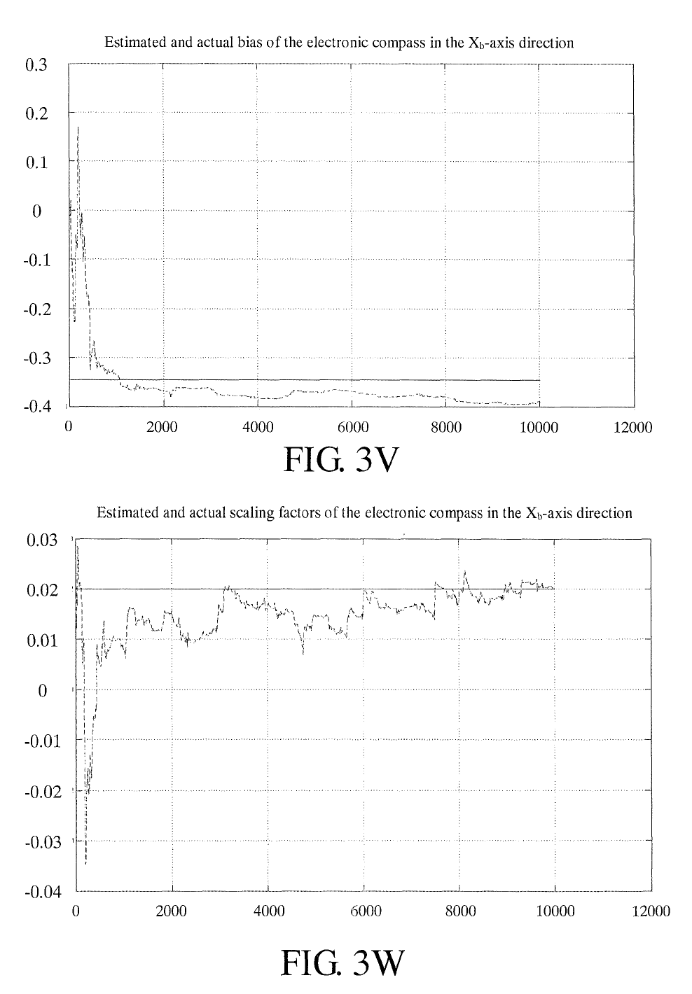

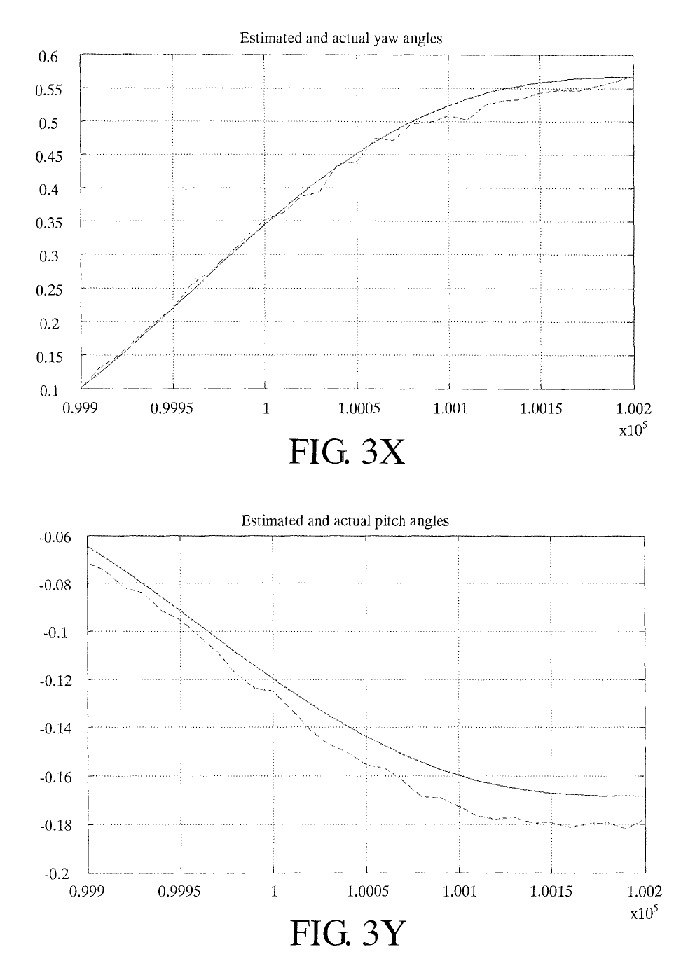

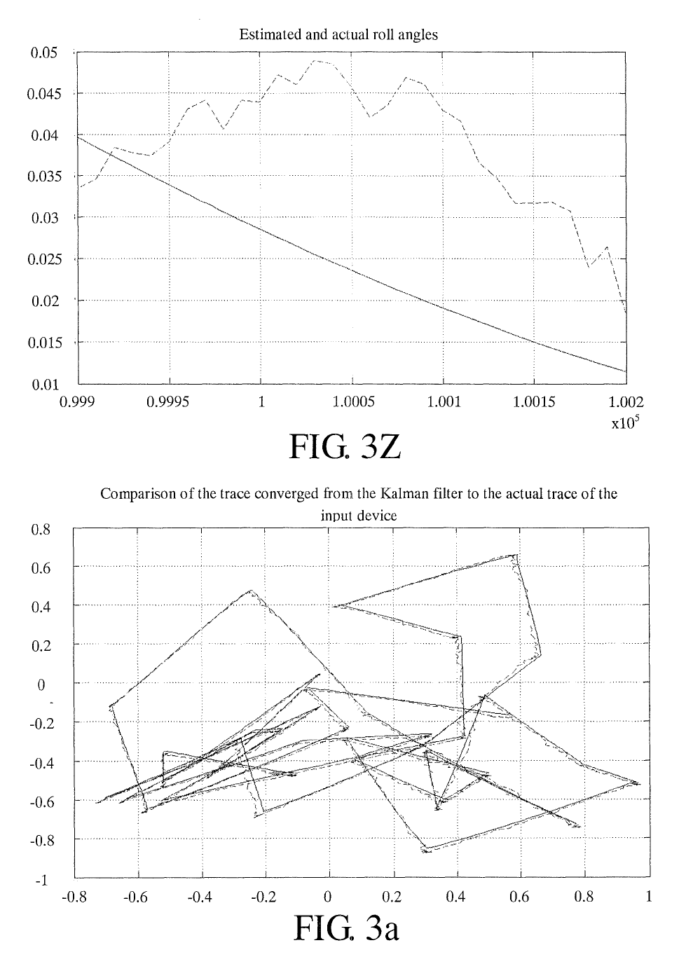

FIG. 3A is a block diagram of the trace-calculating module 10-2 according to an example of the present invention. Referring to FIG. 3A, the trace-calculating module 10-2 may be coupled to a motion-sensing module 10-1. The motion-sensing module 10-1 may be disposed on or in an input device (or an input module) of which trace information is to be measured, so that the motion-sensing module 10-2 may move with the input device. In this example, input device may be the input device 288 illustrated in FIG. 2. The motion-sensing module 10-1 may include an accelerometer 820 and an electronic compass 821. The accelerometer 820 may be disposed in or on the input device 288, and can move with the input device 288, so as to measure accelerations aₓ^{b}, a_{y}^{b} and a_{z}^{b} of the input device 288 in the directions of the X_{b}, Y_{b} and Z_{b} axes of the body frame, respectively, in response to movements of the input device 288 due to forces exerted on the input device 288 (such as being moved/waved/gestured by the user). The electronic compass 821 may be configured to measure the terrestrial magnetisms mₓ^{b}, m_{y}^{b} and m_{z}^{b} in the directions of the X_{b}, Y_{b} and Z_{b} axes, respectively (which may be represented by a magnetic vector [mₓ^{b}, m_{y}^{b}, m_{z}^{b}]^{T}) at each location where the electronic compass 821 is located (i.e., the position of the input device 288) at each point of time during the movements. Since the direction of the magnetic field line of the terrestrial magnetic field in a small area may be regarded as a fixed direction, the measured magnetic vector may be used by the trace-calculating module 10-2 as reference for calculating the trace of the movements (in this example, even if the user move/wave/gesture the input device 288, the change in the position of the input device 288 is limited (not too big) and may not become big enough such that the direction of the magnetic field line passing through the area changes significantly). For example, from the changes in the terrestrial magnetisms mₓ^{b}, m_{y}^{b} and m_{z}^{b} in the directions of the three axes measured by the electronic compass 821, the amount the input device 288 has deviated from the direction of the magnetic field line of the terrestrial magnetic field may be determined, and may be used for generating more accurate trace information.

The trace-calculating module 10-2 may include a first module such as a roll angle and pitch angle calculating module 824, a second module such as a navigation frame's initial magnetic vector calculating module 825, and a third module such as a Kalman Filter 823. When a user points the X_{b} axis of the input device 288 to the screen of the television 28, ready to input information by moving the input device 288, the initial yaw angle may be set to a constant or 0. One skilled in the art may easily understand that in order to determine the point of time when the user is ready to input information, the input device 288 may be designed or configured with a button (for example, the left/right key or the wheel of a mouse, or a specially designed button), and the initial roll/pitch angle calculating module 824 may be configured to set the instant when the bottom is pressed as the starting time for calculating the initial angles. Since the pitch angle and roll angle are related to the direction of the gravitation acceleration (are influenced by gravitational force or its components), during initialization, the accelerometer 820 may measure the accelerations associated with the directions corresponding to these two angles. Therefore, the initial roll/pitch angle calculating module 824 may be configured to calculate the initial roll (φ) and pitch (θ) angles using the following equation:

$$[ \begin{matrix}{a}_{x}^{b} \\ {a}_{y}^{b} \\ {a}_{z}^{b}\end{matrix} ] = [ \begin{matrix} cos θ & 0 & sin θ \\ sin φsin θ & cos φ & - sin φ cos θ \\ - cos φsin θ & sin φ & cos φcos θ\end{matrix} ] [ \begin{matrix}0 \\ 0 \\ - g\end{matrix} ] = [ \begin{matrix}- g sin θ \\ g sin φcos θ \\ - g cos φcos θ\end{matrix} ]$$

where g is the gravitational acceleration, aₓ^{b}, a_{y}^{b} and a_{z}^{b} are the accelerations in the X_{b} axis, Y_{b} axis and Z_{b} axis directions measured by the accelerometer 820 when the user points the X_{b} axis of the input device 288 at the screen of the television 28 in preparation of using the movement of the input device 288 for inputting information. The initial roll (φ), pitch (θ) and yaw (Ψ) angles may be provided to the navigation frame's initial magnetic vector calculating module 825 for calculating the initial magnetic vector [mₓⁿ, m_{y}ⁿ, m_{z}ⁿ]^{T}.

The navigation frame's initial magnetic vector calculating module 825 may calculate the initial magnetic vector of the navigation frame [mₓⁿ, m_{y}ⁿ, m_{z}ⁿ]^{T} using the following equation:

$$[ \begin{matrix}{m}_{x}^{n} \\ {m}_{y}^{n} \\ {m}_{z}^{n}\end{matrix} ] = [ \begin{matrix} cos θ & 0 & sin θ \\ sin φsin θ & cos φ & - sin φ cos θ \\ - cos φsin θ & sin φ & cos φcos θ\end{matrix} ] [ \begin{matrix}{m}_{x}^{b} \\ {m}_{y}^{b} \\ {m}_{z}^{b}\end{matrix} ]$$

where mₓ^{b} m_{y}^{b} and m_{z}^{b} are the terrestrial magnetisms in the X_{b}, Y_{b} and Z_{b} directions measured by the electronic compass 821 when the user points the X_{b} axis of the input device 288 at the screen of the television 28 in preparation of using the movement of the input device 288 to input information. This initial magnetic vector [mₓⁿ, m_{y}ⁿ, m_{z}ⁿ]^{T} is subsequently input into the Kalman Filter 823 for use as a magnetic reference vector \vec{m}ₙ.

The state equation of the trace-calculating module 10-2 (or the Kalman Filter 823) may be represented by a continuous-time differential equation as follows:

$$\frac{d }{d t} \vec{X} = \frac{d }{d t} [ \begin{matrix}ψ \\ θ \\ φ \\ {\vec{b}}_{a}^{b} \\ {\vec{b}}_{c}^{b} \\ {\vec{s}}_{a}^{b} \\ {\vec{s}}_{c}^{b}\end{matrix} ] = [ \begin{matrix}{U}_{ψ} \\ {U}_{θ} \\ {U}_{φ} \\ {\vec{N}}_{ba} \\ {\vec{N}}_{bc} \\ {\vec{N}}_{sa} \\ {\vec{N}}_{sc}\end{matrix} ]$$

where each element of \vec{X} represents a state;

\vec{b}ₐ^{b} represents the accelerometer bias which the accelerometer 820 may have due to the process of manufacturing (for example, if the accelerometer is horizontally stable on a floor table top, but can still measure acceleration in one of the axis);

\vec{b}_{c}^{b} represents the compass bias which the electrical compass 821 may have due to the process of manufacturing;

\vec{s}ₐ^{b} represents the truncation error due to the number of bits (e.g., 10-bit for representing an acceleration value) for representing the acceleration value on the accelerometer scale of the accelerometer;

\vec{s}_{c}^{b} represents the truncation error due to the number of bits (e.g., 10-bits for representing a terrestrial magnetism value) for representing the terrestrial magnetism value on the compass scale of the electronic compass 821;

U_{Ψ}, represents changes in the yaw angle Ψ due to the user using the input device 288 for inputting and generating traces of movements (i.e., differentiate Ψ with respect to time);

U_{θ} represents changes in the pitch angle θ due to the user using the input device 288 for inputting and generating traces of movements (i.e., differentiate θ with respect to time);

U_{φ} represents changes in the roll angle φ due to the user using the input device 288 for inputting and generating traces of movements (i.e., differentiate φ with respect to time);

\vec{N}_{ba} represents the changes in the accelerometer bias, which the accelerometer 820 may have due to the process of manufacturing, as a function of time;

\vec{N}_{bc} represents the changes in the compass bias, which the electronic compass 821 may have due to the process of manufacturing, as a function of time;

\vec{N}ₛₐ represents the truncation error due to the number of bits for representing the acceleration values on the accelerometer scale of the accelerometer 820, as a function of time; and

\vec{N}_{sc} represents the truncation error due to the number of bits for representing the terrestrial magnetism values on the compass scale of the electrical compass 821, as a function of time.

One skilled in the art should be able to easily understand that when the bias of the accelerometer 820 or the electrical compass 821 due to the process of manufacturing is small or when the chip design of the accelerometer 820/electrical compass 821 includes self calibration function, or when the outputs are represented by larger number of bits, the effects of the aforementioned bias or scale factors may be neglected. Therefore, state functions including less or none of the elements related to the bias or scale factors may be obtained. Furthermore, under the circumstances where other factors that may affect the generation of trace information exist, the number of states of \vec{X} may be increased or decreased, in order to arrive at different trace generating effects.

Similarly, the discrete-time state equation of the trace-calculating module 10-2 may be represented as follows:

$${\vec{X}}_{k} = [ \begin{matrix}{ψ}_{k} \\ {θ}_{k} \\ {φ}_{k} \\ {\vec{b}}_{a , k}^{b} \\ {\vec{b}}_{c , k}^{b} \\ {\vec{s}}_{a , k}^{b} \\ {\vec{s}}_{c , k}^{b}\end{matrix} ] = {I}_{15 \times 15} [ \begin{matrix}{ψ}_{k - 1} \\ {θ}_{k - 1} \\ {φ}_{k - 1} \\ {\vec{b}}_{a , k - 1}^{b} \\ {\vec{b}}_{c , k - 1}^{b} \\ {\vec{s}}_{a , k - 1}^{b} \\ {\vec{s}}_{c , k - 1}^{b}\end{matrix} ] + [ \begin{matrix}{u}_{ψ , k - 1} \\ {u}_{θ , k - 1} \\ {u}_{φ , k - 1} \\ {\vec{n}}_{ba , k - 1} \\ {\vec{n}}_{bc , k - 1} \\ {\vec{n}}_{sa} \\ {\vec{n}}_{sc}\end{matrix} ]$$

where I_{15×15} is a 15×15 identity matrix;

the subscript k represents the value at time k, subscript k−1 represents the value at time k−1 (the time before time k);

similarly, \vec{b}_{a.k}^{b} and \vec{b}_{a.k-1}^{b} represent the accelerometer bias, which the accelerometer 820 may have due to the process of manufacturing, at time k and time k−1, respectively;

\vec{b}_{c,k}^{b} and \vec{b}_{c,k-1}^{b} represent the compass bias, which the electrical compass 821 may have due to the process of manufacturing, at time k and time k−1, respectively

\vec{s}_{a,k}^{b} and \vec{s}_{a,k-1}^{b} represent the truncation error due to the number of bits for representing the acceleration value on the accelerometer scale of the accelerometer 820 at time k and time k-1, respectively;

\vec{s}_{c,k}^{b} and \vec{s}_{c,k-1}^{b} represent the truncation error due to the number of bits for representing the terrestrial magnetism value on the compass scale of the electrical compass 821 at time k and time k−1, respectively;

u_{Ψ,k-1} represents increment in the yaw angle Ψ due to the user using the input device 288 for inputting and generating traces of movements at time k−1;

u_{θ,k-1} represents increment in the pitch angle θ due to the user using the input device 288 for inputting and generating traces of movements at time k−1;

u_{φ,k-1} represents increment in the roll angle θ due to the user using the input device 288 for inputting and generating traces of movements at time k−1;

\vec{n}_{ba,k-1} represents the increment in the accelerometer bias, which the accelerometer 820 may have due to the process of manufacturing, at time k−1;

\vec{n}_{bc,k-1} represents the increment in the compass bias, which the electrical compass 821 may have due to the process of manufacturing, at time k−1;

\vec{n}ₛₐ represents the increment in the accelerometer bias, which the accelerometer 820 may have due to the process of manufacturing, at time k−1 (the increment is almost fixed); and

\vec{n}_{sc} represents the increment in the compass bias, which the electronic compass 821 may have due to the process of manufacturing, at time k−1 (the increment is almost fixed).

In addition, the relation between the state of the trace-calculating module 10-2 and the measured value of the motion-sensing module 10-1 may be represented by the following measurement equation:

$${\vec{Z}}_{k} = h ( {\vec{X}}_{k} ) = [ \begin{matrix}{S}_{a , k} {C}_{n , k}^{b} {\vec{g}}_{n} + {\vec{b}}_{a , k}^{b} \\ {S}_{c , k} {C}_{n , k}^{b} {\vec{m}}_{n , k} + {\vec{b}}_{c , k}^{b}\end{matrix} ] + Noise$$

where Noise is the measurement noise, and C_{n,k}^{b} is a navigation-frame-to-body-frame coordinate transformation matrix at time k, which transforms the navigation frame coordinate (subscript n) to the corresponding body frame coordinate (superscript b).

Since the body-frame-to-pseudo-frame coordinate transformation matrix at time k may be represented by:

$${C}_{b , k}^{p} = [ \begin{matrix}1 & 0 & 0 \\ 0 & cos φ & sin φ \\ 0 & - sin φ & cos φ\end{matrix} ]$$

and the pseudo-frame-to-navigation-frame coordinate transformation matrix at time k may be represented by:

$${C}_{n , k}^{p} = [ \begin{matrix} cos θcos ψ & - cos θsin ψ & sin θ \\ sin ψ & cos ψ & 0 \\ - sin θcos ψ & sin θsin ψ & cos θ\end{matrix} ]$$

Thereby the navigation-frame-to-body-frame coordinate transformation matrix at time k, C_{n,k}^{b}, may be obtained from C_{n,k}^{b}=C_{b,k}^{p T}C_{n,k}^{p}.

Furthermore, scale factor matrices S_{a,k} and S_{c,k} may be represented by:

$${S}_{a , k} = [ \begin{matrix} {s}_{a , x , k}^{b} & 0 & 0 \\ 0 & {s}_{a , y , k}^{b} & 0 \\ 0 & 0 & {s}_{a , z , k}^{b}\end{matrix} ] and$$

$${S}_{c , k} = [ \begin{matrix} {s}_{c , x , k}^{b} & 0 & 0 \\ 0 & {s}_{c , y , k}^{b} & 0 \\ 0 & 0 & {s}_{c , z , k}^{b}\end{matrix} ]$$

The Kalman Filter 823 may include a fourth module such as a measurement update module 823-1, a fifth module such as a Kalman gain calculation module 823-2 and a sixth module such as a time update module 823-3.

At the initial stage when the Kalman Filter 823 starts to function, first, the initial roll/pitch angle calculating module 824 may calculate the initial roll angle and pitch angle to obtain an initial state vector \vec{X}ₖ, and the navigation frame's initial magnetic vector calculating module 825 may obtain the initial magnetic vector [mₓⁿ, m_{y}ⁿ, m_{z}ⁿ]^{T} of the navigation frame. One of the Kalman Filters 823, a covariance matrix Q, which is related to the changes in the angles about the three axes of the input device, due to the user's input and the bias of the accelerometer 820 and the electronic compass 821, may be defined as follows:

$$Q = [ \begin{matrix}{σ}_{r}^{2} {I}_{3 \times 3} & {0}_{3 \times 3} & {0}_{3 \times 3} & {0}_{3 \times 6} \\ {0}_{3 \times 3} & {σ}_{{b}_{a}}^{2} {I}_{3 \times 3} & {0}_{3 \times 3} & {0}_{3 \times 6} \\ {0}_{3 \times 3} & {0}_{3 \times 3} & {σ}_{{b}_{c}}^{2} {I}_{3 \times 3} & {0}_{3 \times 6} \\ {0}_{6 \times 3} & {0}_{6 \times 3} & {0}_{6 \times 3} & {0}_{6 \times 6}\end{matrix} ]$$

where σᵣ² represents the variance in the change in angles due to the user's input, σ_{b}_{ₐ}² represents the variance in the change in angles due to the bias of the accelerometer 820, and σ_{b}_{_{c}}² represents the variance in the change in angles due to the bias in the electronic compass 821. In one example, the three variances mentioned above may be obtained from variances calculated from the results of multiple experiments. In one example, at least one of the three variances mentioned above may be pre-stored in the Kalman Filter 823. One of the Kalman Filters 832, a posterior estimate error covariance matrix P₀ may be defined as follow:

$${P}_{0} = [ \begin{matrix}{σ}_{r}^{2} {I}_{3 \times 3} & {0}_{3 \times 3} & {0}_{3 \times 3} & {0}_{3 \times 6} \\ {0}_{3 \times 3} & {σ}_{{b}_{a}}^{2} {I}_{3 \times 3} & {0}_{3 \times 3} & {0}_{3 \times 6} \\ {0}_{3 \times 3} & {0}_{3 \times 3} & {σ}_{{b}_{c}}^{2} {I}_{3 \times 3} & {0}_{3 \times 6} \\ {0}_{6 \times 3} & {0}_{6 \times 3} & {0}_{6 \times 3} & {0}_{6 \times 6}\end{matrix} ]$$

One of the Kalman Filters 823, a measurement noise covariance matrix R, may be defined as follow:

$$R = [ \begin{matrix}{σ}_{ma}^{2} {I}_{3 \times 3} & {0}_{3 \times 3} \\ {0}_{3 \times 3} & {σ}_{mc}^{2} {I}_{3 \times 3}\end{matrix} ]$$

where σₘₐ², represents the measurement noise variance of the accelerometer 820, and σ_{mc}², represents the measurement noise variance of the electronic compass 821.

In one example, the measurement noise variance σₘₐ² of the accelerometer 820 and the measurement noise variance σ_{mc}² of the electronic compass 821 may be obtained through experiments and be pre-stored in the Kalman Filter 823.

Subsequently, time update module 823-3 may be configured to calculate the following equations:

\vec{X}ₖ⁻={right arrow over (\hat{X}ₖ₋₁

A=I_{15×15}

Pₖ⁻=APₖ₋₁A^{T}+Q

where {right arrow over (\hat{X}ₖ represents the a posteriori estimated state vector \vec{X}ₖ of measured \vec{Z}ₖ at time k, A is a 15×15 identity matrix, and Pₖ⁻ represents the a priori estimated error covariance matrix at time k.

The Kalman gain calculating module 823-2 may be configured to perform calculation of the following equations to obtain the Kalman gain Kₖ at time k:

Hₖ=Jacobian(h(\vec{X}ₖ⁻))

Kₖ=Pₖ⁻Hₖ^{T}(HₖPₖ⁻Hₖ^{T}R)⁻¹

Please note that the function h(\vec{X}ₖ⁻) may be obtained by substituting the a priori state vector \vec{X}ₖ⁻ into the measurement equation mentioned above. Hₖ may be obtained by calculating the determinant (Jacobian) of h(\vec{X}ₖ⁻).

The measurement update module 823-1 may be configured to calculate the following equations to obtain an estimated state vector \vec{X}ₖ:

{right arrow over (\hat{X}ₖ=\vec{X}ₖ⁻+Kₖ(\vec{Z}ₖ−h(\vec{X}ₖ⁻))

Pₖ=(I−KₖHₖ)Pₖ⁻

where Pₖ is the a posteriori estimate error covariance matrix at time k. From this, the estimated pitch angle \hat{θ} and yaw angle \hat{ψ} may be obtained.

In one example, the trace-calculating module 10-2 may be further coupled to a magnetic hysteresis/low pass filter 827 for removing, for example, disturbance to measurement or estimation due to the natural vibration of the user's body.

In another example, the trace-calculating module 10-2 may be further coupled to an X,Y coordinate conversion module 828 for converting the pitch angle \hat{θ} and the yaw angle \hat{ψ} to a set of X,Y coordinates.

In addition, in other examples, the trace-calculating module 10-2 may be coupled to a power-off detection module 826. When no changes in the pitch angle \hat{θ} and the yaw angle \hat{ψ} occurred within a period of time, the power-off detection module 826 may decide that the user may not be using the input device 288, and thus send out a power-off command to turn off at least a portion of the circuit of the input device 288 or a portion of the circuit of the trace-generating device 10, so as to achieve the effect of saving energy.

The construction of the models of each module in the trace-generating device 10 and the simulation of the system in a simulation software (Matlab) will now be disclosed.

FIG. 3B is a plot comparing the measured and actual accelerations in the X_{b} axis direction according to an example of the present invention, where the measured acceleration measured by the accelerometer 820 in the X_{b} axis direction is represented by a broken line, and the actual acceleration in the X_{b} axis direction is represented by a solid line. The horizontal axis indicates the number of samples.

FIG. 3C is a plot comparing the measured and the actual accelerations in the Y_{b} axis direction according to an example of the present invention, where the measured acceleration measured by the accelerometer 820 in the Y_{b} axis direction is represented by a broken line, and the actual acceleration in the Y_{b} axis direction is represented by a solid line. The horizontal axis indicates the number of samples.

FIG. 3D is a plot comparing the measured and the actual accelerations in the Z_{b} axis direction according to an example of the present invention, where the measured acceleration measured by the accelerometer 820 in the Z_{b} axis direction is represented by a broken line, and the actual acceleration in the Z_{b} axis direction is represented by a solid line. The horizontal axis indicates the number of samples.

FIG. 3E is a plot comparing the measured and the actual terrestrial magnetisms in the X_{b} axis direction according to an example of the present invention, where the measured terrestrial magnetism measured by the electronic compass 821 in the X_{b} axis direction is represented by a broken line, and the actual acceleration in the X_{b} axis direction is represented by a solid line. The horizontal axis indicates the number of samples.

FIG. 3F is a plot comparing the measured and the actual terrestrial magnetisms in the Y_{b} axis direction according to an example of the present invention, where the measured terrestrial magnetism measured by the electronic compass 821 in the Y_{b} axis direction is represented by a broken line, and the actual acceleration in the Y_{b} axis direction is represented by a solid line. The horizontal axis indicates the number of samples.

FIG. 3G is a plot comparing the measured and the actual terrestrial magnetism in the Z_{b} axis direction according to an example of the present invention, where the measured terrestrial magnetism measured by the electronic compass 821 in the Z_{b} axis direction is represented by a broken line, and the actual acceleration in the Z_{b} axis direction is represented by a solid line. The horizontal axis indicates the number of samples.

FIG. 3H is a plot comparing the estimated and the actual terrestrial magnetism in the X_{b} axis direction according to an example of the present invention, where the measured terrestrial magnetism measured by the Kalman Filter 823 in the X_{b} axis direction is represented by a broken line, and the actual acceleration in the X_{b} axis direction is represented by a solid line. The horizontal axis indicates the number of samples.

FIG. 3I is a plot comparing the estimated and the actual terrestrial magnetisms in the Y_{b} axis direction according to an example of the present invention, where the measured terrestrial magnetism measured by the Kalman Filter 823 in the Y_{b} axis direction is represented by a broken line, and the actual acceleration in the Y_{b} axis direction is represented by a solid line. The horizontal axis indicates the number of samples.

FIG. 3J is a plot comparing the estimated and the actual terrestrial magnetism in the Z_{b} axis direction according to an example of the present invention, where the measured terrestrial magnetism measured by the Kalman Filter 823 in the Z_{b} axis direction is represented by a broken line, and the actual acceleration in the Z_{b} axis direction is represented by a solid line. The horizontal axis indicates the number of samples.

FIG. 3K is a plot comparing the estimation error and the measurement error of terrestrial magnetism in the X_{b} axis direction according to an example of the present invention, where the measurement error of terrestrial magnetism, which is the difference between the estimated terrestrial magnetism in the X_{b} axis direction calculated by the Kalman Filter 823 and the actual terrestrial magnetism in the X_{b} axis direction, is represented by a broken line, and the estimation error of terrestrial magnetism, which is the difference between the measured terrestrial magnetism in the X_{b} axis direction and the actual terrestrial magnetism in the X_{b} axis direction, is represented by a solid line. The horizontal axis indicates the number of samples. From the simulation result, it may be deduced that the estimated terrestrial magnetism calculated by the Kalman Filter 823 of the present invention is closer to the actual terrestrial magnetism in comparison to the terrestrial magnetism measured directly by the electronic compass 821 (the error is smaller).

FIG. 3L is a plot comparing the estimation error and the measurement error of terrestrial magnetism in the Y_{b} axis direction according to an example of the present invention, where the estimation error of terrestrial magnetism, which is the difference between the estimated terrestrial magnetism in the Y_{b} axis direction calculated by the Kalman Filter 823 and the actual terrestrial magnetism in the Y_{b} axis direction, is represented by a broken line, and the measurement error of terrestrial magnetism, which is the difference between the measured terrestrial magnetism in the Y_{b} axis direction and the actual terrestrial magnetism in the Y_{b} axis direction, is represented by a solid line. The horizontal axis indicates the number of samples. From the simulation result, it may be deduced that estimated terrestrial magnetism calculated by the Kalman Filter 823 of the present invention is closer to the actual terrestrial magnetism in comparison to the terrestrial magnetism measured directly by the electronic compass 821 (the error is smaller).

FIG. 3M is a plot comparing the estimation error and the measurement error of terrestrial magnetism in the Z_{b} axis direction according to an example of the present invention, where the estimation error of terrestrial magnetism, which is the difference between the estimated terrestrial magnetism in the Z_{b} axis direction calculated by the Kalman Filter 823 and the actual terrestrial magnetism in the Z_{b} axis direction, is represented by a broken line, and the measurement error of terrestrial magnetism, which is the difference between the measured terrestrial magnetism in the Z_{b} axis direction and the actual terrestrial magnetism in the Z_{b} axis direction, is represented by a solid line. The horizontal axis indicates the number of samples. From the simulation result, it may be deduced that estimated terrestrial magnetism calculated by the Kalman Filter 823 of the present invention is closer to the actual terrestrial magnetism in comparison to the terrestrial magnetism measured directly by the electronic compass 821 (the error is smaller).

FIG. 3N is a plot comparing the estimated acceleration in the X_{b} axis direction estimated by the Kalman Filter 823 of the present invention and the actual acceleration in the X_{b} axis direction. The horizontal axis indicates the number of samples.

FIG. 3O is a plot comparing the estimated acceleration in the Y_{b} axis direction estimated by the Kalman Filter 823 of the present invention and the actual acceleration in the Y_{b} axis direction. The horizontal axis indicates the number of samples.

FIG. 3P is a plot comparing the estimated acceleration in the Z_{b} axis direction estimated by the Kalman Filter 823 of the present invention and the actual acceleration in the Z_{b} axis direction. The horizontal axis indicates the number of samples.

FIG. 3Q is a plot comparing the measurement error and the estimation error of acceleration in the X_{b} axis direction according to an example of the present invention, where the difference between the estimated acceleration in the X_{b} axis direction calculated by the Kalman Filter 823 and the actual acceleration in the X_{b} axis direction (estimation error of acceleration) is represented by a broken line, and the difference between the measured acceleration in the X_{b} axis direction and the actual acceleration in the X_{b} axis direction (measurement error of acceleration) is represented by a solid line. The horizontal axis indicates the number of samples. From the simulation result, it may be deduced that estimated acceleration calculated by the Kalman Filter 823 of the present invention does not provide significant improvement in terms of accuracy in comparison to the acceleration measured directly by the accelerometer 820. The reason for this could be that when the input device 288 is used for inputting strokes, the directions of movements of the input device 288 are mainly in the Y_{b} axis and the Z_{b} axis direction (the main directions receiving forces and generating accelerations), but not in the X_{b} axis direction.

FIG. 3R is a plot comparing the measurement error and the estimation error of acceleration in the Y_{b} axis direction according to an example of the present invention, where the difference between the estimated acceleration in the Y_{b} axis direction calculated by the Kalman Filter 823 and the actual acceleration in the Y_{b} axis direction (estimation error of acceleration) is represented by a broken line, and the difference between the measured acceleration in the Y_{b} axis direction and the actual acceleration in the Y_{b} axis direction (measurement error of acceleration) is represented by a solid line. The horizontal axis indicates the number of samples. From the simulation result, it may be deduced that estimated acceleration calculated by the Kalman Filter 823 of the present invention is closer to the actual acceleration in comparison to the acceleration measured directly by the accelerometer 820 (the error is smaller).

FIG. 3R is a plot comparing the measurement error and the estimation error of acceleration in the Z_{b} axis direction according to an example of the present invention, where the difference between the estimated acceleration in the Z_{b} axis direction calculated by the Kalman Filter 823 and the actual acceleration in the Z_{b} axis direction (estimation error of acceleration) is represented by a broken line, and the difference between the measured acceleration in the Z_{b} axis direction and the actual acceleration in the Z_{b} axis direction (measurement error of acceleration) is represented by a solid line. The horizontal axis indicates the number of samples. From the simulation result, it may be deduced that estimated acceleration calculated by the Kalman Filter 823 of the present invention is closer to the actual acceleration in comparison to the acceleration measured directly by the accelerometer 820 (the error is smaller).

FIG. 3T is the estimated and actual bias of the accelerometer 820 in the X_{b} axis direction according to an example of the present invention.

FIG. 3U is the estimated and actual scaling factors of the accelerometer 820 in the X_{b} axis direction according to an example of the present invention.

FIG. 3V is the estimated and actual bias of the electronic compass 821 in the X_{b} axis direction according to an example of the present invention.

FIG. 3W is the estimated and actual scaling factors in the X_{b} axis direction of the electronic compass 821 according to an example of the present invention.

FIG. 3X is a plot comparing the estimated yaw angle calculated by the Kalman Filter 823 according to an example of the present invention to the actual yaw angle. The horizontal axis indicates the number of samples.

FIG. 3Y is a plot comparing the estimated pitch angle calculated by the Kalman Filter 823 according to an example of the present invention to the actual pitch angle. The horizontal axis indicates the number of samples.

FIG. 3Z is a plot comparing the estimated roll angle calculated by the Kalman Filter 823 according to an example of the present invention to the actual roll angle. The horizontal axis indicates the number of samples.

FIG. 3a is a plot comparing the trace converged from the Kalman Filter 823 of an example of the present invention to the actual trace of the input device 288. From the simulation result, it may be deduced that after being calculated by the trace-calculating module 10-2, the trace generated by the trace-generating device 10 is very close to the actually trace of the input device 288.

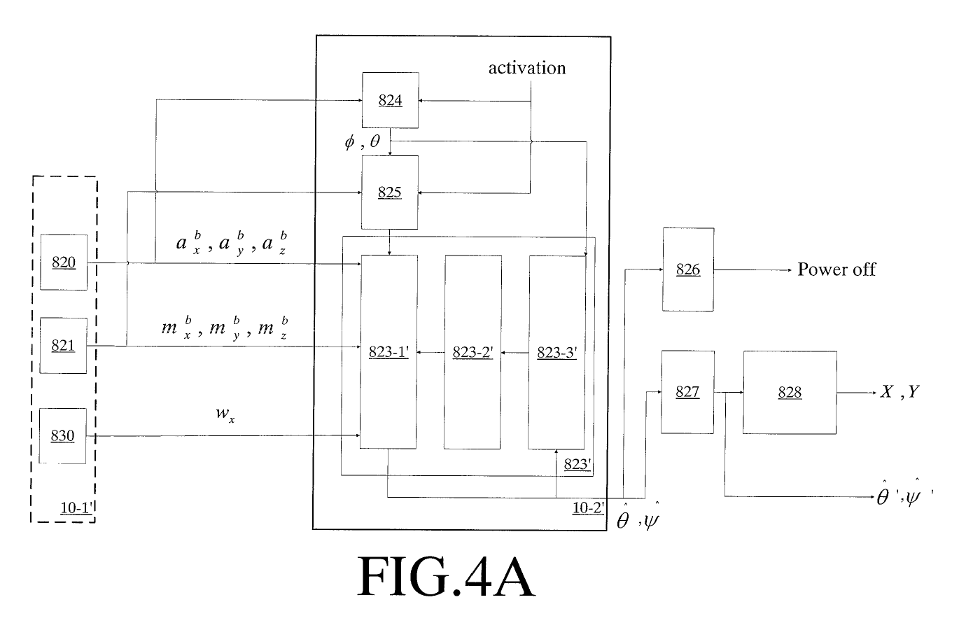

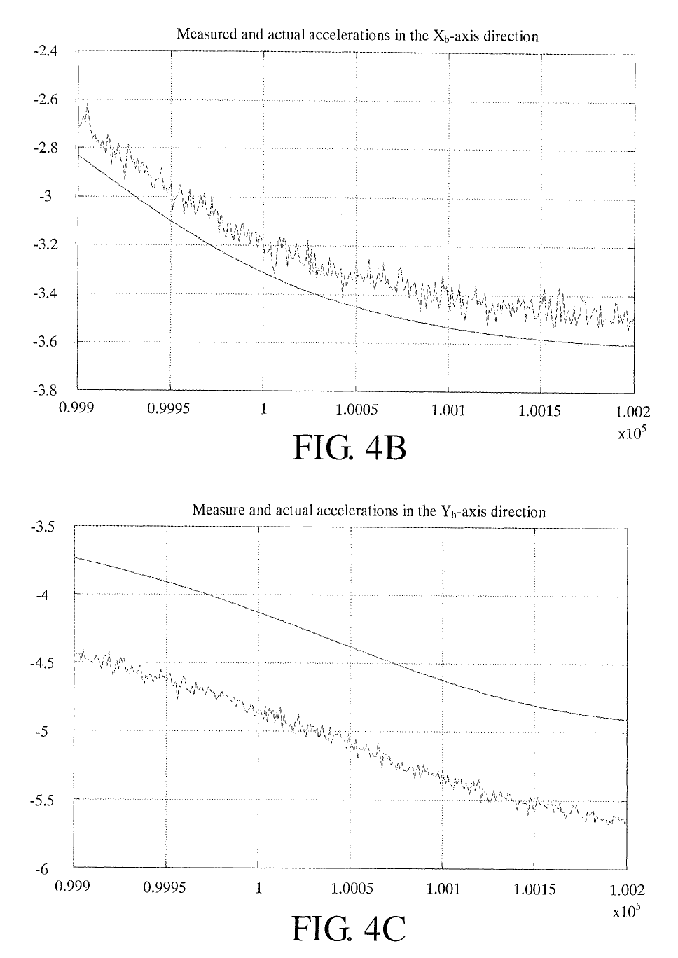

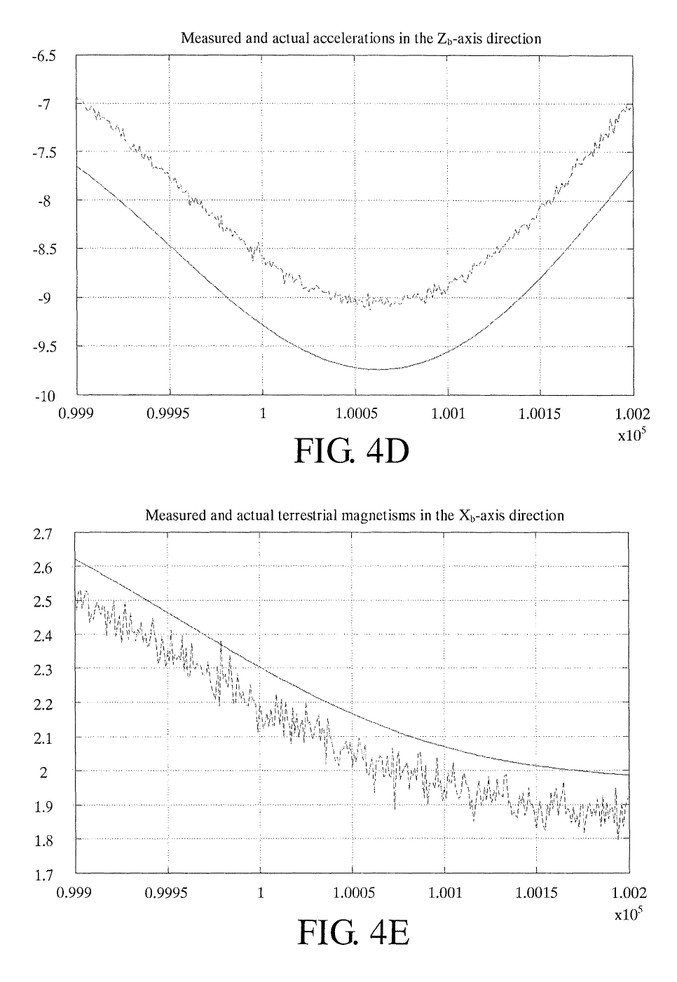

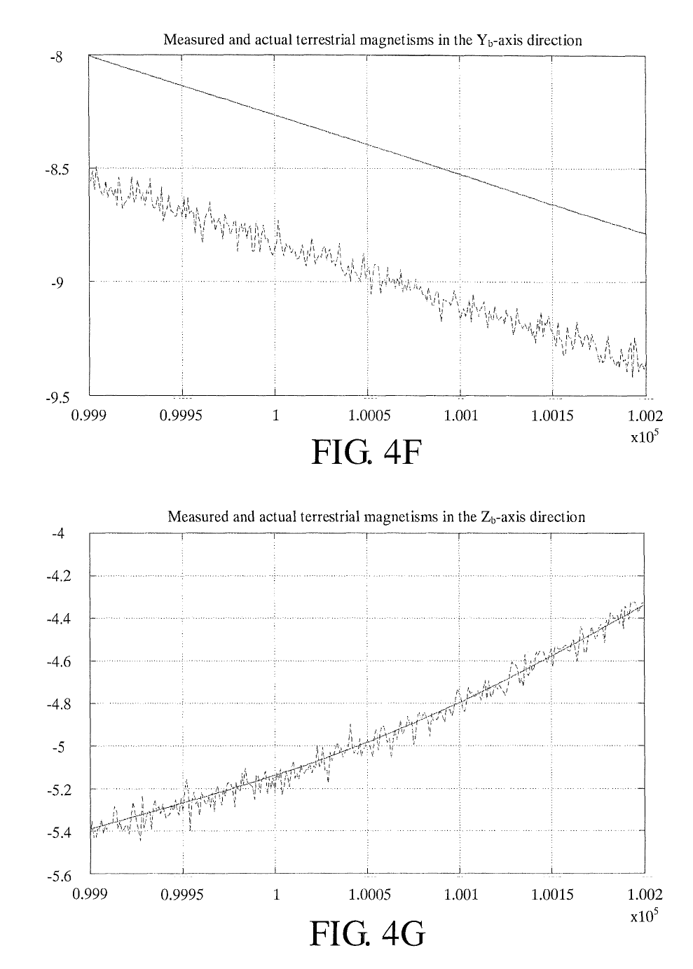

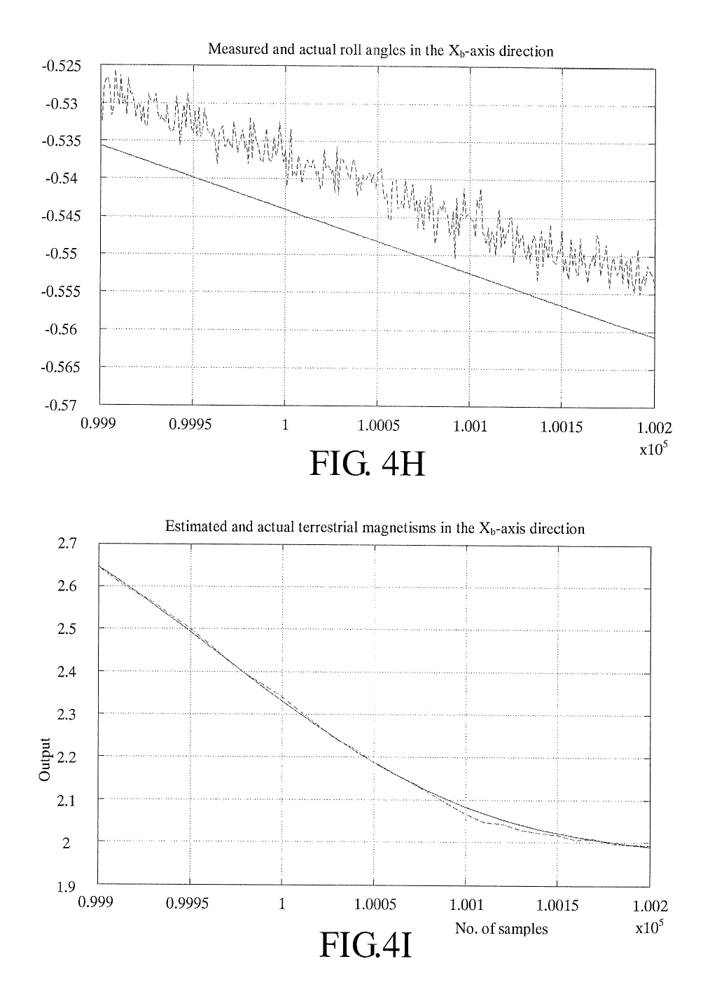

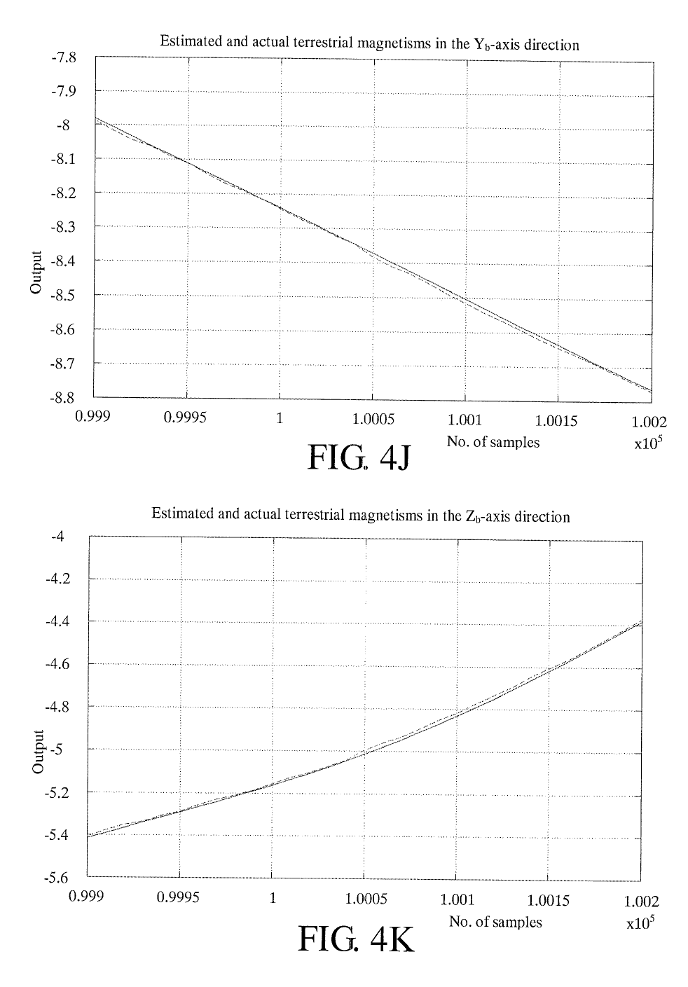

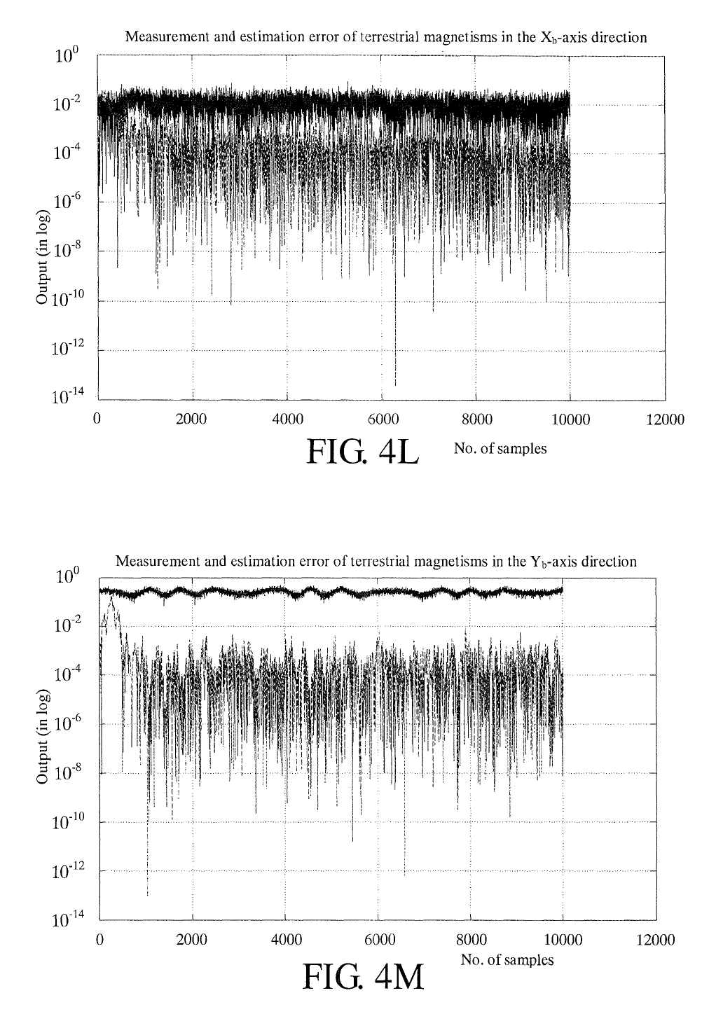

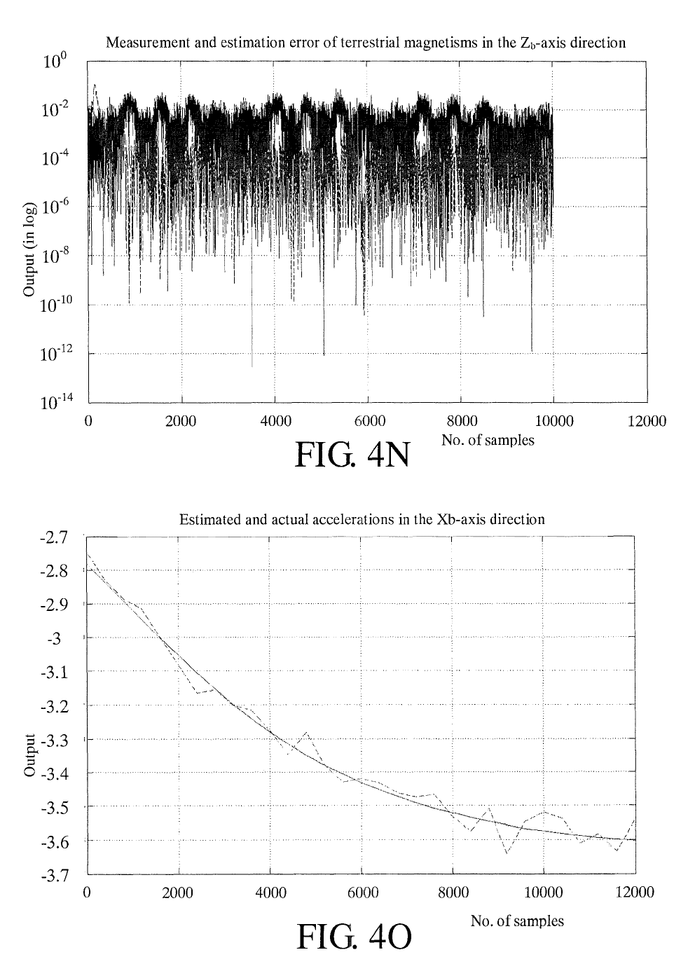

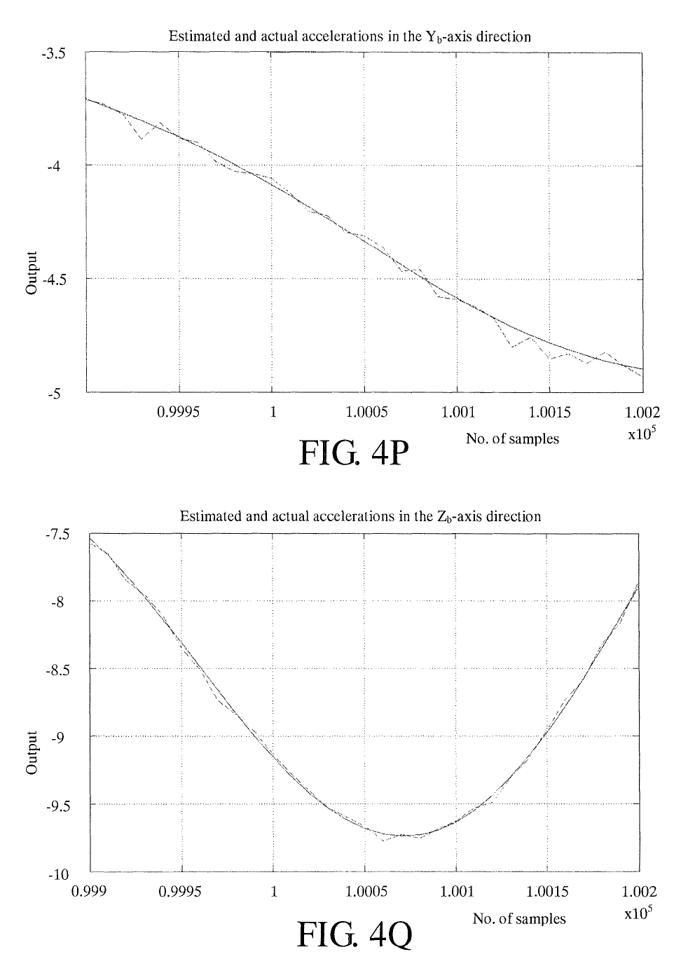

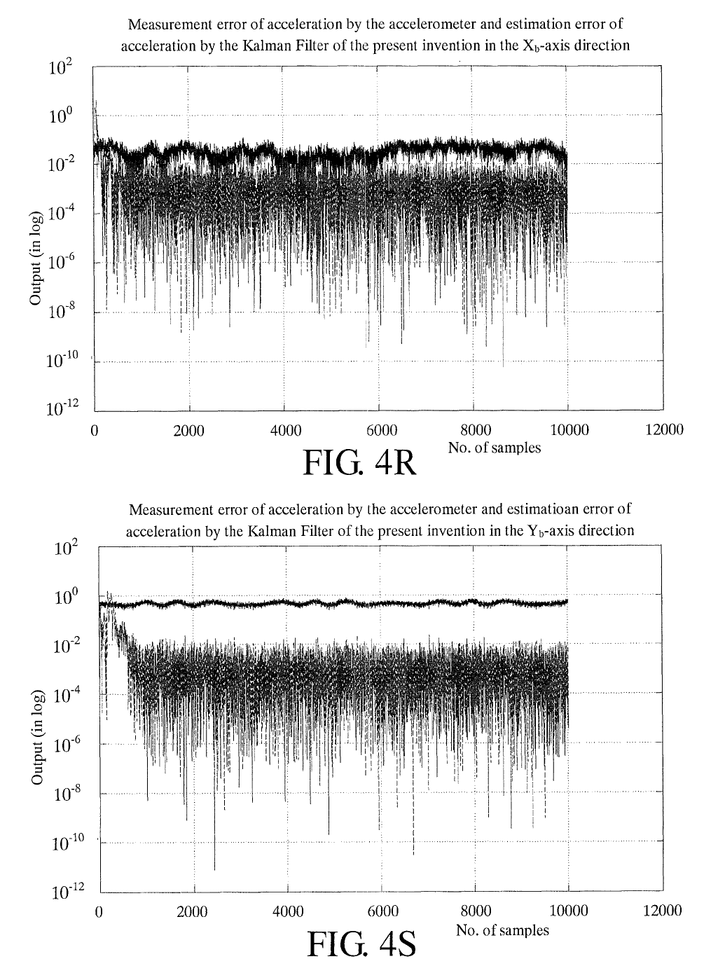

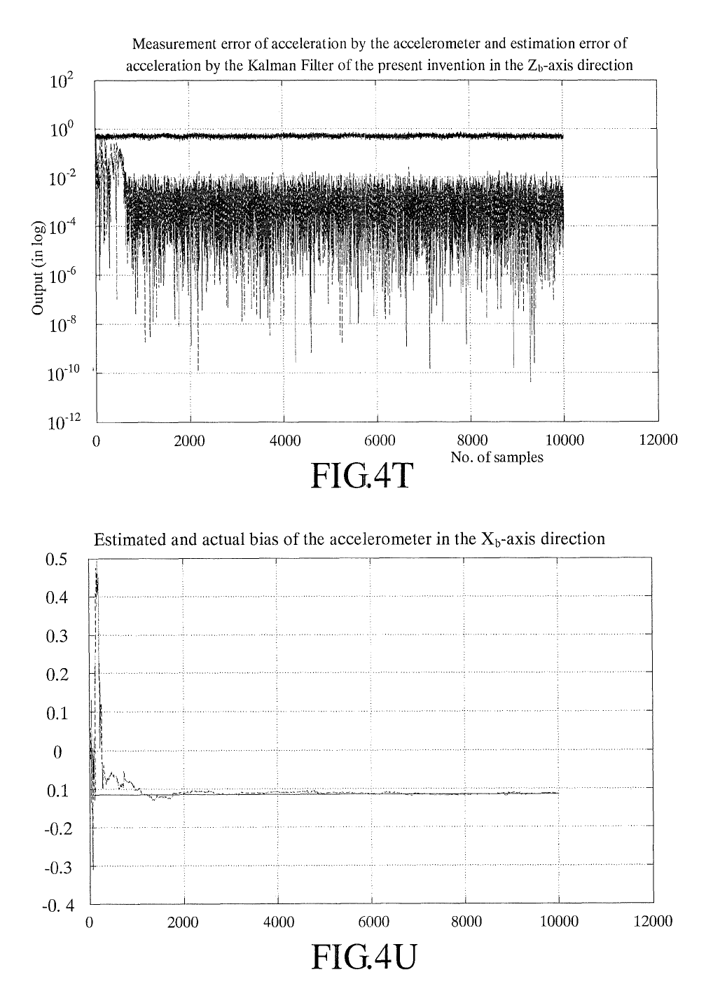

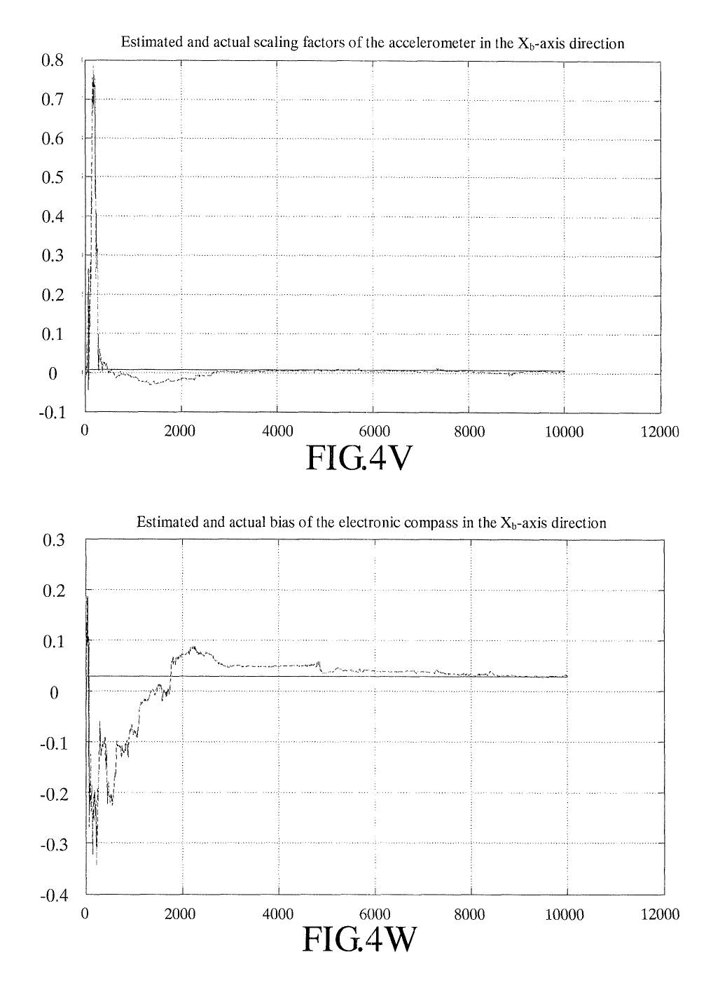

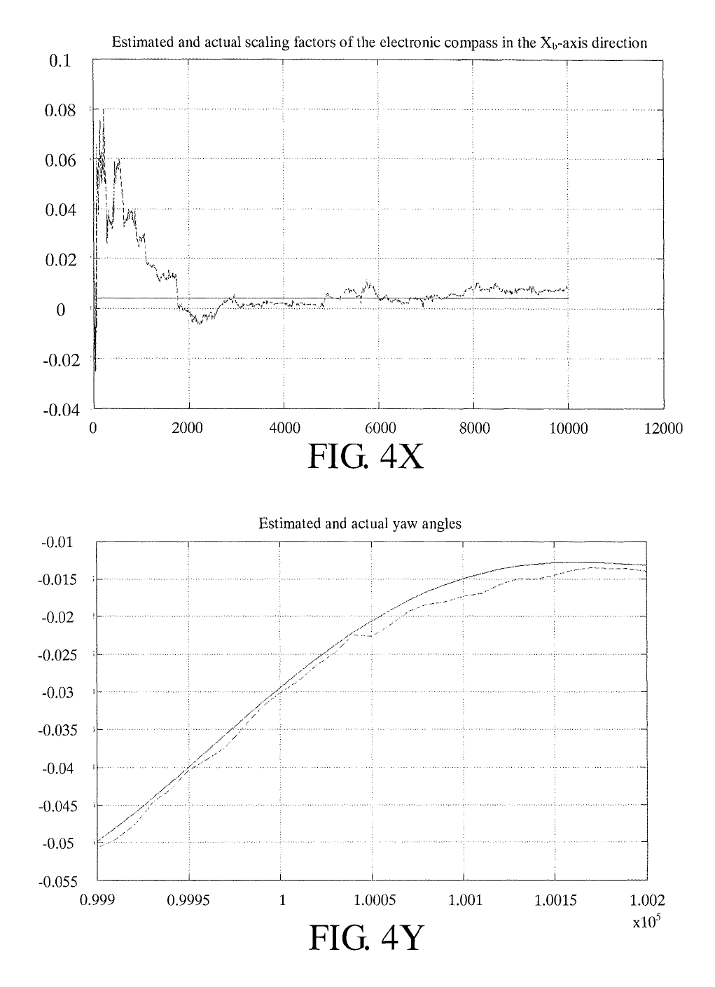

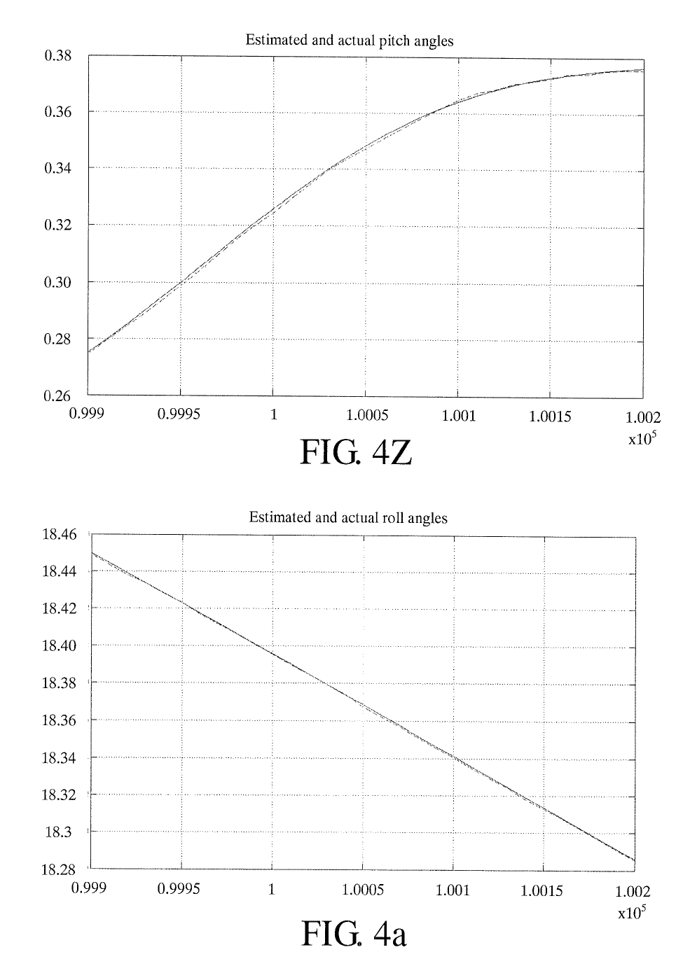

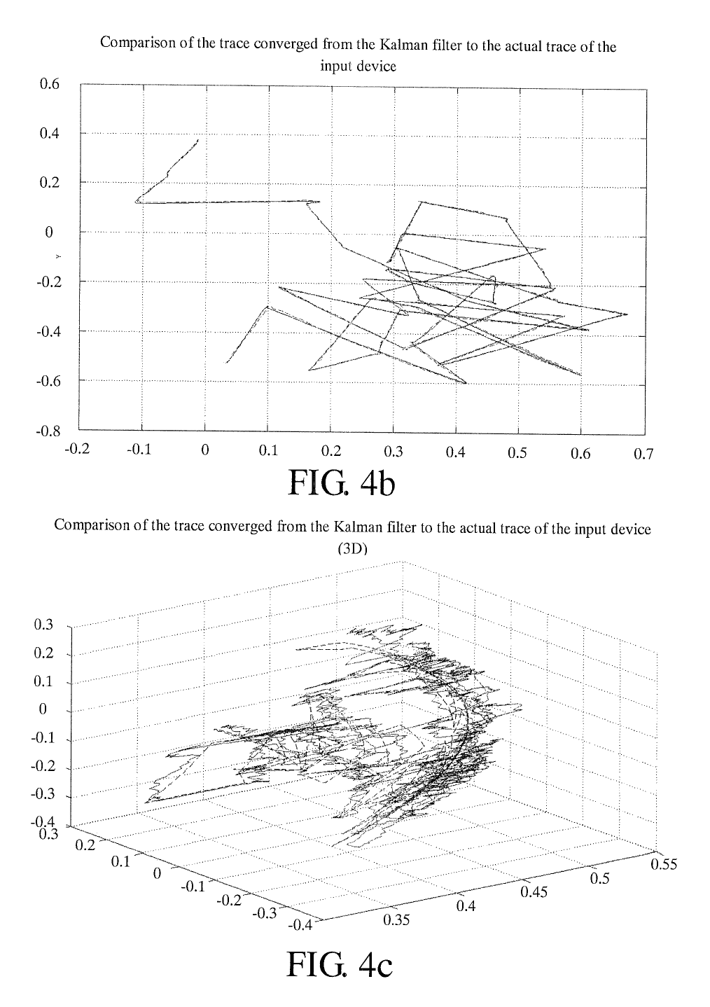

FIG. 4A is the block diagram of the trace-calculating module 10-2′ according to an example of the present invention. Referring to FIG. 4A, besides replacing the Kalman Filter 823 with another Kalman Filter 823′, the trace-calculating module 10-2′ is similar to the trace-calculating module 10-2 shown in FIG. 3A and described in reference to FIG. 3A. Moreover, the motion-sensing module 10-1′ may further include a 1D gyroscope 830.

A kinetic differential equation of the trace-calculating module 10-2′ may be represented as follows.

$$\frac{d }{d t} {\vec{r}}_{n} = \frac{d }{d t} [ \begin{matrix}R \\ Ψ \\ θ\end{matrix} ] = D [ \begin{matrix}{v}_{x}^{p} \\ {v}_{y}^{p} \\ {v}_{z}^{p}\end{matrix} ] = [ \begin{matrix}1 & 0 & 0 \\ 0 & \frac{- 1}{R cos φ} & 0 \\ 0 & 0 & \frac{1}{R}\end{matrix} ] [ \begin{matrix}{v}_{x}^{p} \\ {v}_{y}^{p} \\ {v}_{z}^{p}\end{matrix} ]$$

where \vec{r}ₙ is a position vector, the position vector includes a movement radius R, a yaw angle Ψ and a pitch angle θ. The movement radius R is the approximate movement radius by which the user moves the input device 288 for generating trace information (for example, the average distance between a person's elbow joint and palm).

The kinetic differential equation represents how a velocity vector \vec{v}ₚ=[vₓ^{p}, v_{y}^{p}, v_{z}^{p}]^{T} corresponding to the pseudo frame (represented by superscript p) is obtained, that is, by performing a first-order differentiation on the position vector. D is a transformation matrix for transforming the velocity vector \vec{v}ₚ to the pseudo frame.

The kinetic differential equation may be further represented as:

$$\frac{d}{d t} \vec{{v}_{p}} = \frac{d}{d t} [ \begin{matrix}{v}_{x}^{p} \\ {v}_{y}^{p} \\ {v}_{z}^{p}\end{matrix} ] = {C}_{b}^{p} [ \begin{matrix}{a}_{x}^{b} \\ {a}_{y}^{b} \\ {a}_{z}^{b}\end{matrix} ] + {Ω}_{np}^{p} [ \begin{matrix}{v}_{x}^{p} \\ {v}_{y}^{p} \\ {v}_{z}^{p}\end{matrix} ] - {C}_{n}^{p} [ \begin{matrix}0 \\ 0 \\ g\end{matrix} ]$$

$$where$$

$${Ω}_{np}^{p} = ( {w}_{np}^{p} \times ) = [ \begin{matrix}0 & \frac{{v}_{y}^{p}}{R} & \frac{{v}_{z}^{p}}{R} \\ - \frac{{v}_{y}^{p}}{R} & 0 & 0 \\ - \frac{{v}_{z}^{p}}{R} & 0 & 0\end{matrix} ]$$

where g is the gravitational acceleration, wₙₚ^{p} is a rotation rate vector that corresponds to the pseudo frame for mapping the navigation frame to the corresponding pseudo frame. The values of the elements of the rotation rate vector are rotational speed wₓ about the X_{b} axis, which is calculated based on the measurement results of the 1D gyroscope 830, where the relation between the rotational speed wₓ and roll angle φ may be represented by:

$$\frac{d}{d t} φ = {w}_{x}$$

From the cross product of wₙₚ^{p}, matrix Ωₙₚ^{p} may be obtained.

A continuous-time state equation of the trace-calculating module 10-2′ (or Kalman Filter 823′) may be represented by:

$$\frac{d}{d t} \vec{X} = \frac{d}{d T} [ \begin{matrix}{\vec{r}}_{n} \\ {\vec{v}}_{p} \\ {\vec{a}}_{b} \\ φ \\ w \\ {\vec{b}}_{a}^{b} \\ {\vec{b}}_{c}^{b} \\ {b}_{g} \\ {\vec{s}}_{a}^{b} \\ {\vec{s}}_{c}^{b} \\ {s}_{g} \\ {\vec{m}}_{n}\end{matrix} ] = F \vec{X} - \vec{X} + \vec{N} = [ \begin{matrix}{0}_{3 \times 3} & D & {0}_{3 \times 3} & {0}_{3 \times 1} & {0}_{3 \times 1} & {0}_{3 \times 18} \\ {0}_{3 \times 3} & {Ω}_{np}^{p} & {C}_{b}^{p} & {0}_{3 \times 1} & {0}_{3 \times 1} & {0}_{3 \times 18} \\ {0}_{1 \times 3} & {0}_{1 \times 3} & {0}_{1 \times 3} & 0 & 0 & {0}_{1 \times 18} \\ {0}_{1 \times 3} & {0}_{1 \times 3} & {0}_{1 \times 3} & 0 & 1 & {0}_{1 \times 18} \\ {0}_{18 \times 3} & {0}_{18 \times 3} & {0}_{18 \times 3} & {0}_{18 \times 1} & {0}_{18 \times 1} & {0}_{18 \times 18}\end{matrix} ] [ \begin{matrix}{\vec{r}}_{n} \\ {\vec{v}}_{p} \\ {\vec{a}}_{b} \\ φ \\ w \\ {\vec{b}}_{a}^{b} \\ {\vec{b}}_{c}^{b} \\ {b}_{g} \\ {\vec{s}}_{a}^{b} \\ {\vec{s}}_{c}^{b} \\ {s}_{g} \\ {\vec{m}}_{n}\end{matrix} ] - [ \begin{matrix}{0}_{3 \times 1} \\ {C}_{n}^{p} \vec{g} \\ {0}_{22 \times 1}\end{matrix} ] + [ \begin{matrix}{0}_{6 \times 1} \\ {\vec{U}}_{a} \\ 0 \\ {U}_{w} \\ {\vec{n}}_{a} \\ {\vec{n}}_{c} \\ {n}_{g} \\ {0}_{10 \times 1}\end{matrix} ]$$

where each element of \vec{X} represents a state;

\vec{g}=[00g]^{T};

\vec{b}ₐ^{b} represents an accelerometer bias which the accelerometer 820 may have due to the process of manufacturing (for example, if the accelerometer 820 detects an acceleration along one of the axes, when, in reality, the accelerometer 820 is steadily and horizontally placed on the ground or a table top);

\vec{b}_{c}^{b} represents the compass bias which the electronic compass 821 may have due to the process of manufacturing;

\vec{b}_{g} represents the gyroscope bias which the gyroscope 830 may have due to the process of manufacturing;

\vec{s}ₐ^{b} represents the truncation error due to the number of bits (e.g., 10-bit for representing an acceleration value) for representing the acceleration value on the accelerometer scale of the accelerometer 820;

\vec{s}_{c}^{b} represents the truncation error due to the number of bits (e.g., 10-bit for representing a rotational speed) for representing the rotational speed on the compass scale of the electronic compass 821;

\vec{s}_{g} represents the truncation error due to the number of bits (e.g., 10-bit for representing a rotational speed) for representing the rotational speed on the gyroscope scale of the gyroscope 830;

Uₐ represents the change in acceleration due to the force exerted on the input device 288 by the user;

U_{w} represents the change in roll angle φ due to the user using the input device 288 to input information and generate traces;

\vec{N}ₐ represents the change in the accelerometer bias, which the accelerometer 820 may have due to the process of manufacturing, with respect to time;

\vec{N}_{c} represents the change in compass bias, which the electronic compass 821 may have due to the process of manufacturing, with respect to time; and

\vec{N}_{g} represents the change in the gyroscope bias, which the gyroscope 830 may have due to the process of manufacturing, with respect to time.

Similarly, one skilled in the art should be able to easily understand that when the accelerometer bias of the accelerometer 820 or compass bias of the electronic compass 821 due to the process of manufacturing is very small, if the chip design of the accelerometer 820/electronic compass 821 includes self calibration function, or when more bits are used for representing the output value, the effects cause by the bias and scale factors mentioned above may not need to be considered, and thus obtaining state equations including none or less elements (or components) related to the bias or scaling factors. Furthermore, when other factors that may influence the generation of the trace information exist, the number of states of \vec{X} may be increase or decrease, in order to achieve different effects for generating traces.

Similarly, the discrete-time state equation of the trace-calculating module 10-2′ may be represented as follows:

\vec{X}ₖ=Tₖ₋₁\vec{X}ₖ₋₁+\vec{γ}ₖ₋₁+\vec{μ}ₖ₋₁

where

Fₖ₋₁=F|_{\vec{X}}_{ₖ}₋₁

Tₖ₋₁=I+Fₖ₋₁Δt+½Fₖ₋₁²Δt²

$${\vec{γ}}_{k - 1} = [ \begin{matrix}\frac{1}{2} {DC}_{n , k - 1}^{p} g Δ {t}^{2} \\ {C}_{n , k - 1}^{p} g Δ t \\ {0}_{10 \times 1}\end{matrix} ]$$

$$and$$

$${\vec{μ}}_{k - 1} = [ \begin{matrix}{0}_{6 \times 1} \\ {\vec{u}}_{a , k - 1} \\ 0 \\ {u}_{w , k - 1} \\ {\vec{n}}_{a , k - 1} \\ {\vec{n}}_{c , k - 1} \\ {n}_{g , k - 1} \\ {0}_{10 \times 1}\end{matrix} ]$$

where Δt is the sampling period of the motion-sensing module 10-1′;

\vec{γ}ₖ₋₁ is a gravitational acceleration vector at time k−1 in the discrete-time pseudo-frame; and

\vec{μ}ₖ₋₁ is a vector of input process noise at time k−1, which includes noise from user input and each element of the motion-sensing module 10-1′.

Similarly, the relation between the state of the trace-calculating module 10-2′ and the measurement of the motion-sensing module 10-1′ may be represented by the following measurement equation:

$${\vec{Z}}_{k} = h ( {\vec{X}}_{k} ) = [ \begin{matrix}{S}_{a , k} {\vec{a}}_{k}^{b} + {\vec{b}}_{a , k}^{b} \\ {S}_{c , k} {C}_{n , k}^{b} {\vec{m}}_{n , k} + {\vec{b}}_{c , k}^{b} \\ {s}_{g , k} {w}_{k} + {\vec{b}}_{g , k}\end{matrix} ] + Noise$$

Similarly, Noise is measurement noise, C_{n,k}^{b} is the navigation-frame-to-body-frame coordinate transformation matrix at time k, which transforms navigation frame coordinates (subscript n) to the corresponding body frame coordinates (superscript b).

The body-frame-to-pseudo-frame coordinate transformation matrix C_{b}^{p} at time k may be represented as:

$${C}_{b , k}^{p} = [ \begin{matrix}1 & 0 & 0 \\ 0 & cos φ & sin φ \\ 0 & - sin φ & cos φ\end{matrix} ]$$

and the pseudo-frame-to-navigation-frame coordinate transformation matrix Cₙ^{p} at time k may be represented as:

$${C}_{n , k}^{p} = [ \begin{matrix}cos θ cos ψ & - cos θ sin ψ & sin θ \\ sin ψ & cos ψ & 0 \\ - sin θ cos ψ & sin θ sin ψ & cos θ\end{matrix} ]$$

Therefore, navigation-frame-to-body-frame coordinate transformation matrix C_{n,k}^{b} may be obtained according to the equation C_{n,k}^{b}=C_{b,k}^{b T}C_{n,k}^{p}.

In addition, \vec{b}_{g,k} represents the gyroscope bias which the gyroscope 830 may have at time k;

\vec{s}_{g} represents the error due to the scaling factor of the bits representing the rotation speed indicated by the gyroscope 830 at time k;

scaling factor matrix S_{a,k} and S_{c,k} may be represented as:

$${S}_{a , k} = [ \begin{matrix}{S}_{a , x , k}^{b} & 0 & 0 \\ 0 & {S}_{a , y , k}^{b} & 0 \\ 0 & 0 & {s}_{a , z , k}^{b}\end{matrix} ]$$

$${S}_{c , k} = [ \begin{matrix}{S}_{c , x , k}^{b} & 0 & 0 \\ 0 & {S}_{c , y , k}^{b} & 0 \\ 0 & 0 & {S}_{c , z , k}^{b}\end{matrix} ]$$

and similarly, the Kalman Filter 823′ may include a measurement update module 823-1′, a Kalman gain calculation module 823-2′ and a time update module 823-3′.

At the initial stage when the Kalman Filter 823′ starts to operate, first, the initial roll/pitch angle calculating module 824 may calculate the initial roll angle and pitch angle to obtain a initial state vector \vec{X}ₖ, and the navigation frame's initial magnetic vector calculating module 825 may obtain the initial magnetic vector [mₓⁿ, m_{y}ⁿ, m_{z}ⁿ]^{T} of the navigation frame. A covariance matrix Q of the Kalman Filters 823′ related to the changes in the angles about the three axes of the input device due to the bias of the accelerometer 820, the electronic compass 821 and the gyroscope 830, and the user's input may be defined as follows:

$$Q = [ \begin{matrix}{0}_{6 \times 6} & {0}_{6 \times 3} & {0}_{6 \times 1} & {0}_{6 \times 1} & {0}_{6 \times 3} & {0}_{6 \times 3} & {0}_{6 \times 1} & {0}_{6 \times 10} \\ {0}_{3 \times 6} & {σ}_{a}^{2} {I}_{3 \times 3} & {0}_{3 \times 1} & {0}_{3 \times 1} & {0}_{3 \times 3} & {0}_{3 \times 3} & {0}_{3 \times 1} & {0}_{3 \times 10} \\ {0}_{1 \times 6} & {0}_{1 \times 3} & 0 & 0 & {0}_{1 \times 3} & {0}_{1 \times 3} & 0 & {0}_{1 \times 10} \\ {0}_{1 \times 6} & {0}_{1 \times 3} & 0 & {σ}_{w}^{2} & {0}_{1 \times 3} & {0}_{1 \times 3} & 0 & {0}_{1 \times 10} \\ {0}_{3 \times 6} & {0}_{3 \times 3} & {0}_{3 \times 1} & {0}_{3 \times 1} & {σ}_{{b}_{a}}^{2} {I}_{3 \times 3} & {0}_{3 \times 3} & {0}_{3 \times 1} & {0}_{3 \times 10} \\ {0}_{3 \times 6} & {0}_{3 \times 3} & {0}_{3 \times 1} & {0}_{3 \times 1} & {0}_{3 \times 3} & {σ}_{{b}_{c}}^{2} {I}_{3 \times 3} & {0}_{3 \times 1} & {0}_{3 \times 10} \\ {0}_{1 \times 6} & {0}_{1 \times 3} & 0 & 0 & {0}_{1 \times 3} & {0}_{1 \times 3} & {σ}_{{b}_{g}}^{2} & {0}_{1 \times 10} \\ {0}_{10 \times 6} & {0}_{10 \times 3} & {0}_{10 \times 1} & {0}_{10 \times 1} & {0}_{10 \times 3} & {0}_{10 \times 3} & {0}_{10 \times 1} & {0}_{10 \times 10}\end{matrix} ]$$

where

σₐ² represents the variance of the acceleration due to user's input;

σ_{w}² represents the variance in rotation rate in the X_{b} axis direction due to the user's input;

σ_{b}_{ₐ}² represents the variance of the roll angle due to the bias of the accelerometer 820;

σ_{b}_{_{c}}² represents the variance of the roll angle due to the bias of the electronic compass 821; and

σ_{b}_{_{g}}² represents the variance of the roll angle due to the bias of the gyroscope 830.

In one example, the variances mentioned above may be obtained from the calculated variance of the result of multiple experiments. In another example, at least one of the three variances mentioned above may be pre-stored in the Kalman Filter 823′.

A posterior estimate error covariance matrix P₀ of the Kalman Filter 823′ may be defined as follow:

$${P}_{0} = [ \begin{matrix}{0}_{6 \times 6} & {0}_{6 \times 3} & {0}_{6 \times 1} & {0}_{6 \times 1} & {0}_{6 \times 3} & {0}_{6 \times 3} & {0}_{6 \times 1} & {0}_{6 \times 10} \\ {0}_{3 \times 6} & {σ}_{a}^{2} {I}_{3 \times 3} & {0}_{3 \times 1} & {0}_{3 \times 1} & {0}_{3 \times 3} & {0}_{3 \times 3} & {0}_{3 \times 1} & {0}_{3 \times 10} \\ {0}_{1 \times 6} & {0}_{1 \times 3} & 0 & 0 & {0}_{1 \times 3} & {0}_{1 \times 3} & 0 & {0}_{1 \times 10} \\ {0}_{1 \times 6} & {0}_{1 \times 3} & 0 & {σ}_{w}^{2} & {0}_{1 \times 3} & {0}_{1 \times 3} & 0 & {0}_{1 \times 10} \\ {0}_{3 \times 6} & {0}_{3 \times 3} & {0}_{3 \times 1} & {0}_{3 \times 1} & {I}_{3 \times 3} & {0}_{3 \times 3} & {0}_{3 \times 1} & {0}_{3 \times 10} \\ {0}_{3 \times 6} & {0}_{3 \times 3} & {0}_{3 \times 1} & {0}_{3 \times 1} & {0}_{3 \times 3} & {I}_{3 \times 3} & {0}_{3 \times 1} & {0}_{3 \times 10} \\ {0}_{1 \times 6} & {0}_{1 \times 3} & 0 & 0 & {0}_{1 \times 3} & {0}_{1 \times 3} & 1 & {0}_{1 \times 10} \\ {0}_{10 \times 6} & {0}_{10 \times 3} & {0}_{10 \times 1} & {0}_{10 \times 1} & {0}_{10 \times 3} & {0}_{10 \times 3} & {0}_{10 \times 1} & {I}_{10 \times 10}\end{matrix} ]$$

A measurement noise covariance matrix R of the Kalman Filter 823′ may be defined as follow:

$$R = [ \begin{matrix}{σ}_{ma}^{2} {I}_{3 \times 3} & {0}_{3 \times 3} & {0}_{3 \times 1} \\ {0}_{3 \times 3} & {σ}_{mc}^{2} {I}_{3 \times 3} & {0}_{3 \times 1} \\ {0}_{1 \times 3} & {0}_{1 \times 3} & {σ}_{mg}^{2}\end{matrix} ]$$

where σₘₐ², represents the measurement noise variance of the accelerometer 820, σ_{mc}², represents the measurement noise variance of the electronic compass 821, and σ_{mg}² represents the measurement noise variance of the gyroscope 830.

In one example, the measurement noise variance σₘₐ² of the accelerometer 820, the measurement noise variance σ_{mc}² of the electronic compass 821, or the measurement noise variance σ_{mg}² of the gyroscope 830 may be obtained through experiment and be pre-stored in the Kalman Filter 823′.

Subsequently, the time update module 823-3′ may be configured to calculate the following equations:

\vec{X}ₖ⁻=Tₖ{right arrow over (\hat{X}ₖ₋₁+{right arrow over (\hat{γ}ₖ₋₁

Aₖ=Jacobian(Tₖ{right arrow over (\hat{X}ₖ₋₁+\vec{γ}ₖ₋₁)

Pₖ⁻=AₖPₖ₋₁Aₖ^{T}+Q

where {right arrow over (\hat{X}ₖ represents the a posteriori estimated state vector \vec{X}ₖ of measured \vec{Z}ₖ at time k, A is the Jacobian determinant of \vec{X}ₖ⁻, and Pₖ⁻ represents the a priori estimated error covariance matrix at time k.

Similarly, the Kalman gain calculating module 823-2′ may be configured to calculate the following equations to obtained the Kalman gain Kₖ at time k.

Hₖ=Jacobian(h(\vec{X}ₖ⁻))

Kₖ=Pₖ⁻Hₖ^{T}(HₖPₖ⁻Hₖ^{T}R)⁻¹

Similarly, measurement update module 823-1′ may be configured to calculate the following equation to obtain an estimation state vector \vec{X}ₖ:

{right arrow over (\hat{X}ₖ=\vec{X}ₖ⁻+Kₖ(\vec{Z}ₖ−h(\vec{X}ₖ⁻))

Pₖ=(I−KₖHₖ)Pₖ⁻

where Pₖ is the a posterior estimate error covariance matrix at time k. Estimated pitch angle \hat{θ} and yaw angle \hat{ψ} may thus be obtained.

FIG. 4B is a plot comparing the measured and the actual acceleration ins the X_{b} axis direction according to an example of the present invention, where the measured acceleration in the X_{b} axis direction measured by the accelerometer 820 is represented by a broken line, and the actual acceleration in the X_{b} axis direction is represented by a solid line. The horizontal axis indicates the number of samples.

FIG. 4C is a plot comparing the measured and the actual accelerations in the Y_{b} axis direction according to an example of the present invention, where the measured acceleration in the Y_{b} axis direction measured by the accelerometer 820 is represented by a broken line, and the actual acceleration in the Y_{b} axis direction is represented by a solid line. The horizontal axis indicates the number of samples.

FIG. 4D is a plot comparing the measured and the actual accelerations in the Z_{b} axis direction according to an example of the present invention, where the measured acceleration in the Z_{b} axis direction measured by the accelerometer 820 is represented by a broken line, and the actual acceleration in the Z_{b} axis direction is represented by a solid line. The horizontal axis indicates the number of samples.

FIG. 4E is a plot comparing the measured and the actual terrestrial magnetisms in the X_{b} axis direction according to an example of the present invention, where the measured terrestrial magnetism in the X_{b} axis direction measured by the electrical compass 821 is represented by a broken line, and the actual terrestrial magnetism in the X_{b} axis direction is represented by a solid line. The horizontal axis indicates the number of samples.

FIG. 4F is a plot comparing the measured and the actual terrestrial magnetisms in the Y_{b} axis direction according to an example of the present invention, where the measured terrestrial magnetism in the Y_{b} axis direction measured by the electrical compass 821 is represented by a broken line, and the actual terrestrial magnetism in the Y_{b} axis direction is represented by a solid line. The horizontal axis indicates the number of samples.

FIG. 4G is a plot comparing the measured and the actual terrestrial magnetisms in the Z_{b} axis direction according to an example of the present invention, where the measured terrestrial magnetism in the Z_{b} axis direction measured by the electrical compass 821 is represented by a broken line, and the actual terrestrial magnetism in the Z_{b} axis direction is represented by a solid line. The horizontal axis indicates the number of samples.

FIG. 4H is a plot comparing the measured and the actual roll angles about the X_{b} axis according to an example of the present invention, where the measured roll angle about the X_{b} axis measured by the 1D gyroscope 830 is represented by a broken line, and the actual roll angle about the X_{b} axis is represented by a solid line. The horizontal axis indicates the number of samples.

FIG. 4I is a plot comparing the estimated and the actual terrestrial magnetisms in the X_{b} axis direction according to an example of the present invention, where the estimated terrestrial magnetism in the X_{b} axis direction estimated by the Kalman Filter 823′ is represented by a broken line, and the actual terrestrial magnetism in the X_{b} axis direction is represented by a solid line. The horizontal axis indicates the number of samples.

FIG. 4J is a plot comparing the estimated and the actual terrestrial magnetisms in the Y_{b} axis direction according to an example of the present invention, where the estimated terrestrial magnetism in the Y_{b} axis direction estimated by the Kalman Filter 823′ is represented by a broken line, and the actual terrestrial magnetism in the Y_{b} axis direction is represented by a solid line. The horizontal axis indicates the number of samples.

FIG. 4K is a plot comparing the estimated and the actual terrestrial magnetisms in the Z_{b} axis direction according to an example of the present invention, where the estimated terrestrial magnetism in the Z_{b} axis direction estimated by the Kalman Filter 823′ is represented by a broken line, and the actual terrestrial magnetism in the Z_{b} axis direction is represented by a solid line. The horizontal axis indicates the number of samples.

FIG. 4L is a plot comparing the estimation error and the measurement error of terrestrial magnetism in the X_{b} axis direction according to an example of the present invention, where the estimation error of terrestrial magnetism, which is the difference between the estimated terrestrial magnetism in the X_{b} axis calculated by the Kalman Filter 823′ and the actual terrestrial magnetism in the X_{b} axis, is represented by a broken line, and the measurement error of terrestrial magnetism, which is the difference between the measured terrestrial magnetism in the X_{b} axis direction and the actual terrestrial magnetism in the X_{b} axis, is represented by a solid line. The horizontal axis indicates the number of samples. From the simulation result, it may be deduced that estimated terrestrial magnetism calculated by the Kalman Filter 823′ of the present invention is closer to the actual terrestrial magnetism in comparison to the terrestrial magnetism measured directly by the electronic compass 821 (the error is smaller).

FIG. 4M is a plot comparing the estimation error and the measurement error of terrestrial magnetism in the Y_{b} axis direction according to an example of the present invention, where the estimation error of terrestrial magnetism, which is the difference between the estimated terrestrial magnetism in the Y_{b} axis calculated by the Kalman Filter 823′ and the actual terrestrial magnetism in the Y_{b} axis, is represented by a broken line, and the measurement error of terrestrial magnetism, which is the difference between the measured terrestrial magnetism in the Y_{b} axis direction and the actual terrestrial magnetism in the Y_{b} axis, is represented by a solid line. The horizontal axis indicates the number of samples. From the simulation result, it may be deduced that estimated terrestrial magnetism calculated by the Kalman Filter 823′ of the present invention is closer to the actual terrestrial magnetism in comparison to the terrestrial magnetism measured directly by the electronic compass 821 (the error is smaller).

FIG. 4N is a plot comparing the estimation error and the measurement error of terrestrial magnetism in the Z_{b} axis direction according to an example of the present invention, where the estimation error of terrestrial magnetism, which is the difference between the estimated terrestrial magnetism in the Z_{b} axis calculated by the Kalman Filter 823′ and the actual terrestrial magnetism in the Z_{b} axis, is represented by a broken line, and the measurement error of terrestrial magnetism, which is the difference between the measured terrestrial magnetism in the Z_{b} axis direction and the actual terrestrial magnetism in the Z_{b} axis, is represented by a solid line. The horizontal axis indicates the number of samples. From the simulation result, it may be deduced that the estimated terrestrial magnetism calculated by the Kalman Filter 823′ of the present invention is closer to the actual terrestrial magnetism in comparison to the terrestrial magnetism measured directly by the electronic compass 821 (the error is smaller).

FIG. 4O is a plot comparing the estimated acceleration in the X_{b} axis direction estimated by the Kalman Filter 823′ according to an example of the present invention to the actual acceleration. The horizontal axis indicates the number of samples.

FIG. 4P is a plot comparing the estimated acceleration in the Y_{b} axis direction estimated by the Kalman Filter 823′ according to an example of the present invention to the actual acceleration. The horizontal axis indicates the number of samples.

FIG. 4Q is a plot comparing the estimated acceleration in the Z_{b} axis direction estimated by the Kalman Filter 823′ according to an example of the present invention to the actual acceleration. The horizontal axis indicates the number of samples.

FIG. 4R is a plot comparing the measurement error and the estimation error of acceleration in the X_{b} axis direction according to an example of the present invention, where the estimation error of acceleration, which is the difference between the estimated acceleration in the X_{b} axis calculated by the Kalman Filter 823′ and the actual acceleration in the X_{b} axis, is represented by a broken line, and the measurement error of terrestrial magnetism, which is the difference between the measured acceleration in the X_{b} axis direction and the actual acceleration in the X_{b} axis, is represented by a solid line. The horizontal axis indicates the number of samples. From the simulation result, it may be deduced that the estimated acceleration calculated by the Kalman Filter 823′ of the present invention is closer to the actual acceleration in comparison to the acceleration measured directly by the accelerometer 820 (the error is smaller).

FIG. 4S is a plot comparing the measurement error and the estimation error of acceleration in the Y_{b} axis direction according to an example of the present invention, where the estimation error of acceleration, which is the difference between the estimated acceleration in the Y_{b} axis calculated by the Kalman Filter 823′ and the actual acceleration in the Y_{b} axis, is represented by a broken line, and the measurement error of terrestrial magnetism, which is the difference between the measured acceleration in the Y_{b} axis direction and the actual acceleration in the Y_{b} axis, is represented by a solid line. The horizontal axis indicates the number of samples. From the simulation result, it may be deduced that estimated acceleration calculated by the Kalman Filter 823′ of the present invention is closer to the actual acceleration in comparison to the acceleration measured directly by the accelerometer 820 (the error is smaller).

FIG. 4T is a plot comparing the measurement error and the estimation error of acceleration in the Z_{b} axis direction according to an example of the present invention, where the estimation error of acceleration, which is the difference between the estimated acceleration in the Z_{b} axis calculated by the Kalman Filter 823′ and the actual acceleration in the Z_{b} axis, is represented by a broken line, and the measurement error of terrestrial magnetism, which is the difference between the measured acceleration in the Z_{b} axis direction and the actual acceleration in the Z_{b} axis, is represented by a solid line. The horizontal axis indicates the number of samples. From the simulation result, it may be deduced that estimated acceleration calculated by the Kalman Filter 823′ of the present invention is closer to the actual acceleration in comparison to the acceleration measured directly by the accelerometer 820 (the error is smaller).

FIG. 4U is the estimated and actual bias in the X_{b} axis direction of the accelerometer 820 according to an example of the present invention.

FIG. 4V is the estimated and actual scaling factor in the X_{b} axis direction of the accelerometer 820 according to an example of the present invention.

FIG. 4W is the estimated and actual bias in the X_{b} axis direction of the electrical compass 821 according to an example of the present invention.

FIG. 4X is the estimated and actual scaling factors in the X_{b} axis direction of the electrical compass 821 according to an example of the present invention.

FIG. 4Y is a plot comparing the estimated yaw angle calculated by the Kalman filter 823′ according to an example of the present invention to the actual yaw angle. The horizontal axis is the number of samples.

FIG. 4Z is a plot comparing the estimated pitch angle calculated by the Kalman filter 823′ according to an example of the present invention to the actual pitch angle. The horizontal axis is the number of samples.

FIG. 4a is a plot comparing the estimated roll angle calculated by the Kalman filter 823′ according to an example of the present invention to the actual roll angle. The horizontal axis is the number of samples.

FIG. 4b is a plot comparing the trace converged from the Kalman Filter 823′ of an example of the present invention to the actual trace of the input device 288. From the simulation result, it may be deduced that after being calculated by the trace-calculating module 10-2, the trace generated by the trace-generating device 10 is very close to the actually trace of the input device 288.

FIG. 4c is a 3D plot comparing the trace converged from the Kalman Filter 823′ of an example of the present invention to the actual trace of the input device 288. Similarly, from the simulation result, it may be deduced that after being calculated by the trace-calculating module 10-2, the trace generated by the trace-generating device 10 is very close to the actually trace of the input device 288.

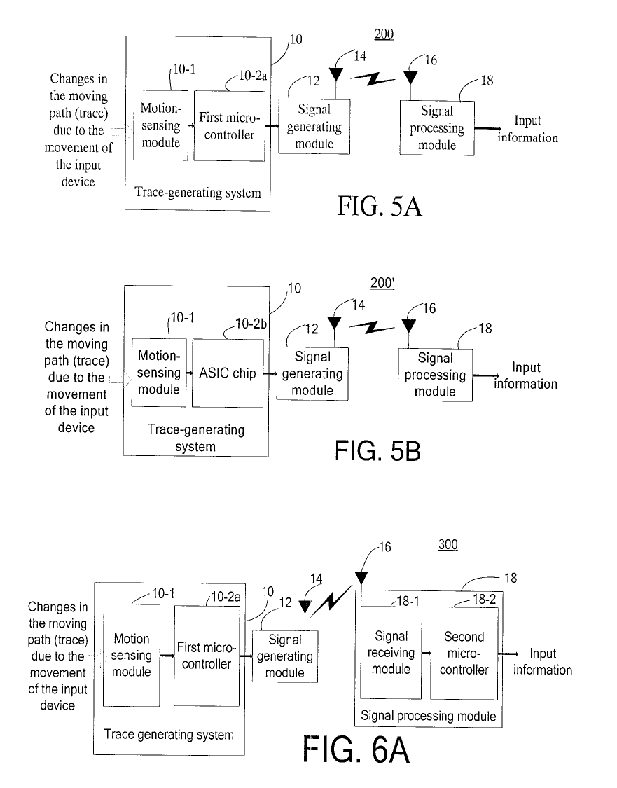

FIG. 5A is a block diagram of a control/information input system 200 having the trace-generating device 10 applied therein according to another example of the present invention. The control/information input system 200 described in FIG. 5A may be the same as or similar to the control/information input system 100b having the trace-generating device 10 therein described in FIG. 1B, except that the trace-calculating module 10-2 may further include a first microcontroller 10-2a. According to World Semiconductor Trade Statistics (WSTS), a microcontroller is a semiconductor element that can operate independently without having to be connected to other external circuits, such as memory. In this example, the first microcontroller 10-2a may be a system on a chip (SoC) including an on-chip memory, such as a cache or a read-only memory (ROM), where the on-chip memory may store executable programs (codes) for achieving the functions of the trace-calculating module 10-2. The first microcontroller 10-2a may be configured to receive the accelerations and terrestrial magnetisms (and/or roll angles) measured by the motion-sensing module 10-1, and generate a piece of trace information by executing the program mentioned above to performing calculations. The trace information may include yaw and pitch angles of the input device, which has the control/information input system 200 applied therein, or X,Y coordinates (navigation frame), obtained from the yaw and pitch angles, corresponding to a remote/controlled device. In one example, the trace-calculating module 10-2 may be coupled to or include a memory, such as a flash, a cache, a random access memory (RAM) or a ROM, which may store programs (codes) and be coupled to the first microcontroller 10-2a, and allow the first microcontroller 10-2a to retrieve the programs (codes).

In addition, one skilled in the art may easily understand that the role played by the above-mentioned first microcontroller 10-2a does not necessarily be a microcontroller circuit (chip) having the configuration of SoC like that of the first microcontroller 10-2a. In other examples, the first microcontroller 10-2a may also use a digital signal processing (DSP) module with an external memory, such as a flash, a cache, a RAM or a ROM, or an Application-Specific Integrated Circuit; ASIC) for implementation. Therefore, the present invention is not limited to the examples described herein.

For example, referring to FIG. 5B, FIG. 5B is a block diagram of an information input system 200′ according to another example of the present invention. Besides replacing the first microcontroller 10-2a in FIG. 5A with an ASIC chip 10-2b, the control/information input system 200′ having the trace-generating device 10 applied therein in FIG. 5B may be the same as or similar to the control/information input system 200 described in FIG. 5A. In this example, the ASIC chip 10-2b may include multiple logic gates and may be configured to process the accelerations and terrestrial magnetism (and/or roll angles) measured by the motion-sensing module 10-1 to generate trace information, such as the yaw and pitch angles of the input device, or further processing the yaw and pitch angles to obtain the corresponding X,Y coordinates (navigation frame) of a remote/controlled device. One skilled in the art should be able to easily understand that the ASIC chip 10-2b may also be replaced by a digital signal processor and a ROM storing a program.

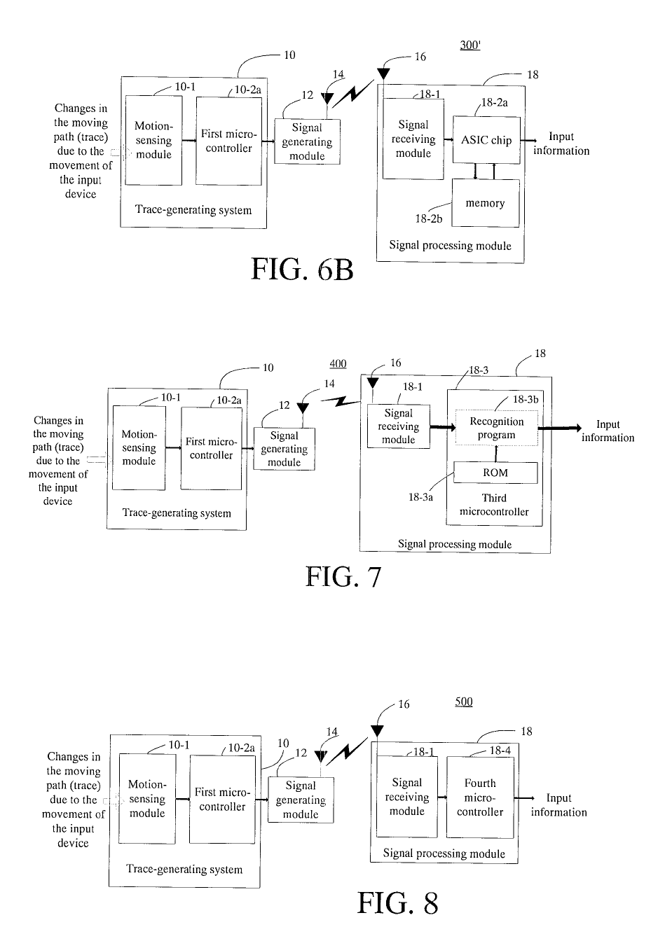

FIG. 6A is a block diagram of a control/information input system 300 having the trace-generating device 10 applied therein according to another example of the present invention. Referring to FIG. 6A, except that the signal processing module 18 may further include a signal receiving module 18-1 and a second microcontroller 18-2, the control/information input system 300 described in FIG. 6A may be similar to the control/information input system 200 described in FIG. 5A. The signal receiving module 18-1 may process the transmit signal received by the second antenna 16, and transform the received signal into a digital signal. The second microcontroller 18-2 may include multiple logic gates and static random access memory. A first portion of the multiple logic gates may be configured to convert (restore) the trace information (may include multiple coordinates) from the digital signal and store the trace information in the static RAM. The second portion of the multiple logic gates may be configured to interpret the changes in the coordinates in the trace information as a stroke, and process multiple strokes to identify at least one of a number, a word, a character, a punctuation, a mathematical operator and a hand-written symbol that corresponds to the multiple strokes, in order to generate or interpret the information originally input by the user. One skilled in the art should be able to easily understand that the second microcontroller 18-2 may be implemented by a digital signal processing module with a memory, such as a flash, a cache, a RAM or a ROM, or an ASIC. Therefore, the signal processing module 18 of the present invention is not limited to a microcontroller.

For example, please refer to FIG. 6B. FIG. 6B is a block diagram of a control/information input system 300′ having the trace-generating device 10 applied therein according to yet another example of the present invention. Except that the second microcontroller 18-2 in FIG. 6A is replaced by an ASIC chip 18-2a with a memory 18-2b, the control/information input system 300′ described in FIG. 6B may be similar to the control/information input system 300 described in FIG. 6A. In this example, the ASIC chip 18-2a may be configured to be specifically used for processing the transmit signal received by the signal receiving module 18-1, recording the changes in the coordinates indicated by the trace information represented by the signal, and interpreting and generating input information (such as the corresponding character key code or ASCII code etc.) One skilled in the art should be able to easily understand that the ASIC chip 18-2a may be replaced by a digital signal processor and a read only memory storing a program. Implementation methods as such may be the same as or similar to the invention described below with references to FIG. 7.

Referring to FIG. 7, FIG. 7 is a block diagram of a control/information input system 400 having the trace-generating device 10 applied therein according to another example of the present invention. Besides the signal processing module 18 that may include a third microcontroller 18-3 different from the second microcontroller 18-2, the control/information input system 400 described in FIG. 7 may be the same as or similar to the control/information input system 300 described in FIG. 6A. The third microcontroller 18-3 may be configured to use an recognition program 18-3b to interpret the trace information (with the changes to the coordinate) as a stroke, and process multiple strokes to interpret at least one of a number, a word, a character, a punctuation, a mathematical operator, and a hand-written symbol corresponding to the multiple strokes, so as to generate the input information. In one example, the recognition program 18-3b may be stored in a ROM 18-3a. One skilled in the art may easily understand that it may not be necessary to store the recognition program 18-3b in the ROM 18-3a. In another example, the third microcontroller 18-3 may include a flash or a cache for storing the recognition program 18-3b.

FIG. 8 is a block diagram of a control/information input system 500 having the trace-generating device 10 applied therein according to another example of the present invention. Referring to FIG. 8, except that the third microcontroller 18 in FIG. 7 is replaced by a fourth microcontroller 18-4 in FIG. 8, the control/information input system 500 described in FIG. 8 may be the same as or similar to the control/information input system 400 in FIG. 7. In this example, the control/information input system 500 may be coupled to a system including a screen, and the system may display an item or a cursor on the screen. A user may use the control/information input system of the present invention to move the cursor or move the cursor to be on top of or near by the item, and click or select the item. The fourth microcontroller 18-4 may be configured to convert the trace information into the coordinates of the cursor, so as to cause the position of the cursor to change according to the movement of the trace-generating device 10, and generate the information input by the user which may be changing the coordinates of the cursor or performing the action of selecting the item. In another example, when being used in combination with the functions of the aforementioned second and third microcontrollers, the signal processing module 18 may first determine whether or not a first initial condition has been establish, in order to understand whether the user's desired input is a word, symbol, movement of a cursor or using the cursor to select an item in the screen, then decide whether or not to activate the hand-writing recognition function, similar to that of the second and third microcontroller. For example, the user may quickly shake the trace-generating device 10 twice (establishing the first initial condition). When the two quick shakes were detected by the trace-generating device 10 and sent to the signal processing module 18, the signal processing module 18 may determine that the user desires to input information and would interpret the trace information in the received signal as commands for moving a cursor or using the cursor to select an item displayed on the screen; otherwise, perform hand-writing recognition on the trace information and generate input information. One skilled in the art should be able to understand that using the aforementioned method of determining the first initial condition in order to operate the information input system of the present invention, the information input system of the present invention may be used for replacing the keyboard and mouse (or track ball) of a computer or a notebook computer.

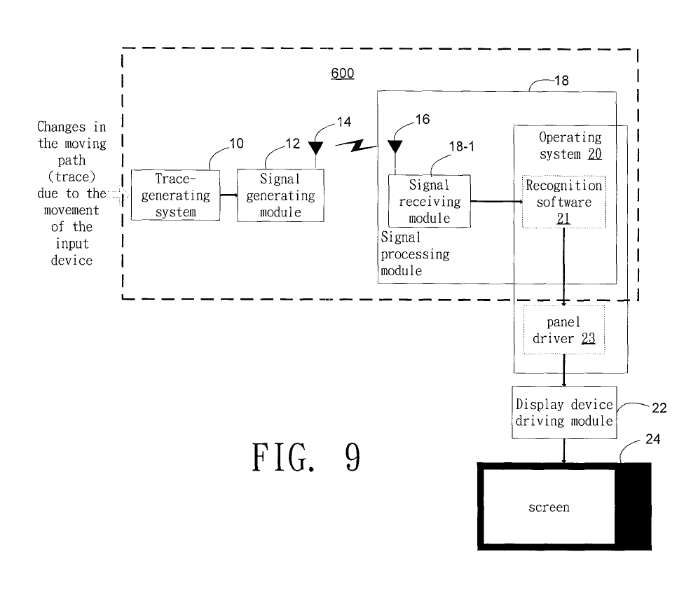

FIG. 9 is a block diagram of a control/information input system having the trace-generating device 10 applied therein according to an example of the present invention. Referring to FIG. 9, besides the signal processing module 18 in FIG. 9 that may be different from the signal processing modules in the aforementioned figures, the control/information input system 600 may be the same as or similar to the control/information input systems mentioned above. The signal processing module 18 may include a recognition software 21 executable in operating system 20. The recognition software 21 may be configured to execute a hand-writing recognition program for processing the input, including stroke information, from the signal receiving module 18-1. Subsequently, using the operating system 20 with a panel driver 23, the information desired to be displayed may be sent to a display device driving module 22 to drive a display module, such a screen 24, to display input information desired by a user, who gestures the trace-generating device 10 with movements similar to that of writing characters or symbols. In an example, the display device driving module 22 may be a graphics card. One skilled in the art should be able to understand that although the frame of the operating system (broken line) includes a part of the signal processing module 18 (such as the recognition software 21). The purpose of this is to indicate that the recognition software 21 is an application software or program that may be executed under the environment of the operating system 20, but not to indicate that the operating system 20 includes the signal processing module 18, or that the signal processing module includes the operating system 20. Furthermore, one skilled in the art should be able to understand that for different applications, the operating system 20 may be one of UNIX, Widows or Linux or be one of Palm OS, WinCE OS, EPOC OS, Penbex OS, Mine OS, Symbian OS. Moreover, the recognition software 21 may be used in combination with built-in handwriting recognition function of the operating system.

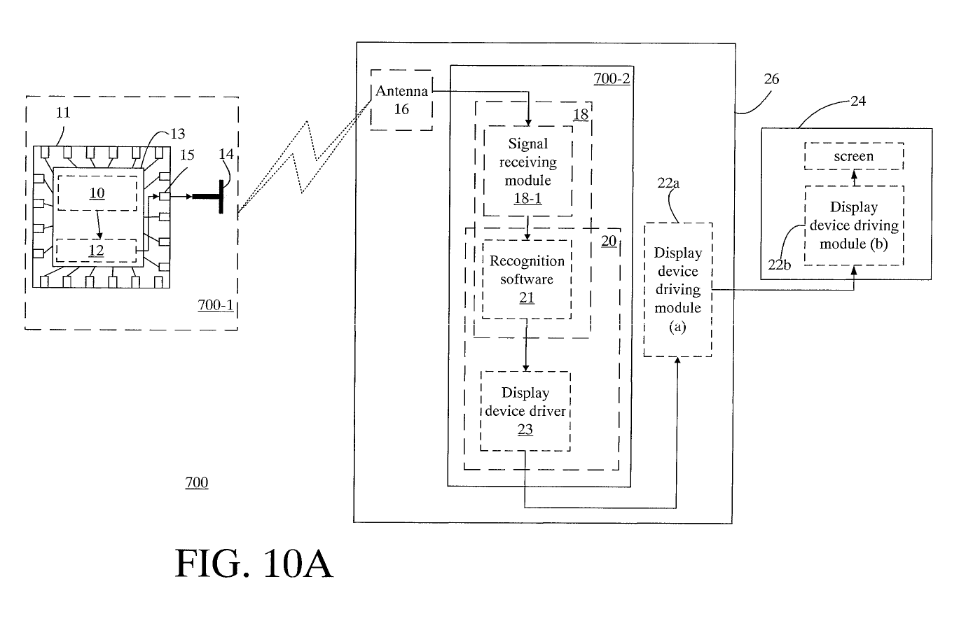

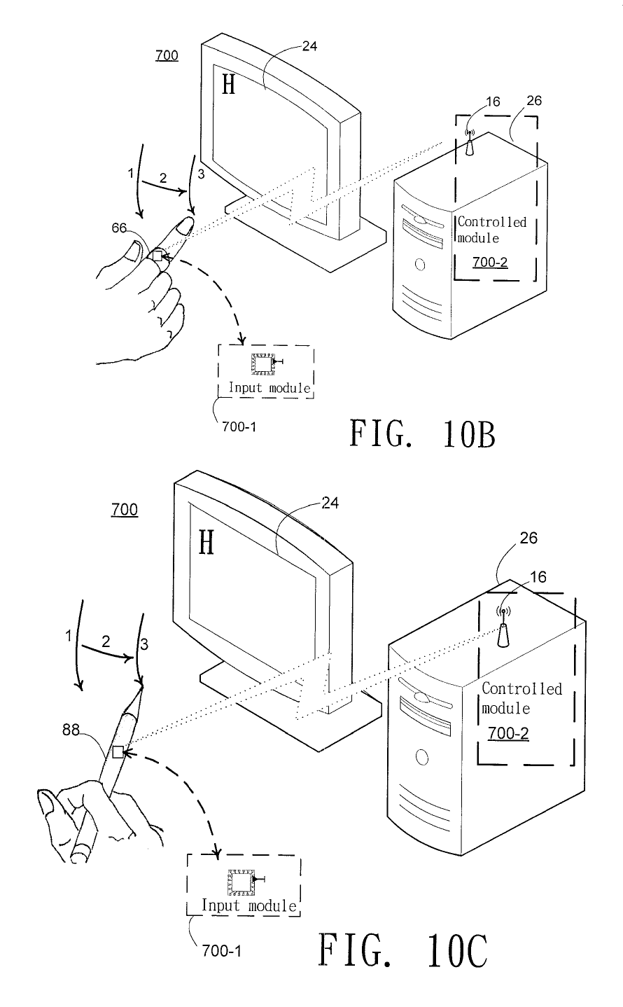

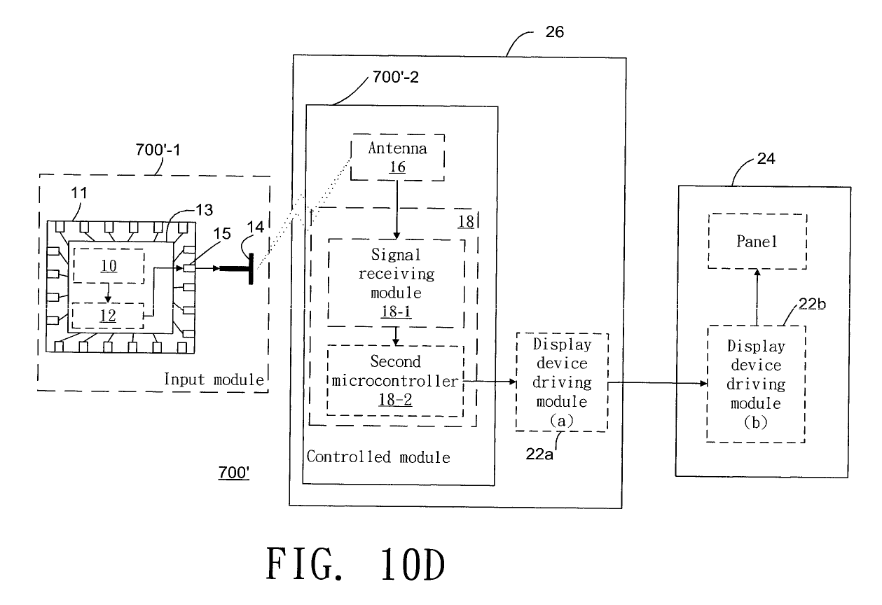

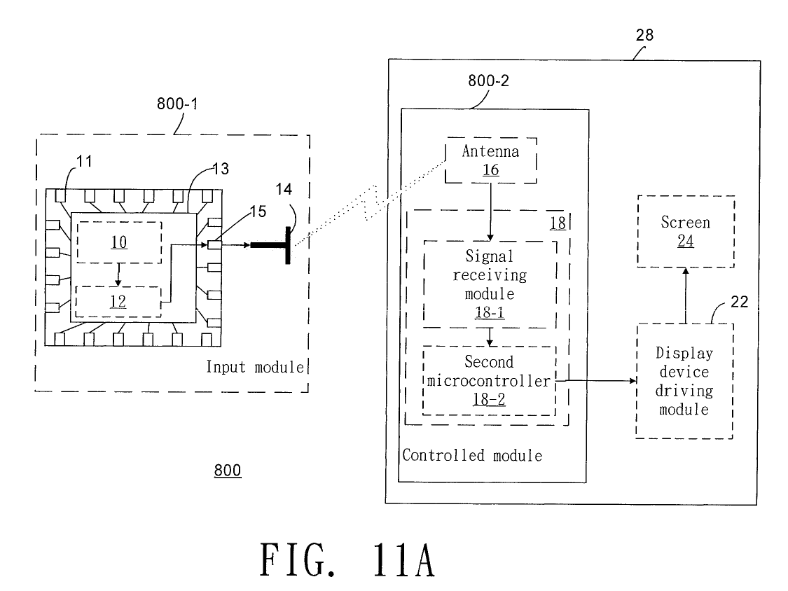

FIG. 10A is a schematic diagram of a control/information input system 700 having the trace-generating device 10 aaplied therein according to an example of the present invention. The control/information input system 700 of the present invention may be used when inputting information to a host 26, such as a computer, a workstation, a server or a home server of a digital home system, is desired. Referring to FIG. 10A, the control/information input system 700 may include an input module 700-1 and a controlled module 700-2 configured in or coupled to the host 26. The input module 700-1 may include a die 13 and a first antenna 14 packaged in a package 11. The die 13 may be a SoC, and may include a trace-generating device 10 and a transmit signal generating module 12. The trace-generating device 10 may be configured to sense the movement of itself (the trace-generating device 10 or the die 13), in order to generate trace information. The signal generating module 12 coupled to the trace-generating device 10 may process the trace information and generate a transmit signal. Subsequently, via the line of one of PIN 15 coupled to the package 11, the signal generating module 12 sends the transmit signal to the PIN 15, and then transmit the transmit signal via the first antenna 14 coupled to the PIN 15. The controlled module 700-2 may further include a second antenna 26 and a signal processing module 18. In one example, the second antenna 15 may be coupled to the host 26. In another example, the second antenna 16 may be included in (built-in) or on the host 26. The signal processing module 18 may also be configured in the host 26. Furthermore, the signal processing module 18 may include a signal receiving module 18-1 and a recognition software 21. In addition, host 26 may further include an operating system 20 and a display driving module 22a. The operating system 20 may include a display device driver 23 capable of converting input information to information for being displayed on a display device (screen, such as a television screen or a computer screen) 24 coupled to (connected to) the host 26. The recognition software 21 and the display device driver 23 may be executed in the environment of the operating system 20. The second antenna 16 may be configured to receive the transmit signal transmitted by the first antenna 14 and transmit the received signal to the signal receiving module 18-1 of the signal processing module 18. Subsequently, the signal receiving module 18-1 may convert the received signal to a digital signal, and using the recognition software to restore the original information (characters or symbols) input by the user. Subsequently, using the display device driver 23 and the display device driving module 22a to control the display device driving module 22b of the screen 24, in order to display the input information on the screen 24. In one example, the display device driving module 22a may include a graphics card. In another example, the display device driving module 22b may include a driver IC of a panel.

FIG. 10B is a schematic diagram of the operation of the control/information input system 700 in FIG. 10A. Referring to FIG. 10B, the input module 700-1 may be set up in or on an object 66 that may be worn on a hand or a finger of a user. The object 66 may be a bracelet, a bangle, a watch, a finger stall, a glove or a ring, or even in a piece of clothing or a sleeve. When the user uses his hand or finger to perform movements similar to that of writing characters or symbols, such as movements 1, 2 and 3, in the air or on other objects, such as a table top or a wall, the trace-generating device 10 in the input module 700-1 may measure the traces (or paths) of the movements and send them to the signal generating module 12. The signal generating module 12 will then convert the traces (or paths) into a transmit signal and send it to the controlled module 700-2. Subsequently, using the signal processing module 18 set up in or coupled to the host 26, operating system 20, display device driving module 22a and display device driving module 22b, the measured traces (or paths) may be converted into the character “H” or other symbols and be displayed on screen 24, so as to achieve the purpose of inputting information. One skilled in the art should be able to easily understand that the input module 700-1 may be set up in objects that may be worn on other body parts. In one example, the input module 700-1 of the present invention may be set up in or on an anklet or a foot ring, so that a user may wear the anklet or foot ring and use his foot to perform movements similar to that of writing characters or symbols with hands. Applications as such may bring conveniences to users with hand or arm disabilities when inputting information or communicating with the host 26. In another example, the input module 700-1 of the present invention may be set up in or on a cap, a nose cover or an earring, so that another user may wear the cap, the nose cover or the earring and use his head to perform movements similar to that of writing characters or symbols to input information (such as characters). Methods and applications as such may greatly convenient users with hand or foot disabilities to input information to or communication with the host 26. Moreover, one skilled in the art should be able to easily understand that setting up the aforementioned input module 700-1 in wearable objects 66 may include setting up the input module 700-1 inside the wearable objects 66, or fixing or attaching the input module 700-1 on the wearable objects 66. Therefore, the method of setting up the input module 700-1 in or on the wearable objects 66 of the present invention should not be limited to the examples described herein. In one example, a user may stick or attach the input module 700-1 on a watch he is wearing, so that he may input information to the host 26 set up with the controlled module 700-2 by waving the hand wearing the watch having the input module 700-1 attached thereon.

FIG. 10C is a schematic diagram of another operation of the control/information input system 700 in FIG. 10A. Referring to FIG. 10C, besides changing the hand wearable object 66 to a hand-heldable device 88 (such as a pen), the method of operating the information input system 700 is the same as or similar to the operating method as showing in FIG. 6B. One skilled in the art should be able to easily understand that the pen 88 shown in the figure is for facilitating illustration purpose only. In other examples, the input module 700-1 may be set up in other types of hand-heldable devices, and thus the type of hand-heldable devices which the input module 700-1 is set up in should not be a limitation of the present invention. In other example, the input module 700-1 may also be set up in a mouse, a cellular phone or a remote control, so that a user may conveniently us the mouse, cellular phone or the remote control to input information into a remote host 26 wirelessly.

Referring to FIGS. 10A, 10B and 10C again, one skilled in the art should be able to easily understand that the control/information input system 700 may also be replaced by the control/information input systems 200, 200′, 300, 300′, 400 or 500 as shown in FIGS. 5A to 8 without departing from the method of operating the control/information input device 700 of the present invention as shown in FIGS. 10B to 10C. For example, referring to FIG. 10D, FIG. 10D is a schematic diagram of applying the trace-generating device 10 to a control/information input system 700′ according to an example of the present invention, where the control/information input system 700′ may be implemented in the same or similar manner as the control/information input system 300 in FIG. 6A.

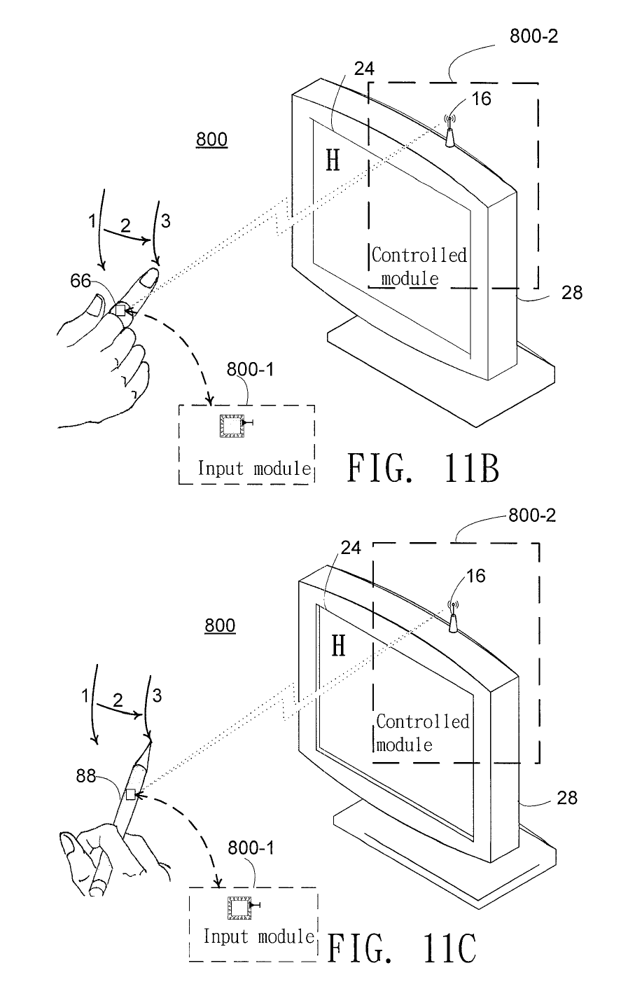

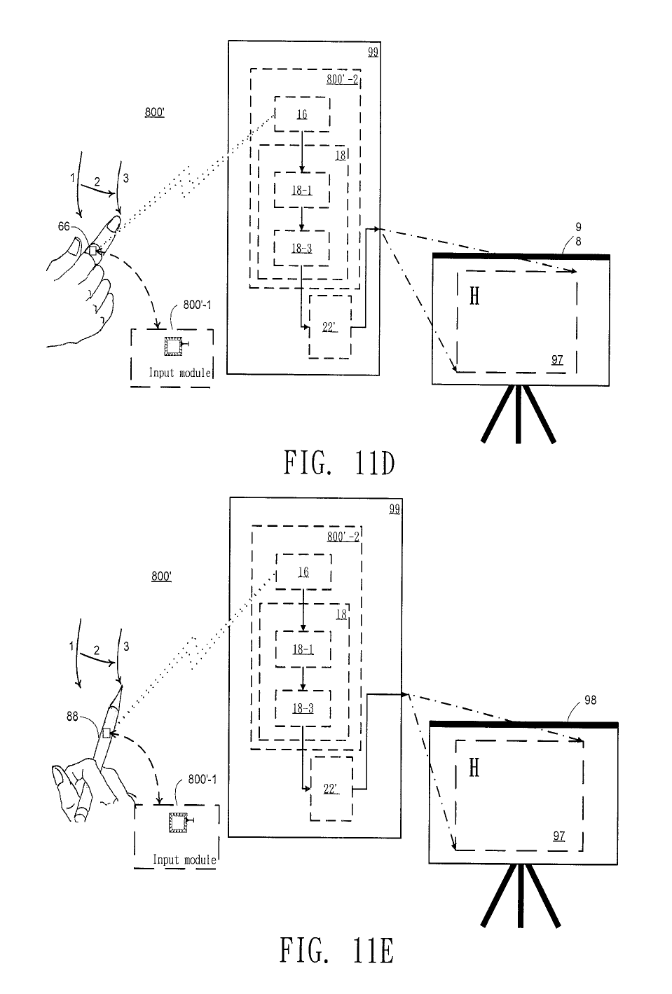

FIG. 11A is a schematic diagram of applying the trace-generating device 10 to a control/information input system 800 according to another example of the present invention. Referring to FIG. 11A, the control/information input system 800 may include an input module 800-1 and a controlled module 800-2. Besides that the second antenna 16 may be set up on a television 28 or built-in to the television 28, and that the signal processing module 18 may be built-in to the television 28, the control/information input system 800 may be the same as or similar to the control/information input system 700 or 700′ of FIGS. 10A to 10D described above. The signal receiving module 18-1 may process the transmit signal received by the second antenna 16, and convert the received signal into a digital signal. The second microcontroller 18-2 may include multiple logic gates. A first portion of the multiple logic gates may be configured for converting (or restoring) the trace information from the digital signal, and a second portion of the multiple logic gates may be configured for recognizing the trace information as a stroke and processing multiple strokes to interpret at least one of a number, a word, a character, a punctuation, a mathematical operator and a hand-written symbol that corresponds to the multiple strokes, and generate (or restore) the original input information input by the user and display the information on a screen 24 of the television 28.

FIG. 11B is a schematic diagram of operating the control/information input system 800 in FIG. 11A. Using the same or similar operating method as shown in FIG. 10B, a user may operate a control/information input system 800 to input information by means of his hand or finger wearing an object 66 (such as a bracelet, a bangle, a watch, a finger stall or a ring) which as a input module 800-1 set up thereon. When the user uses his hand or finger to perform movements simulating the writing of characters or symbols, such as movements 1, 2 and 3, in the air or on other objects, such as table top of wall, the trace-generating device 10 in the input module 800-1 may measure the traces (or paths) of the movements and send the measured traces (or paths) to the signal generating module 12. The signal generating module 12 will then convert the measured traces (or paths) into a transmit signal and transmit the transmit signal to the second antenna 16. Subsequently, using the signal processing module 18 and the display device driving module 22, the movement of the user may be converted into the character “H” or other symbols and be displayed in the screen 24 of the television 28. The goal of inputting information to the television 28 by the user may thus be achieved. Similar to the input module 700-1 in FIG. 10A, one skilled in the art should be able to easily understand that the input module 800-1 may be set up in objects wearable on other body parts. In one example, the input module 800-1 of the present invention may be set up in an anklet or a toe ring, so that a user may wear the anklet or toe ring to input information by moving the foot wearing the anklet or toe ring in a method similar to inputting characters or symbols with hands. In another example, the input module 800-1 of the present invention may also be set up in a cap, a nose cover or an earring, so that the user may input information by moving his head in a similar manner as writing characters or symbols with hands.

FIG. 11C is another operational schematic diagram of the control/information input system 800 in FIG. 11A. Referring to FIG. 11C, besides changing the objects 66 that may be worn on hands to a hand-heldable device (such as a pen) 88, the operation of the control information input system 88 is the same as or similar to the operation of that shown in FIG. 11B. One skilled in the art should be able to easily understand that the input module 800-1 may be configured in other types of hand-heldable devices. Therefore, the scope of the present invention should not be limited by the type of hand-heldable device where the input module 800-1 is configured in. In one example, the input module 800-1 may be configured in a mouse, a cellular phone or a remote control, such that a user may use the mouse, the cellular phone or the remote control to wirelessly input information into a remote television 28.

Referring to FIGS. 11A, 11B and 11C again, one skilled in the art should be able to easily understand that the control/information input system 800 may be replaced by the control/information input systems 200, 200′, 400, 500 or 600 described in FIG. 5A, 5B, 7, 8 or 10, respectively, and without deviating from the implementation method of the operation of the control/information input system 800 of the present invention described in FIGS. 11B and 11C, so as to be used with devices, such as television 28, including or having configured therein a controlled module 800-2.

In addition, one skilled in the art should be able to easily understand that other digital home devices or information appliances, such as video recording/playing devices or a digital family server including a screen, may also be implemented with the information input system 200 of the present invention as shown in FIGS. 11A, 11B and 11C.

For example, when a device (such as a video/audio device or a cellular phone) is only connect to a projecting module or a projector which functions as the display device thereof, or use a built-in projecting module as its display device, no touch panel may be configured thereon for allowing the user to input information. In this type of examples, the control/information input system 800 of the present invention may allow the user to input information by writing with hands or using other writing methods with the aid of hand-writing recognition technology or other characters recognition technology.

FIG. 11D is a schematic diagram of applying the trace-generating device 10 in a control/information input system 800′ according to other example so of the present invention. Referring to FIG. 11D, except that the second antenna 16 and the signal processing module 18 may be set up in a projector 99, the control/information input system 800′ may be similar to the control/information input system 800. The signal processing module 18 may be coupled to a display device driving module 22′. The display device driving module 22′ may include a control circuit (not shown in FIG. 11D), the projector 99 may include a panel (also not shown in FIG. 11D), and the control circuit may be configured to control the pixels of the panel to display red, green or blue color. The projector 99 may further include a light source (also not shown in FIG. 11D). Furthermore, in view of the application and cost considerations, projectors of different projecting technology (such as DMB or LCoS) may be used for projecting the image on the panel on an external surface, such as projection screen 98. In one example, when a user wears an object 66 wearable on his finger (such as a ring), and uses his hand or his finger to perform movements 1, 2 and 3 in order (the user may perform the movement in the air directly or on a wall, desktop or a piece of paper), with the information input system 800′ of the present invention, movements 1, 2 and 3 may be converted into input information, such as the letter “H” and be displayed on screen 98 within the projection area 97.

FIG. 11E is a schematic diagram of the trace-generating device 10 being applied to a control/information input system 800′ according to another example of the present invention. Referring to FIG. 11E, except that the object 66 wearable by hand is replaced by a hand-heldable device 88 (such as a pen), the operation of the control/information input system 800′ is the same as or similar to the operation method shown in FIG. 11D. In the same manner, or similarly, one skilled in the art may easily understand the input module 800′-1 may also be set up in other types of hand-heldable device, so as to allow a user to hold different types of devices for inputting information. Therefore, the scope of the present invention should not be limited by the type of device where the input module 800′-1 is implemented. In one example, input module 800′-1 may be set up in a cellular phone or a controller, to allow users to conveniently input information to a remote television 28 wirelessly.

In addition, one skilled in the art should be able to easily understand that multiple controlled modules (such as controlled module 800-2) may be set up in different digital home devices or information appliances, so as to use the same input module (such as input module 800-1) for controlling the multiple controlled devices separately or input information in the different digital home devices or information appliances. In one example, the trace-generating device 10 may use its initial roll/pitch angle calculating module 824 and the navigation frame's initial magnetic vector calculating module 825 to convert the body frame coordinate of each of the home digital devices or information appliances to the corresponding navigation frame coordinate, with respect to the position of each of the digital home devices or information appliances relative to the position of the user of the input module. When the user points the input module at one of the digital home devices or information appliances, the controlled module set up in the home digital device or information appliance being pointed at, in cooperation with the input module, may allow the user to input information into the home digital device or information appliance that is being pointed at.

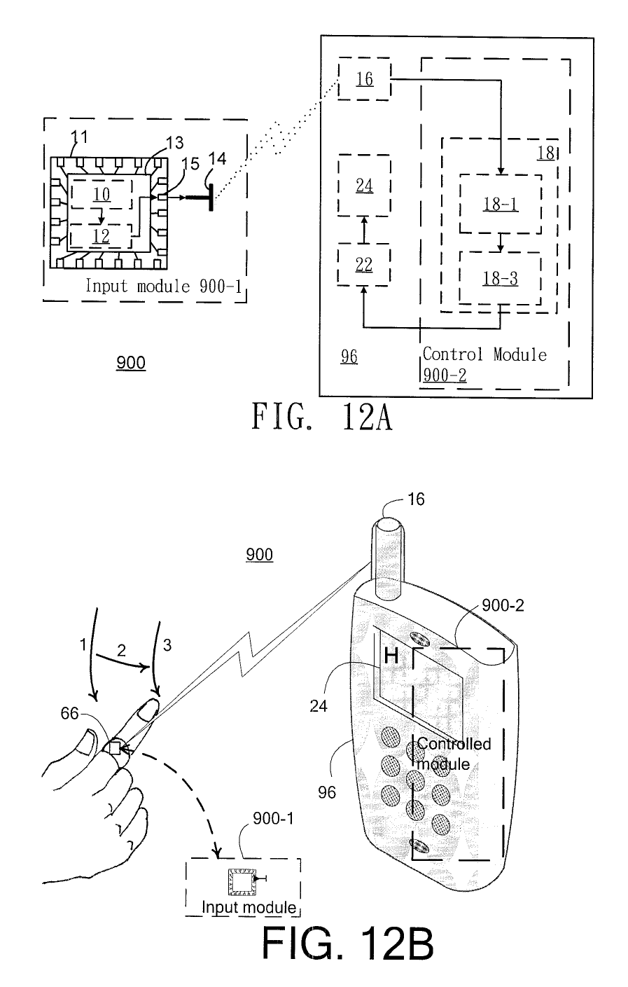

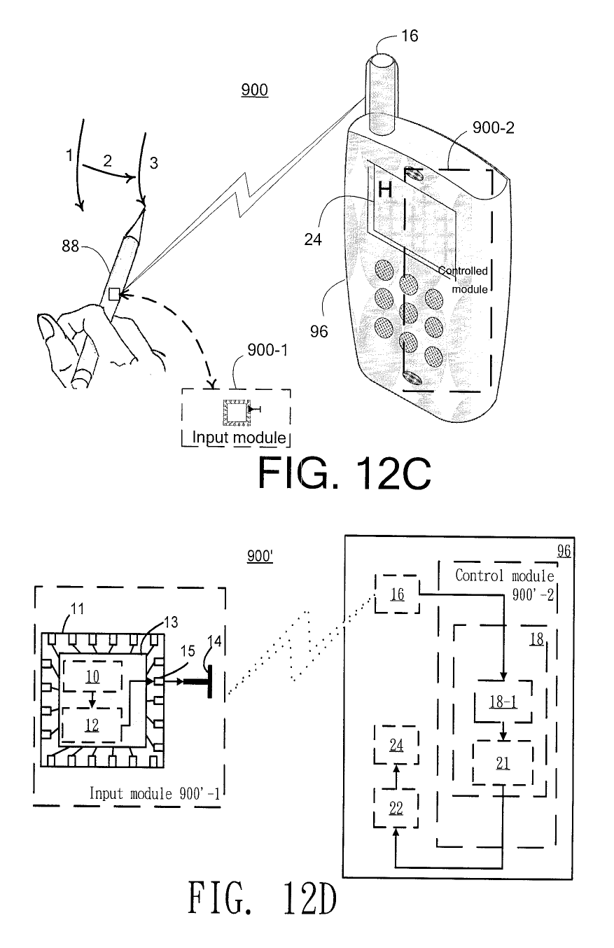

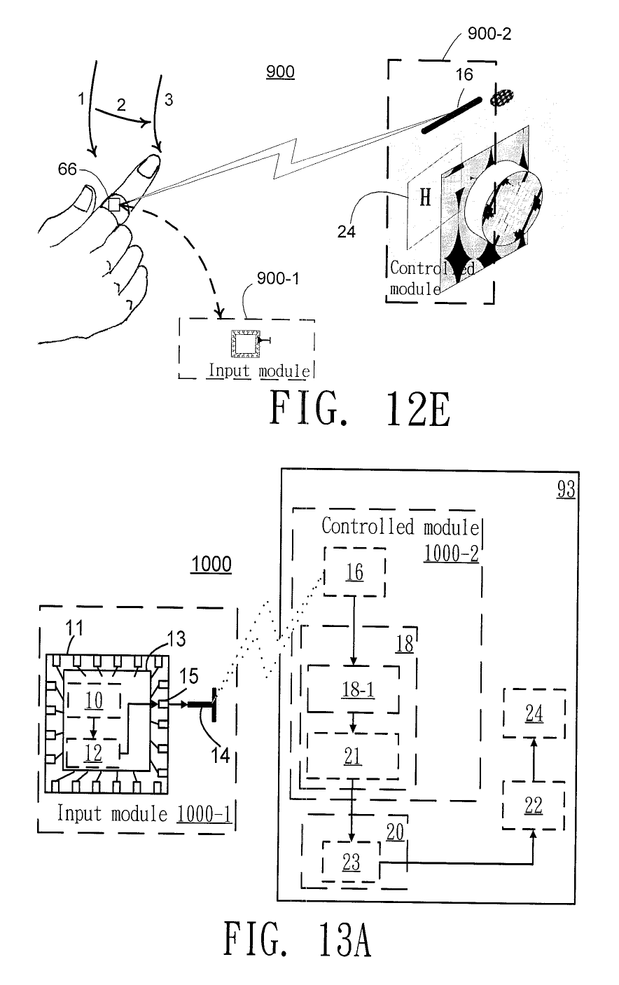

FIG. 12A is a schematic diagram of the trace-generating device 10 being applied to a control/information input system 900 according to another example of the present invention. Referring to FIG. 12A, the control/information input system 900 may be the same as or similar to the control information input system 400 in FIG. 7. The control/information input system 900 may include an input module 900-1 and a controlled module 900-2. The input module 900-1 may be the same as or similar to the input module 700-1, 700′-1, 800-1 or 800′-1 in FIGS. 10A to 11E. The controlled module 900-2 is set up in a hand-heldable device, such a cellular phone 96. In this example, the implementation method of the signal processing module 18 may be the same as or similar to that of the control/information input system 400 in FIG. 7. After the signal processing module 18 generates input information corresponding to information input by a user using the input module 900-1, the input information may be displayed on the screen 24 of the cellular phone 96 by the display device driving module 22 (which may include a driving program or a panel control chip). In addition, one skilled in the art may easily understand that in other applications, instead of installing an additional antenna specific for the control/information input system 900 of the present invention, the second antenna 16 may be the antenna which the cellular phone 96 already have for receiving voice signal, text messages or video signals. In one example, the second antenna 16 and the signal receiving module 18-1 may also include or use built-in devices of the cellular phone 96, such as a Bluetooth device.

FIG. 12B is a schematic diagram of the operation of the control/information input system 900. Referring to FIG. 12B, with the same or similar operation method as that of FIG. 10B or 11B, a user my wear an object 66 (such as a bracelet, a bangle, a watch, a finger stall or a ring) on his wrist or finger to operate the control/information input system 900 for inputting information. When the user uses his hand or finger to perform movements similar to that of writing characters or symbols, such as movements 1, 2 and 3, in the air or on other objects, such as table top or wall, the trace-generating device in input module 900-1 may measure the traces (or paths) of the movement and send the traces (or paths) to the signal generating module 12 for converting the trace (or paths) into as signal, and send the transmit signal to the second antenna 16. Subsequently, using the signal processing module 18 and the display device driving module 22 set up in the cellular phone 96, the character “H” or the symbol written by the user may be displayed on the screen of television 96. The purpose of the user entering information into the cellular phone 96 is thus achieved. Therefore, the information input device 900 of the present invention may bring great conveniences to the user for inputting large amount of characters and displaying the characters on the screen of the cellular phone 96.

Besides, similar to or same as the input module 700-1 in FIG. 10A and input module 800-1 in FIG. 11B, one skilled in the art may easily understand that like input modules 700-1 and 800-1, input module 900-1 may also be configured in objects wearable by other body parts.

FIG. 12C is an operation schematic diagram of the control/information input system 900 in FIG. 12A. Referring to FIG. 12C, besides setting up the input module 900-1 in a hand-held able device 88 (such as a pen) instead of the object 66 wearable by hand, the operation of the control/information input system 900 may be the same or similar to that of FIG. 12B. In a similar or same manner, one skilled in the art may easily understand that the input module 900-1 may be set up in other types of hand-heldable devices. Therefore, the scope of the present invention should not be limited by the type of hand-heldable device which the input module 900-1 is implemented in.

Referring to FIGS. 12A, 12B and 12C again, one skilled in the art should be able to easily understand that the control/information input system 900 may be replaced by the information input system 200, 200′, 300, 200′, 500 or 600 described in FIG. 5A, 5B, 6A, 6B, 8 or 10, respectively, without deviating from the essence of the present invention and the operation method of the control/information inputting system 900 being used with the device, such as cellular phone 96, including or set up with the controlled module 900-2, as shown in FIGS. 12B and 12C.

For example, Referring to FIG. 12D, FIG. 12D is another schematic diagram of using the trace-generating device 10 in a control/information input system 900′ according to another example of the present invention. Besides the signal processing module 18 may be different, the control/information input system 900′ may be the same as or similar to the control/information input system 900 in FIG. 12A, 12B or 12C. The signal processing module 18 may include a recognition software 21 executable in an operating system set up in a cellular phone 96. The recognition software 21 may interpret trace information included in a transmit signal received by the signal receiving module 18-1 as a character or symbol.

In addition, the control/information input system 900 may be applied to other hand-heldable devices, such as a digital camera or a video camera (or the aforementioned cellular phone 96 may include the function of a digital camera or a video camera) for the same or similar applications. For example, when a user uses the digital camera to take a picture and desires to record information related to the picture, such as person, time, or place, in text form, the control/information input system 900 or 900′ of the present invention may be used for inputting information into the digital camera. The method for applying the control/information input system 900 or 900′ to the video camera may be similar to that for the digital camera. Having the hand holding the pen 88 set up with module 900-1 or 900′-1, or wearing the ring 66 set up with the input module 900-1 or 900′-1, a user may perform movements of writing characters in the air or a surface near the video camera to input the desired characters into the video camera. Please refer to FIG. 12E for details.

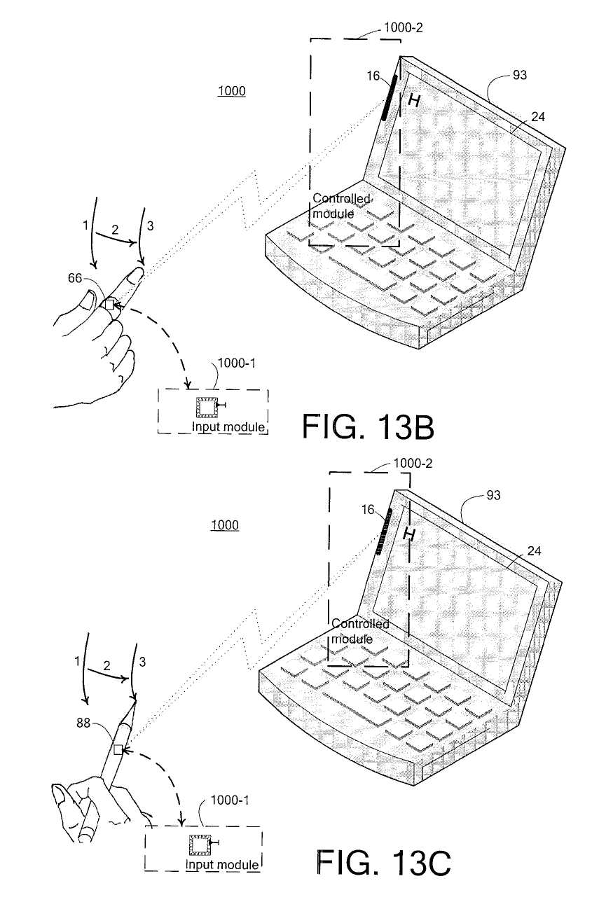

FIG. 13A is a schematic diagram of applying the trace-generating device 10 in a control/information input module 1000 according to another example of the present invention. Referring to FIG. 13A, the control/information input system 1000 may be applied in a notebook computer 93. The control/input information system 1000 may include an input module 1000-1 and a controlled module 1000-2. Besides the function of the second antenna 16 that may be implemented using the antenna for performing Bluetooth function, cellular network communication function or wireless network function, the control/information input system 1000 may be similar to the control/information input systems of the present invention described in FIG. 4, 5, 6A or 8D.

FIG. 13B is a schematic diagram of the operation of the control/information input system in FIG. 13A. Referring to FIG. 13B, with the same or similar operating method as shown in FIGS. 10B, 11B and 12B, a user may, by wearing an object 66 (such as a bracelet, a bangle, a watch, a finger stall or a ring) having an input module 1000-1 set up therein on his wrist or finger, use operating methods similar to the aforementioned control/information input system to operate the control/information input system 1000 for inputting information. In the same manner or similarly, when the user uses the hand or the finger to perform movements of writing characters or symbols, such as movements 1, 2 and 3, in the air or on other objects, such as table top or wall, the trace-generating device 10 in the input module 1000-1 may measure the traces (or paths) of the movements and send the measured traces (or paths) to the signal generating module 12 for converting the traces (or paths) into a transmit signal and transmitting the transmit signal to the second antenna 16. Subsequently, using the signal processing module 18 and the display device driving module 22 set up within the notebook computer 93, the character “H” or other corresponding symbols written by the user may be displayed on the screen 24. Hence, the goal of inputting information into the notebook computer 93 by the user may be achieved. Similar to or as the input module 700-1 in FIG. 10A, one skilled n the art may easily understand that the input module 800-1 may also be setup in other objects wearable by other human body parts. In one example, the input module 800-1 of the present invention may be set up in or on an anklet or a toe ring, so that a user may input information (such as characters) by moving his foot wearing the anklet or toe ring in a method similar to that of writing characters or symbols with hand. In other example, the input module 1000-1 of the present invention may be set up in or on a cap, a nose cover or an earring, so that a user may input information (such as inputting characters) by moving his head in a similar manner as writing the characters, while wearing the cap, the nose cover or the earring.

FIG. 13C is a schematic diagram of the operation of the control/information system in FIG. 13A. Referring to FIG. 13C, besides setting up the input module 1000-1 in a hand-heldable device 88 (such as a pen), instead of a hand-wearable object 66, the method of operating the control/information input system 1000 may be the same as or similar to the operation method in FIG. 10B.

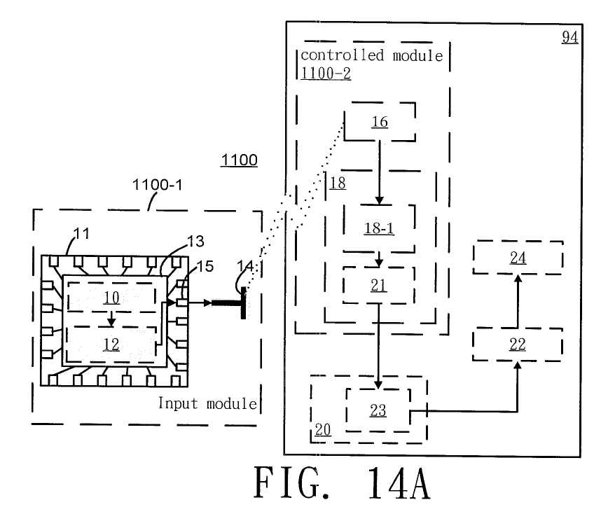

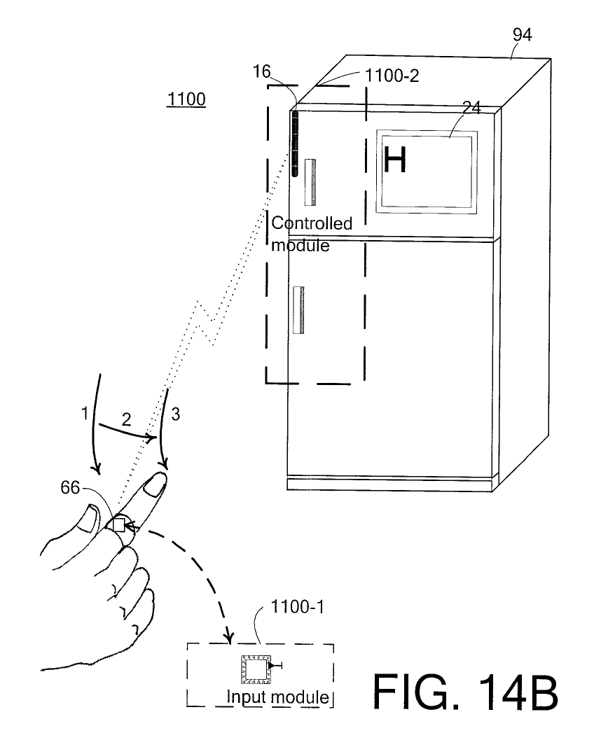

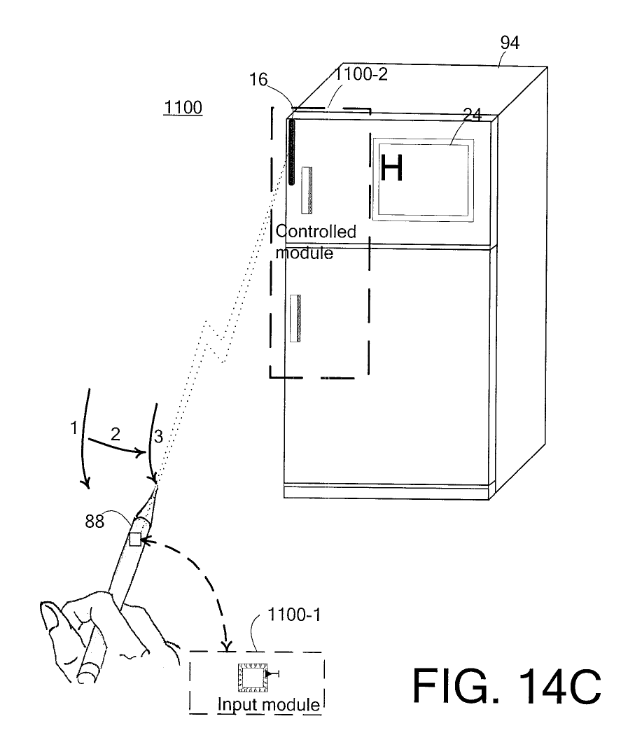

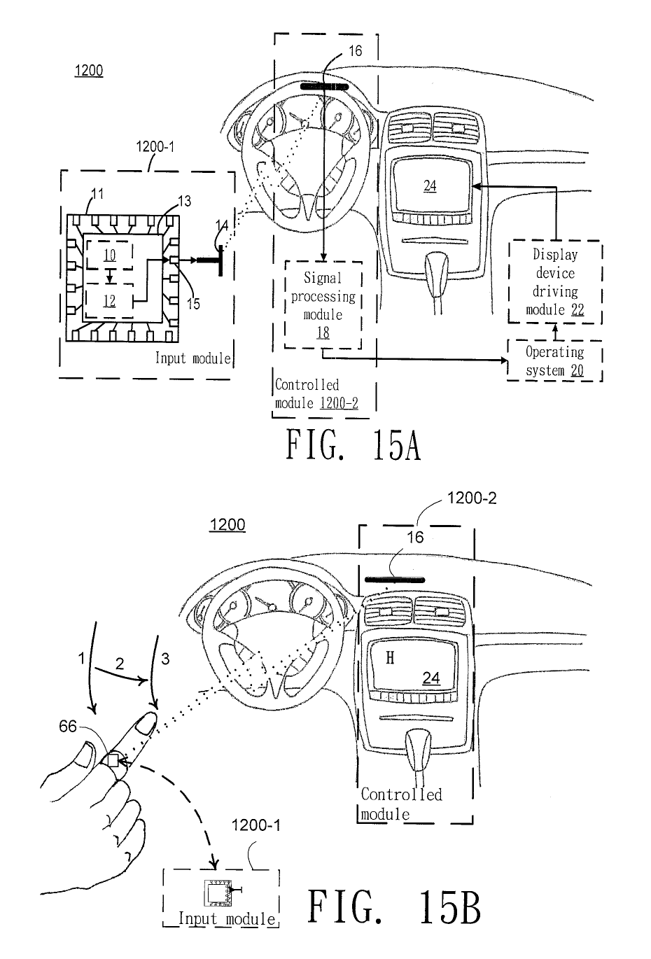

FIG. 14A is a schematic diagram of applying the trace-generating device 10 to a control/information input system 1100 according to another example of the present invention. Referring to FIG. 14A, the control/information input system 1100 may include a input module 1100-1 and a controlled module 1100-2, where the input module 1100-1 may be the same as or similar to the input module 700-1, 800-1, 900-1 or 1000-1 described according to the previously mentioned figures, and the controlled module 1100-2 may be set up in an information appliance. In this example, the controlled module 1100-2 may be set it in a refrigerator 94 having a processor, an operating system, a cache or a memory built-in or configured thereto, and capable of executing or recording the content within the refrigerator, information on the freshness of the content therein, or recipes or provide internet access. The signal processing module 18 may include a recognition software 21 executable in an operating system set up in a cellular phone 96. The recognition software 21 may interpret trace information included in a signal received by the signal receiving module 18-1 as a character or a symbol. As a result, the present invention may replace the conventional refrigerator with information input function, which requires a keyboard, a mouse, a track ball or a touch panel, so as to bring more conveniences to those cooking in the kitchen. In addition, one skilled in the art should be able to easily understand that, in other examples, the aforementioned control/information input system 300, 400 or 500 may replace the control/information/input system 1100 for applying to the refrigerator 94.

FIG. 14B is a schematic diagram of the operation of the control/information input system in FIG. 14A. Referring to FIG. 14B, with the same or similar operating method as shown in FIG. 10B, 11B, 12B or 13B, a user may, by wearing an object 66 (such as a bracelet, a bangle, a watch, a finger stall or a ring) having an input module 1100-1 set up therein on his wrist or finger, use operating methods similar to the aforementioned control/information input system to operate the control/information input system 1100 for inputting information. In the same manner or similarly, when the user uses the hand or the finger to perform movements of writing characters or symbols, such as movements 1, 2 and 3, in the air or on other objects, such as table top or wall, the trace-generating device 10 in the input module 1100-1 may measure the traces (or paths) of the movements and send the measured traces (or paths) to the signal generating module 12 for converting the traces (or paths) into a transmit signal and transmitting the transmit signal to the second antenna 16. Subsequently, using the signal processing module 18 and the display device driving module 22 set up within the refrigerator 94, the character “H” or other corresponding symbols written by the user may be displayed on the screen 24. Using the control/information input system 1100 of the present invention, the user may operate or input information to the refrigerator 94 from other corners in the kitchen. For example, if the user were beside an oven located at a distance from the refrigerator 94, it would not be necessary for the user to walk to the refrigerator 94 in order to input information.

One skilled in the art may also easily understand that multiple controlled module 1100-2 may be set up in different information appliances in the kitchen, so as to use the same input module 1100-1 to control or input information to the different information appliances. In one example, the trace-generating device 10 may use the initial roll/pitch angle calculating module 824 and the navigation frame's initial magnetic vector calculating module to, with respect to the relative position or direction of each of the information appliances to the position of the user, convert its body frame coordinates into the different navigation frame coordinates of each information appliances. When the user points the input module at one of the information appliances, a controlled module in the information appliance being pointed at may perform the inputting action desired by the user in cooperation with the inputting module.

FIG. 14C is a schematic diagram of the operation of the control/information system in FIG. 14A. Referring to FIG. 14C, except that the input module 1100-1 may be implemented in a hand-heldable device 88 (such as a pen), instead of a hand-wearable object 66, the operating method of the control/information input system 1100 may be the same as or similar to the operating method shown in FIG. 10B.

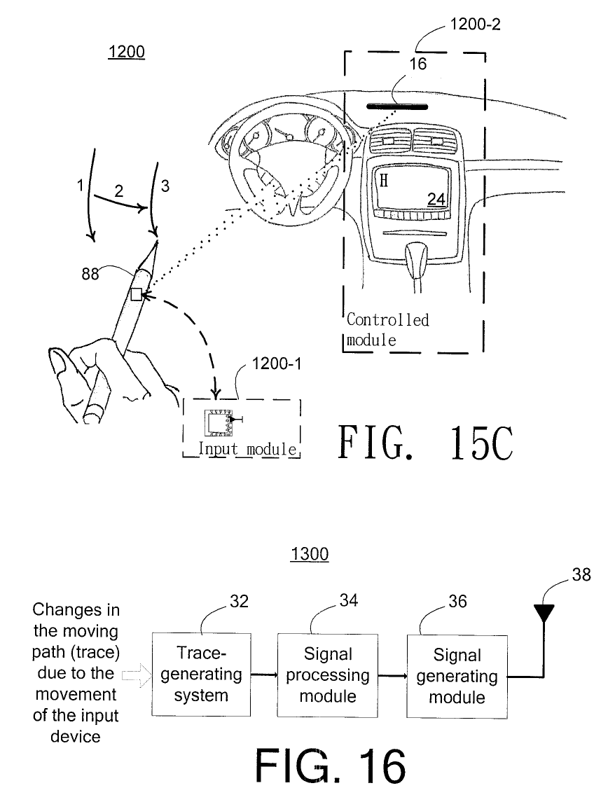

FIG. 15A is a schematic diagram of applying the trace-generating device 10 in a control/information input system 1200 according to another example of the present invention. In order to save space in a limited car interior (not labeled) or a limited area of the central control system (not labeled), for a computer to be setup within a car (since a part of the computer may be setup within the central control system, hence it is not labeled in FIG. 15A), it may not be suitable to setup a keyboard, a mouse or a track ball as tool for inputting information. Furthermore, since it may be inconvenient for the driver who is driving the car to input a string of characters using a touch panel (such as inputting a keyword in a navigation page or entering a web address), using a touch panel as in information input device in a car may not be ideal, and it may affect the safety of the driving. Therefore, referring to FIG. 15A, the control/information input system 1200 of the present invention may be applied to a computer in a car, and the computer in the car may be setup with an operating system 20 and a screen 24 as a display device. The car interior or the central control system may be set up with a second antenna 16. The signal processing module 18 may include a recognition software (not shown in FIG. 15A, please refer to the previous diagrams showing the same or similar signal processing module including the recognition software for implementation method) executable by the operating system in the computer of the car. The recognition software may interpret trace information included in a transmit signal received by the signal processing module as a character or a symbol. Subsequently, with a display device driving module 22 included in the computer in the car, the character or symbol may be displayed on the screen 24.

FIG. 15B is a schematic diagram of the operation of the control/information input system in FIG. 15A. Referring to FIG. 15B, with the same or similar operating method as shown in FIG. 10B, 11B, 12B, 13B or 14B, a driver or a passenger may, by wearing an object 66 (such as a bracelet, a bangle, a watch, a finger stall or a ring) having an input module 1200-1 set up therein on his wrist or finger, use operating methods similar to that of the aforementioned control/information input system to operate the control/information input system 1200 for inputting information.

FIG. 15C is a schematic diagram of the operation of the control/information system in FIG. 15A. Referring to FIG. 15C, except that the input module 1200-1 may be implemented in a hand-heldable device 88 (such as a pen), instead of a hand-wearable object 66, the operating method of the control/information input system 1200 may be the same as or similar to the operating method shown in FIG. 11B.

In addition, one skilled in the art should be able to easily understand that the control/information input system 1200 of the present invention may be slightly modified and be applied in other cockpits or cabins (such as a cockpit or a cabin of a train, a boat, a plane or a helicopter), so that the user (driver or passenger) may conveniently input information into the computer of the cabin. Moreover, the same or similar applications of the control/information input system 1200 may also be implemented on a motorcycle (if the motorcycle is configured with a computer allowing the rider or the passenger of the motorcycle to input information).

FIG. 16 is a block diagram of applying the trace-generating device 32 to a control/information input system 1300 according to an example of the present invention. Referring to FIG. 16, the control/information input system 1300 may include a trace-generating device 32, a signal processing module 34, a signal generating module 36 and a third antenna 38. The trace-generating device 32 may be configured to generate trace information by detecting the movement of the trace-generating device 32. The signal processing module 34 may be coupled to the trace-generating device 32 and may be configured to generate input information by receiving and processing the trace information. The signal generating module 36 may be coupled to the signal processing module and may be configured to generate a transmit signal by processing the input information. The third antenna 38 may be coupled to the signal generating module 36 and may be configured to transmit the signal. Without departing from the essence of the present invention including controlling/inputting information (such as characters, symbols or making selections with a cursor) by detecting traces, the control/information input system 1300 differs from the control/information input systems described in FIGS. 5A to 15C in that, for inputting information, the trace information may first be processed by the signal processing module 34 coupled to the trace-generating device 32 (such as perform character recognition or hand-writing recognition), and then having the signal generating module 36 generate a transmit signal and transmit the transmit signal to a controlled device located at a remote location via the third antenna 38.

FIG. 17 is a block diagram of applying the trace-generating device 32 in a control/information input system 1400 according to another example of the present invention. Referring to FIG. 17, except that the trace-generating device 32 may include a motion-sensing module 32-1 and a fifth microcontroller 32-2, wherein the motion-sensing module 32-1 may include a chip including a micro electro mechanical system (MEMS), such as an accelerometer or a electrical compass (or a gyroscope), the control/information input system 1400 may be similar to the control/information input system 1300 described in FIG. 16. The motion-sensing module 32-1 may be configure to detect accelerations, terrestrial magnetism (which may include the movement in the directions of three axes) from the movement of the trace-generating device 32 and transmit the detected results to the fifth microcontroller 32-2. The fifth microcontroller 32-2 may include a built-in memory (not shown in the figure), which may store executable programs (codes) for achieving the functions of the trace-calculating module 10-2. Therefore, the fifth microcontroller 32-2 may be configured to process the detected accelerations and terrestrial magnetism by executing the programs (codes), in order to generate trace information. The trace information may include the yaw and pitch angles of the device including the control/information input system 1400, or the yaw and pitch angles may be further processed to an corresponding X,Y coordinates (navigation frame) of a remote/controlled device.

FIG. 18 is a block diagram of applying the trace-generating device 32 to a control/information input system 1500 according to another example of the present invention. Referring to FIG. 18, except that the information processing module 34 may include a sixth microcontroller 33, the control/information input system 1500 may be similar to the control/information input system 1300 described in FIG. 16. The sixth microcontroller 33 may include multiple logic gates. The multiple logic gates may be configured to recognize the trace information as a stroke, and process multiple strokes to identify at least one of a number, a character, a work, a punctuation, a mathematical operator and a hand-written symbol that corresponds to the multiple strokes, in order to generate the input information.

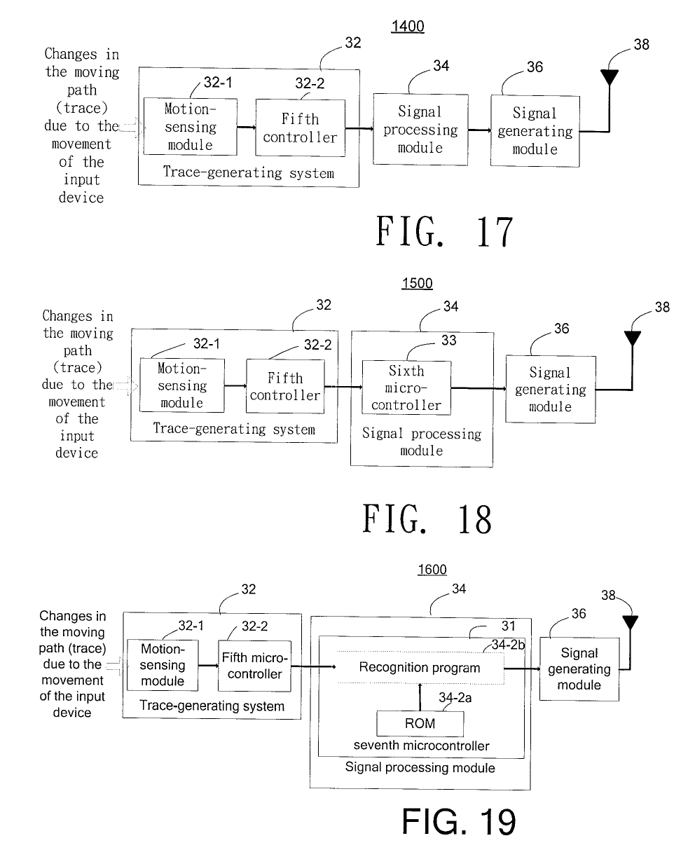

FIG. 19 is a block diagram of applying the trace-generating device 32 to a control/information input system 1600a according to an example of the present invention. Referring to FIG. 19, except that the information processing system 34 may include a seventh microcontroller 31, the control/information input system 1600 may be similar to the control/information input system 1500 described in FIG. 18. The seventh microcontroller 31 may be configured to interpret the trace information as a stroke by executing a recognition program 34-2b, and process multiple strokes to identify at least one of a number, a character, a work, a punctuation, a mathematical operator and a hand-written symbol that corresponds to the multiple strokes, in order to generate the input information. The seventh microcontroller 31 may include a read only memory (ROM) 34-2a or may be coupled to an external memory (not shown in the figure) for storing the recognition program 34-2b. When the seventh microcontroller 31 is to perform recognition on the trace information, the seventh microcontroller 31 may load the recognition program 21 from the read only memory 34-2a in order to execute the hand-writing recognition program.

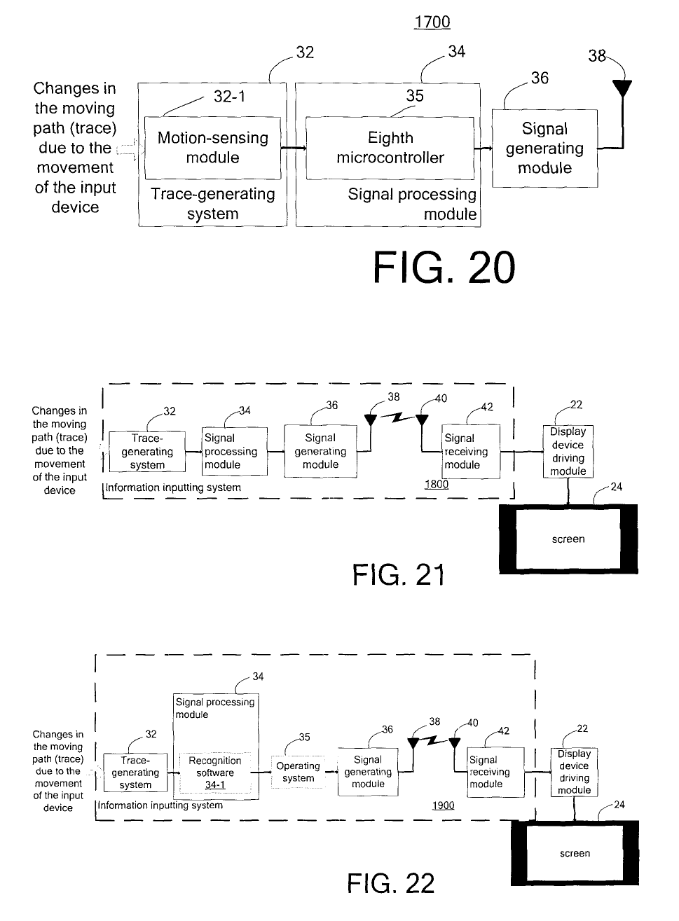

FIG. 20 is a block diagram of applying the trace-generating device 32 to a control/information input system 1700 according to another example of the present invention. Referring to FIG. 20, the structure of the system may be similar to that of the information input system 1500 described in FIG. 18. Without departing from the essence of the present invention of inputting information (characters, symbols or selection by cursor) to generate trace information, the difference between the controller/information input system 1700 and the control/information input system 1500 is that the signal processing module 34 may include an eighth microcontroller 35. The eighth microcontroller 35 may be configured to convert the trace information into coordinates a position of the cursor, and cause the position of the cursor on the screen to move with the movement of the trace-generating device 32 (in this example, it may be said to be the movement of the control/information input system 1700), in order to generate the input information (in this example, the change in position of the cursor is the input information). In another example, a selection may be made on the screen using the cursor.

FIG. 21 is a block diagram of applying the trace-generating device 32 to a control/information input system 1800 according to another example of the present invention. Referring to FIG. 21, except that the control/information input system 1800 may include a fourth antenna 40 and a signal receiving module 42, the control/information input system 1800 may be similar to the control/information input system 1300 described in FIG. 16. The fourth antenna 40 may be configured to receive the transmit signal transmitted by the third antenna 38. The signal receiving module 42 may be coupled to the fourth antenna 40 and be configured to process the received signal in order to generate a digital signal including or relating to the input information. Subsequently, the digital signal may be processed (such as by executing a display device driving in an operating system) and sent to a display device driving module 22 (such as a graphics card or a display device driving chip), for being displayed on a screen 24. As a result, the information input by the user using the trace-generating device 32 may be displayed on the screen 24, so as to achieve the goal of inputting information.

FIG. 22 is a block diagram of applying the trace-generating device 32 in a control/information input system 1900 according to an example of the present invention. Referring to FIG. 22, except that the signal processing module may include a recognition software 34-1, the control/information input system 1900 may be the same as or similar to the control/information input system 1800 described in FIG. 21.

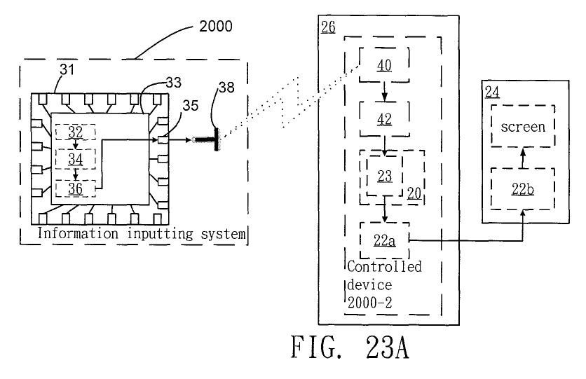

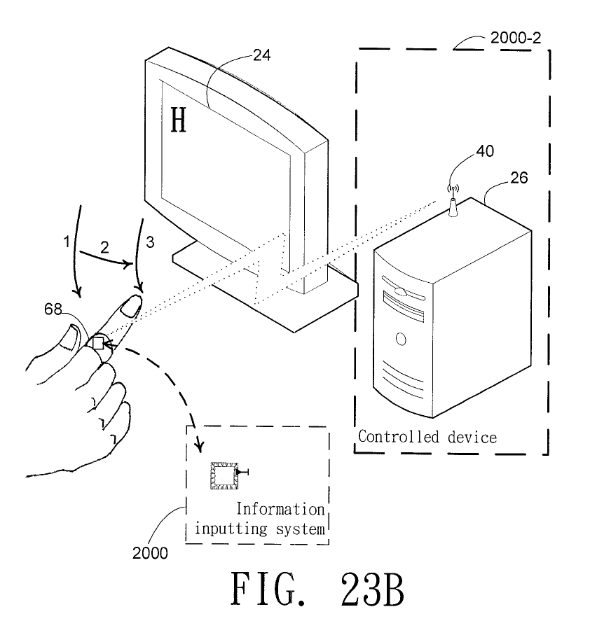

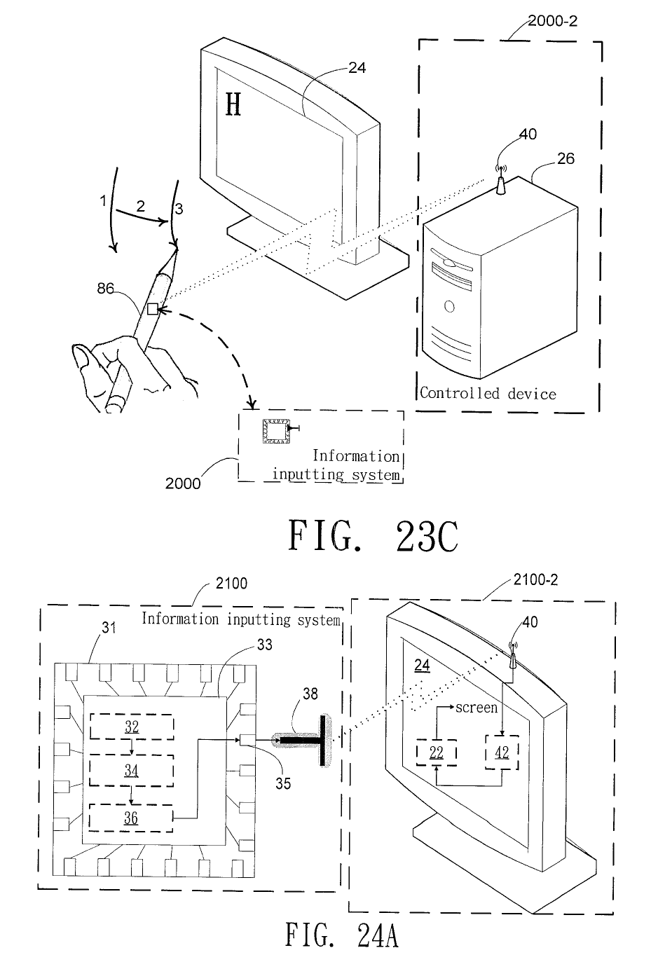

FIG. 23A is a schematic diagram of a control/information input system having the trace-generating device 32 applied therein according to an example of the present invention. Referring to FIG. 23A, the control/information input system 2000 of the present invention may be applied to input information into a controlled device 2000-2. In this example, the control/information input system 2000 is implemented as a SoC. The control/information input system 2000 may include a die 33 and a third antenna 38 packaged by a packaging 31. The die 33 may be a SoC and may include a trace-generating device 32, a signal processing module 34 and a signal generating module 36. The trace-generating device 32 may be configured to detect the movement of itself (the trace-generating device or die 33), in order to generate trace information. Those coupled to the trace-generating module include a microprocessor (not shown in the figure) or a recognition software (not shown in the figure), for recognizing the trace information generated by the trace-generating device 32 as information (characters or symbols) a user desired to input using the control/information input system 2000. The signal generating module 36 may generate a transmit signal by processing the trace information, and using a connecting wire coupled to a PIN 35 of the packaging 31 to send the transmit signal to PIN 35. Subsequently, using the third antenna 38 coupled to the PIN 35 the transmit signal may be transmit to a controlled device 2000-2. In this example, the controlled device 2000-2 is a host coupled to a screen 24. The host may be or may include a computer, workstation, a server or a home server of a digital home system, or a television gaming console. The controlled device 2000-2 may further include a fourth antenna 40 and a signal receiving module 42. Furthermore, the controlled device 2000-2 may include an operating system 20, a display device driver 23 and a display device driving module (a) 22a. When the fourth antenna 40 receives the transmit signal transmitted by the third antenna 38 and transmit the received signal to the signal receiving module 42, the signal receiving module 42 may convert the received signal into a digital signal. Subsequently, by executing the display device driver and the display device driving module 22a in the operating system 20, control a display device driving module (b) 22b of the screen 24 to display the input information on the screen. In one example, the display device driving module 22a may include a graphics card. In another example, the display device driving module 22b may include a driver IC of display device, such as a panel.

FIG. 23B is a schematic diagram of the operation of the control/information input system 2000 in FIG. 23A. Referring to FIG. 23B, the control/information input module 2000 may be set up in or on an object 68 that may be worn on a hand or a finger of a user. The object 68 may be a bracelet, a bangle, a watch, a finger stall, a glove or a ring, or even in a piece of clothing or a sleeve. When the user uses his hand or finger to perform movements similar to that of writing characters or symbols, such as movements 1, 2 and 3, in the air or on other objects, such as a table top or a wall, the trace-generating device 32 in the input module 2000 may measure the traces (or paths) of the movements and send them to the signal processing module 34 so as to convert the trace information generated by the trace-generating device from movements 1, 2 and 3 into input information. For example, the movements 1, 2 and 3 may be converted into a character “H” or other symbols. Subsequently, the signal generating module 38 converts the input information into a transmit signal and transmits the transmit signal to a controlled device 2000-2 via the third antenna 38. Using the fourth antenna 40 setup in or coupled to the controlled device 2000-2 or after the signal receiving module 42 receives the signal, the operating system 20 and the display device driving module 22a of the controlled device 2000-2 may display the input information (the character “H”) or other symbols on the screen 24 using the display device driving module 22b, so as to achieve the goal of inputting information. One skilled in the art should be able to easily understand that the control/information input system 2000 may be set up in objects that may be worn on other body parts. In one example, the control/information input system 2000 of the present invention may be set up in or on an anklet or a foot ring, so that a user may wear the anklet or foot ring and use his foot to perform movements similar to that of writing characters or symbols with hands. Applications as such may bring conveniences to users with hand or arm disabilities when inputting information or communicating with the controlled device 2000-2. In another example, the control/information input system 2000 of the present invention may be set up in or on a cap, a nose over or an earring, so that another user may wear the cap, the nose cover or the earring and use his head to perform movements similar to that of writing characters or symbols to input information (such as characters). Methods and applications as such may greatly convenient users with hand or foot disabilities to input information to or communication with the controlled device 2000-2. Moreover, one skilled in the art should be able to easily understand that setting up the aforementioned control/information input system 2000 in wearable objects 68 may include setting up the control/information input system 2000 inside the wearable objects 68, or fixing or attaching the control/information input system 2000 on the wearable objects 68. Therefore, the method of setting up the input module 700-1 in or on the wearable objects 68 of the present invention should not be limited to the examples described herein. In one example, a user may stick or attach the control/information input system 2000 on a watch he is wearing, so that he may input information to the controlled module 2002-2 set up with the controlled module 2002-2 by waving the hand wearing the watch having the control/information input system 2000 attached thereon.

FIG. 23C is a schematic diagram of the operation of the control/information input system 2000 in FIG. 23A. Referring to FIG. 23C, except that the hand-wearable object 68 may be replaced by a hand-heldable device 86 (such as a pen), the operation of the control/information input system 2000 may be the same or similar to the operation of the control/information input system 2000 in FIG. 23B. One skilled in the art should be able to easily understand that the pen 86 in the figure is only for easy demonstration. In other examples, the control/information input system 2000 may also be setup in other types of hand-heldable devices. Therefore, the scope of the present invention should not be limited by the type of hand-heldable device where the control/information input system 2000 is setup in. In another example, the control/information input system 2000 may also be setup in a mouse, a cellular phone or a remote control, so as to allow a user to use the mouse, the cellular phone or the remote control to input information to a controlled device 2000-2 located at a remote location wirelessly.

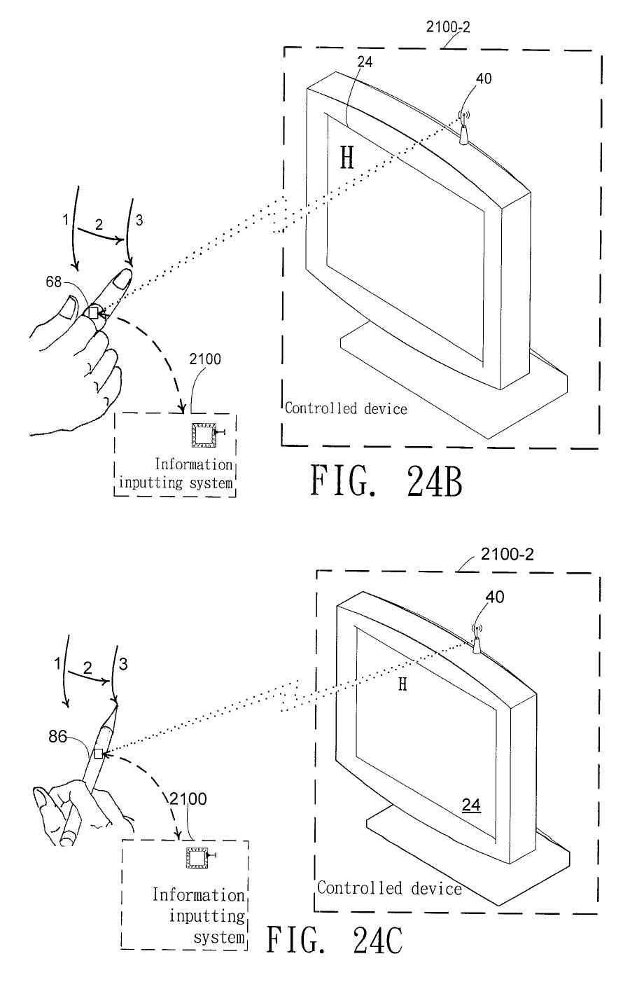

FIG. 24A is a schematic diagram of applying the trace-generating device 32 to a control/information input system 2100 according to another example of the present invention. Referring to FIG. 24A, the control/information input system 2100 may be the same as or similar to the control/information input system 200 described in FIGS. 23A to 23C, except that the control/information input system 2100 controls a controlled device 2100-2 (which may be a digital home device or a information appliance, such as a television or a projector). The controlled device 2100-2 may include a fourth antenna 40 and a signal receiving module 42. Furthermore, the controlled device 2100-2 may further include a display device driving module 22 and a screen 24. When the fourth antenna 40 receives the transmit signal transmitted by the third antenna 38 and sends the received signal to the signal receiving module 42, the signal receiving module may convert the received signal into a digital signal. Subsequently, the display device driving module 22 may drive the screen 24 to display the input information on the screen 24.

FIG. 24B is a schematic diagram of the operation of the control/information input system 2100 in FIG. 20A. Referring to FIG. 24B, the method of operation of the control/information input system 2100 with respect to the controlled device 2100-2 may be the same as or similar to the control/information input system 2000 described in FIG. 23B.

FIG. 24C is a schematic diagram of the operation of the control/information input system in FIG. 24A. Referring to FIG. 24C, besides setting up the control/information input system 2100 in a hand-heldable device 86, instead of a wearable object 68 as in FIG. 24B, the operation of the control/information input system 2100 may be the same as or similar to that of FIG. 24B.

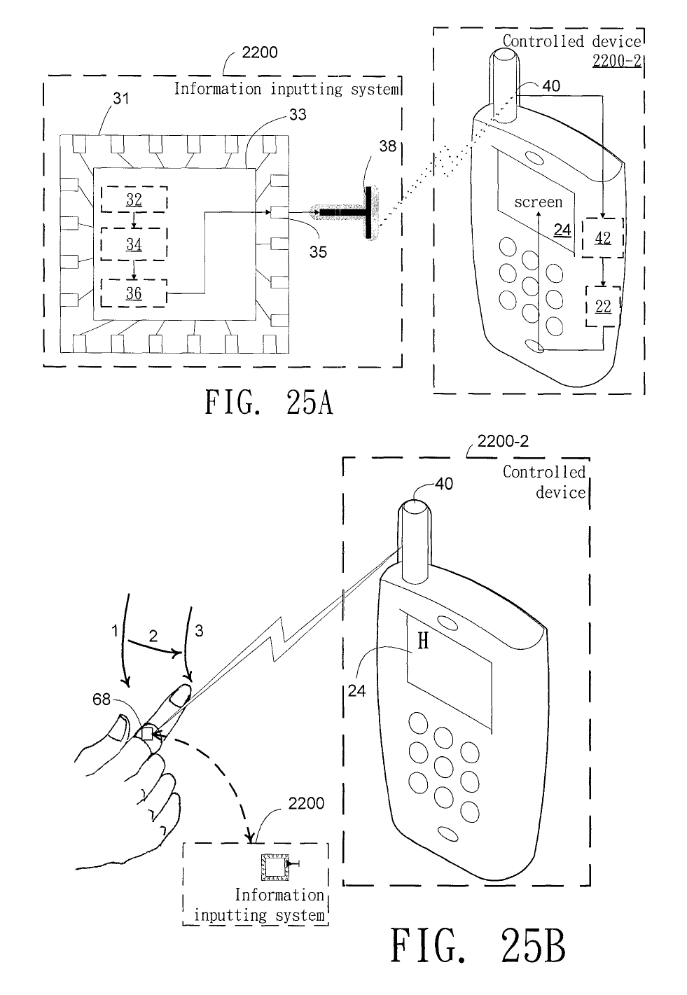

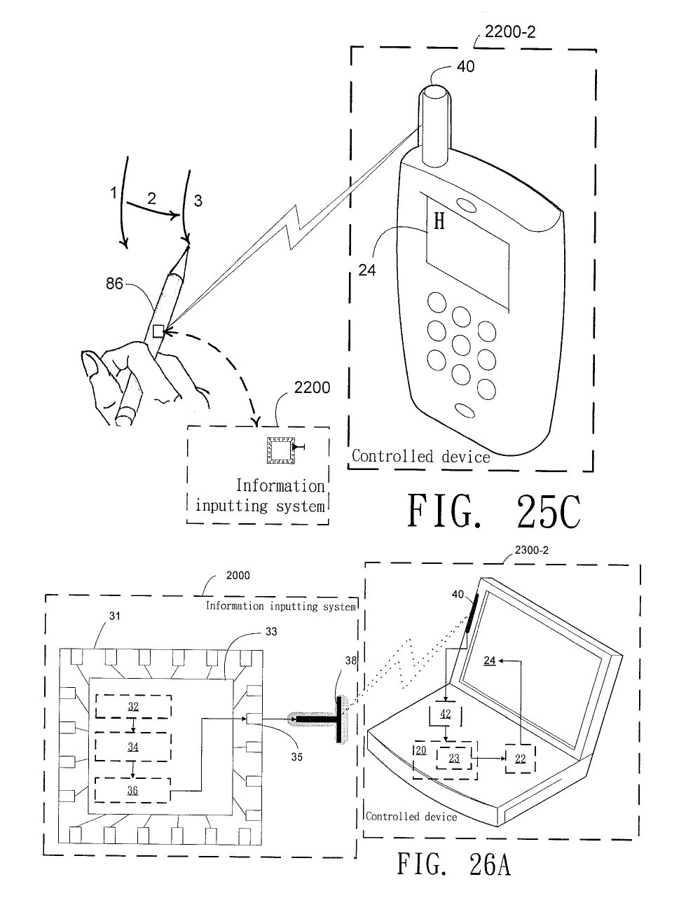

FIG. 25A is a schematic diagram of applying the trace-generating device 32 to a control/information input system 2200 according to another example of the present invention. Referring to FIG. 25A, the control/information input system 2200 may be the same as or similar to the control/information input systems 2000 or 2100 described in FIGS. 23A to 25C, except that the control/information input system 2200 is configured to control a controlled device 2200-2 (which may be a hand-heldable device or a mobile device, such as a cellular phone, a PDA, a digital camera or a video camera). In addition, one skilled in the art should be able to easily understand that in other applications, the fourth antenna 40 shown in FIG. 25A may be the antenna of the controlled device 2200-2 itself, such as an antenna for receiving voices, text messages or images of a cellular phone, instead of an additional antenna specifically setup for the use of the control/information input system 2200. In one example, the fourth antenna 40 and the signal receiving module 42 may also be implemented with built-in devices of a cellular phone, such as a Bluetooth device.

FIG. 25B is a schematic diagram of the operation of the control/information input system in FIG. 25A. Referring to FIG. 25B, the method of operation of the control/information input system 2200 on the controlled device 2200-2 may be the same as or similar to the control/information input systems 2000 or 2100 described in FIGS. 23B and 24B.

FIG. 25C is a schematic diagram of the operation of the control/information input system in FIG. 25A. Referring to FIG. 25C, besides setting up the control/information input system 2200 in a hand-heldable device 86 as shown in FIG. 25C instead of in a wearable object 68 as shown in FIG. 25B, the operation of the control/information input system 2200 may be the same as or similar to FIG. 25B.

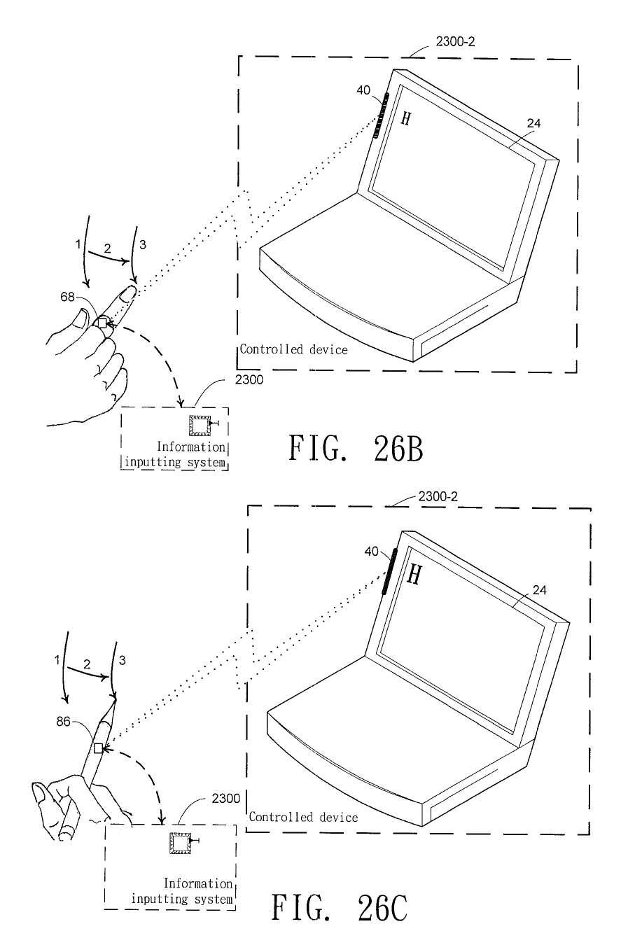

FIG. 26A is a schematic diagram of applying the trace-generating device 32 to a control/information input system 2300. Referring to FIG. 26A, the control/information input system 2300 may be similar to the control/information input system 2000 described in FIG. 23A to 23C, except for a controlled device 2300-2 (which may be a notebook computer). In addition, one skilled in the art may be able to easily understand that the a fourth antenna 40 that may be included in the controlled device 2300-2 may be implemented with devices that are already of the controlled device 2300-2, such as the bluetooth function, cellular network communication function or wireless network function of the notebook computer.

FIG. 26B is a schematic diagram of the operation of the control/information input system. Referring to FIG. 26B, the method of operation of the control/information input system 2300 on the controlled device 2300-2 may be the same as or similar to the control/information input system 2000 described in FIG. 23B.

FIG. 26C is a schematic diagram of the operation of the control/information input system in FIG. 26A. Referring to FIG. 26C, besides setting up the control/information input system 2300 in a hand-heldable device 86 as shown in FIG. 26C instead of in a wearable object 68 as shown in FIG. 26B, the operation of the control/information input system 2300 may be the same as or similar to FIG. 26B.

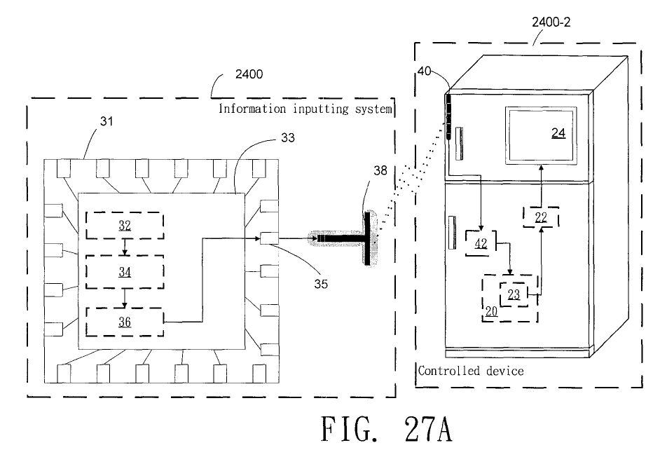

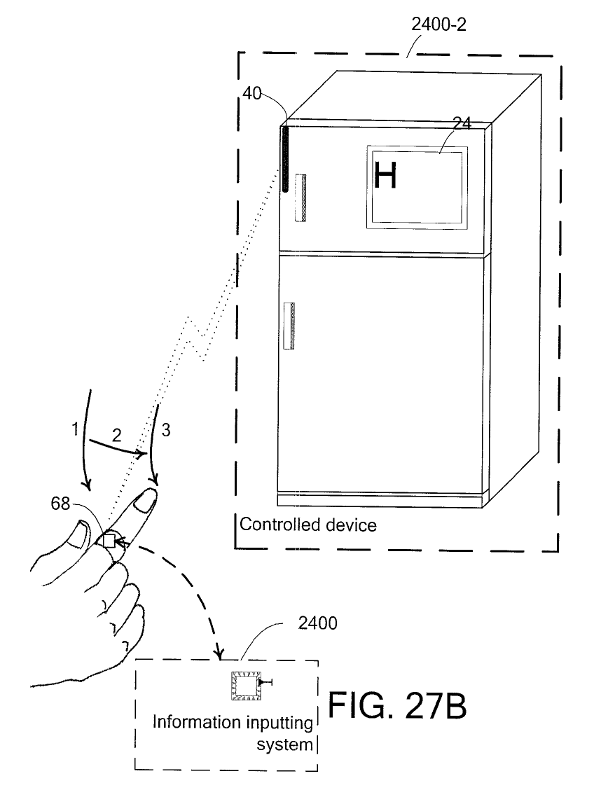

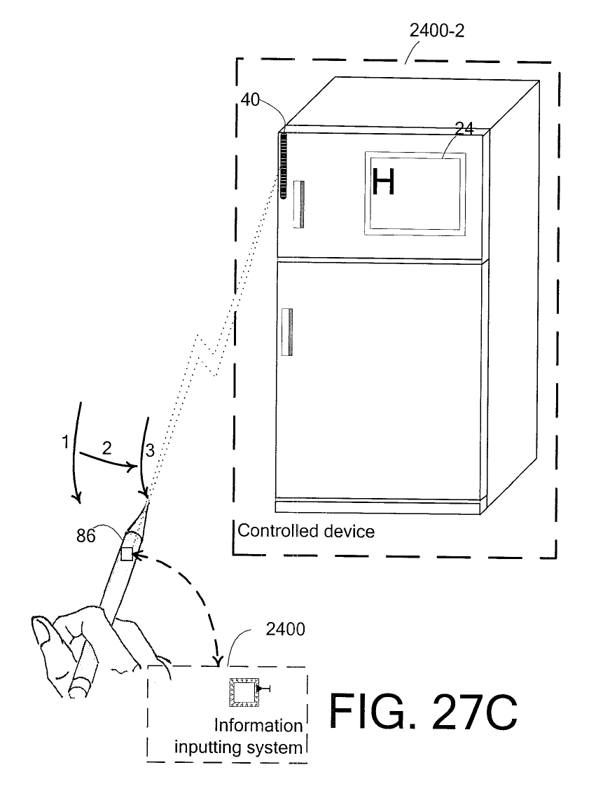

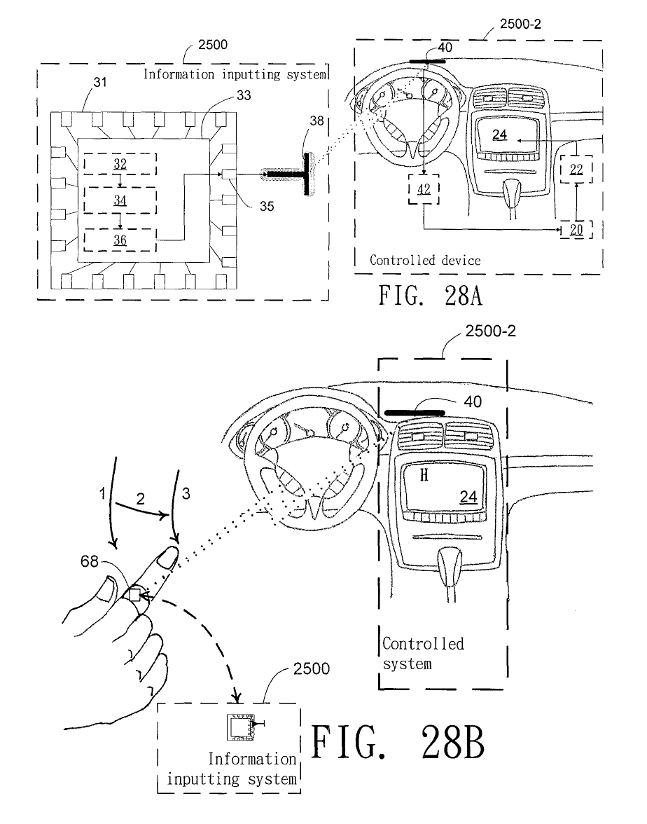

FIG. 27A is a schematic diagram of the application of the trace-generating device 32 in a control/information input system 2400. Referring to FIG. 27A, the control/information input system 2400 may be similar to the control/information input systems 2000, 2100 or 2300 described in FIGS. 23A to 24C and 26A to 26C, except for a controlled device 2400-2 (which may be an information appliance, such as a refrigerator). One skilled in the art should be able to easily understand that the control/information input system 2400 may be used for controlling or inputting information to multiple different information appliances separately, where the application method may be similar to those mentioned above. In one example, the trace-generating device 32 may detect and convert the coordinates of the position of each of the information appliances located at different directions. Therefore, when a user points the input device at one of the information appliances, the user may input information to the appointed information appliance using the input module.

FIG. 27B is a schematic diagram of the operation of the control/information input system in FIG. 27A. Referring to FIG. 27B, the operation method of the control/information input system 2400 on the controlled device 2400-2 may be similar to the control/information input system 2000, 2100 or 2300 described in FIGS. 23A to 24C and 26A to 26C.

FIG. 27C is a schematic diagram of the control/information input system in FIG. 27A. Referring to FIG. 27C, besides implementing the control/information input system 2400 in a hand-heldable device 86 as shown in FIG. 27C instead of a wearable object 68 as shown in 27B, the method of operation of the control/information input system 2400 may be the same as or similar to that of FIG. 27B.

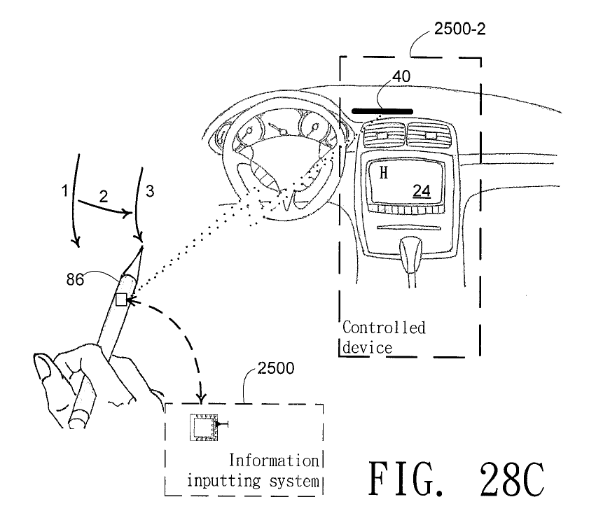

FIG. 28A is a schematic diagram of applying the trace-generating device 10 to a control/information input system 2500 according to another example of the present invention. Referring to FIG. 28A, the control/information input system 2500 may be similar to the control/information input systems 2000, 2100, 2200, 2300 or 2400 described in FIGS. 23A to 27C, except for a controlled module 2500-2 (which may be a computer in a car).

FIG. 28B is a schematic diagram of the operation of the control/information input system in FIG. 28A. Referring to FIG. 28B, the method of operating the control/information input system 2500 on the controlled device 2500-2 may be the same or similar to the control/information input system 2000, 2100, 2200, 2300 or 2400 described in and in reference to FIGS. 23A to 27C.

FIG. 28C is a schematic diagram of the operation of the control/information input system in FIG. 28A. Referring to FIG. 28C, except for setting up the control/information input system 2500 in a hand-heldable device 86, as shown in FIG. 28C, instead of a wearable object 68, as shown in 28B, the operation of the control/information input system 2500 may be the same as or similar to that in FIG. 28B.

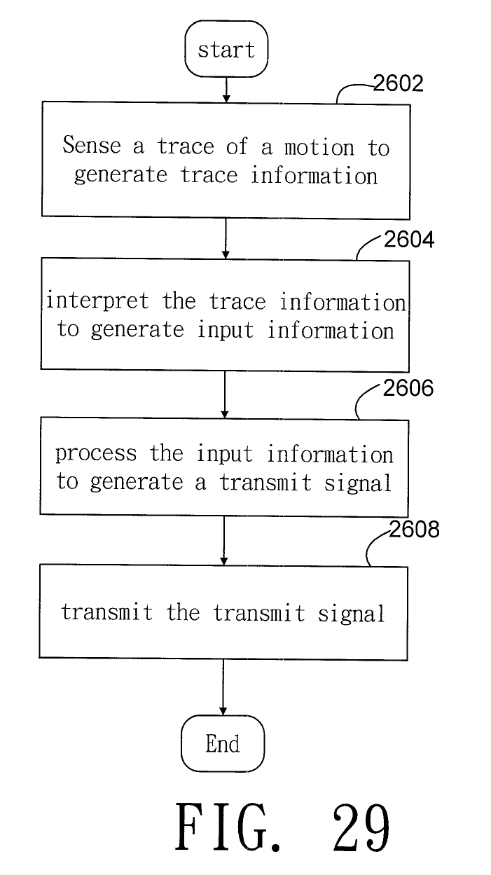

FIG. 29 is a flow chart of a method of applying the trace-generating device for controlling/inputting information according to an example of the present invention. Referring to FIG. 29, the method of inputting information may include detecting a trace using a trace-generating device to generate trace information in step 2602. Subsequently, in step 2604, a signal processing module may interpret the trace information to generate input information. In step 2606, a signal transmitting module may process the input information to generate a signal. Then, in step 2608, a fourth antenna may be used for transmitting the transmit signal.

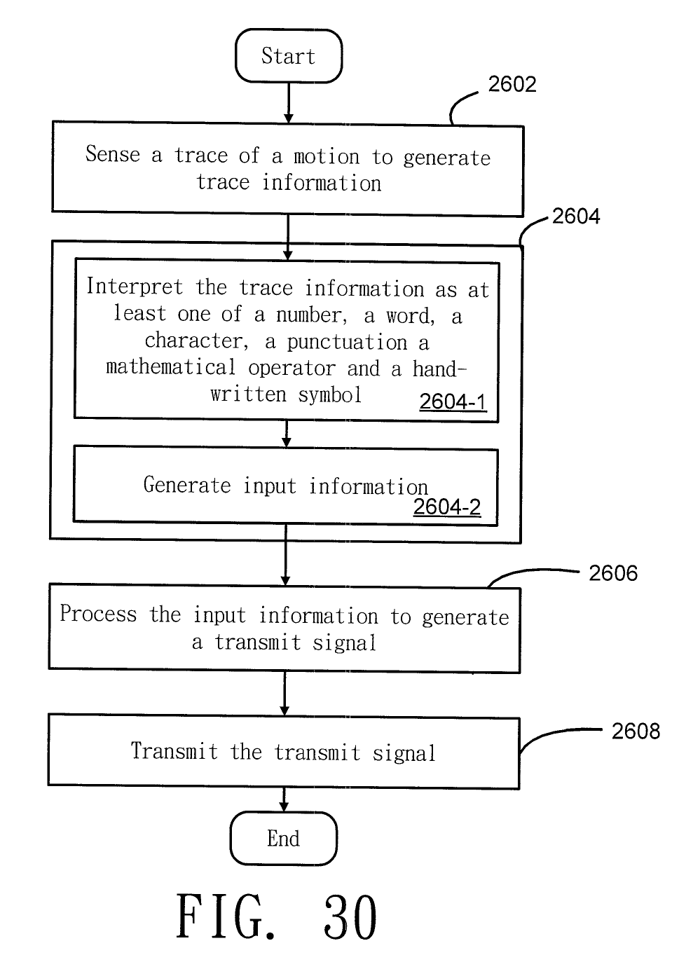

FIG. 30 is a flow chart of a method of applying the trace-generating device for controlling/inputting information according to another example of the present invention. Referring to FIG. 30, the method of controlling/inputting information described in and in references to FIG. 30 may the same as or similar to the method of controlling/inputting information described in and in reference to FIG. 29, except step 2604 may further include steps 2604-1 and 2604-2. The signal processing module may interpret the trace information as at least one of a number, a character, a word, a punctuation, a mathematical operator and a hand-written symbol in step 2604-1, and generate the input information in step 2604-2.

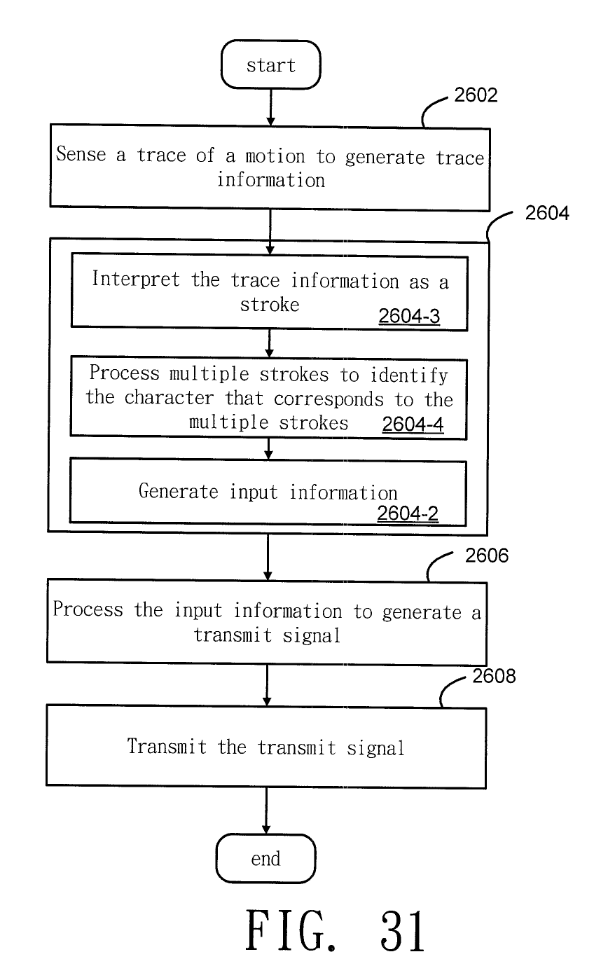

FIG. 31 is a flow chart of a method of applying the trace-generating device for controlling/inputting information according to another example of the present invention. Referring to FIG. 31, the method of controlling/inputting information described in and in references to FIG. 31 may the same as or similar to the method of controlling/inputting information described in and in reference to FIG. 29, except step 2604 may further include steps 2604-3, 2604-4 and 2604-2. The signal processing module may interpret the trace information as a stroke in step 2604-3. Subsequently, the signal processing module may process multiple strokes in order to identify at least one of a number, a character, a word, a punctuation, a mathematical operator and a hand-written symbol that corresponds to the multiple strokes in step 2604-4, and generate the input information in step 2604-2.

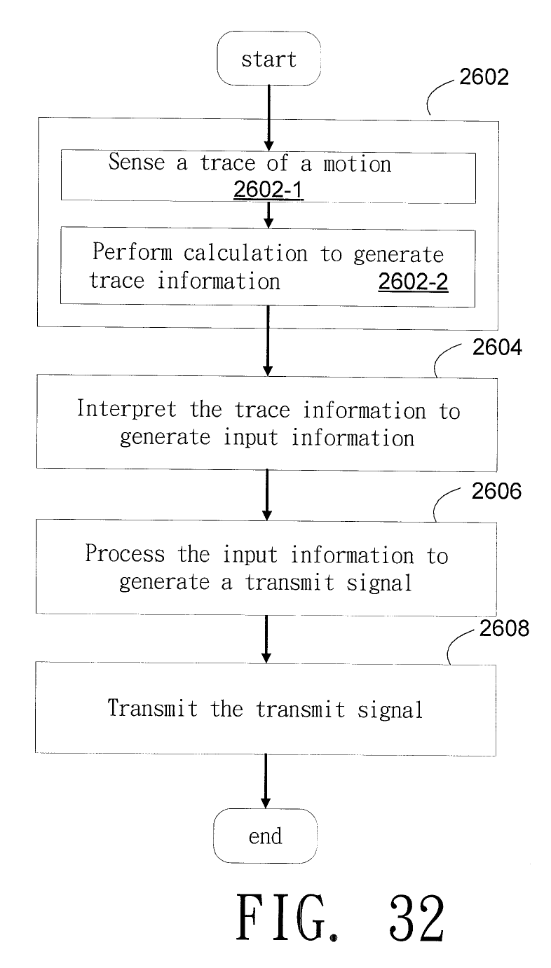

FIG. 32 is a flow chart of a method of applying the trace-generating device for controlling/inputting information according to another example of the present invention. Referring to FIG. 32, the method of controlling/inputting information described in and in references to FIG. 32 may the same as or similar to the method of controlling/inputting information described in and in reference to FIG. 29, except step 2602 may further include steps 2602-1 and 2602-2. In step 2602-1, the trace-generating device may use a built-in MEMS to detect a trace, where the MEMS include at least one of an accelerometer and an electronic compass for detecting the changes in the coordinates of the trace-generating device. Subsequently, the trace-generating device may calculate and generate the trace information in step 2602-2.

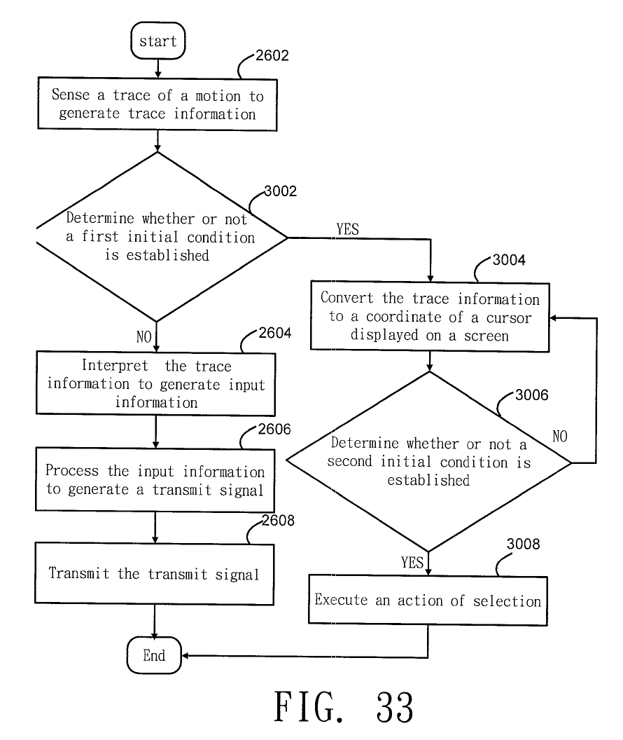

FIG. 33 is a flow chart of a method of applying the trace-generating device for controlling/inputting information according to another example of the present invention. Referring to FIG. 33, the method of controlling/inputting information described in and in references to FIG. 33 may the same as or similar to the method of controlling/inputting information described in and in reference to FIG. 29, except that the method of controlling/inputting information described in and in reference to FIG. 33 further includes the steps of 3002, 3004, 3006 and 3008. After step 2602, in step 3002, the signal processing module may determine whether or not a first initial condition has been established. If the first initial condition has not been established (NO), proceeds to steps 2604, 2606 and 2608, similar to the steps in FIG. 29. If the first initial condition has been established (YES), proceeds to step 3004. In step 3004, the signal processing module may convert the trace information to a coordinate of a cursor displayed in a screen, so as to cause changes in the position of the cursor on the screen corresponding to the changes in the trace information. In one example, the first initial condition may indicate, as the input information, the trace information or the subsequent input (subsequent trace information generated based on the movement of the trace-generating device subsequent to the aforementioned trace information) by the user is for the purpose of moving the cursor or using the cursor to select an item displayed on the screen. Therefore, when the first initial condition is not established, the method of controlling/inputting information may be used for inputting a word or a symbol. On the contrary, when the first initial condition is not established, the method of controlling/inputting information may be used for controlling the movement of the cursor and performing the action of making selections.

In another example, the method of controlling/inputting information may further include step 3006. In step 3006, the signal processing module may further determine whether or not a second initial condition has been established. If the second initial condition has not been established (NO), return to step 3004. If the second initial condition has been established (YES), proceed to step 3008. In the example, the second initial condition is for determining whether the trace information indicates the movement of the coordinates of the cursor (when the second initial condition is not established) or the cursor is being used for selecting an item displayed on the screen (when the second initial condition is established). In step 3008, when the second initial condition is established, the action of selecting is executed.

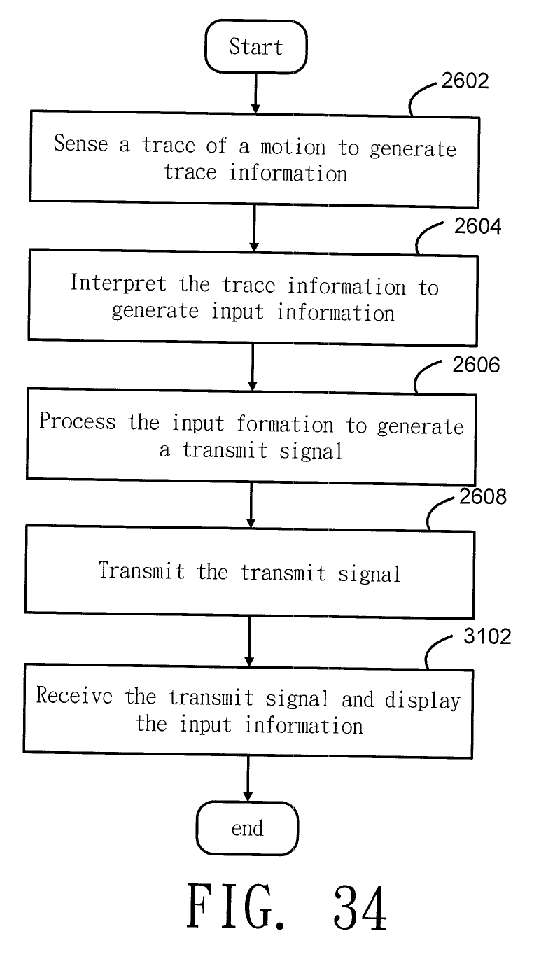

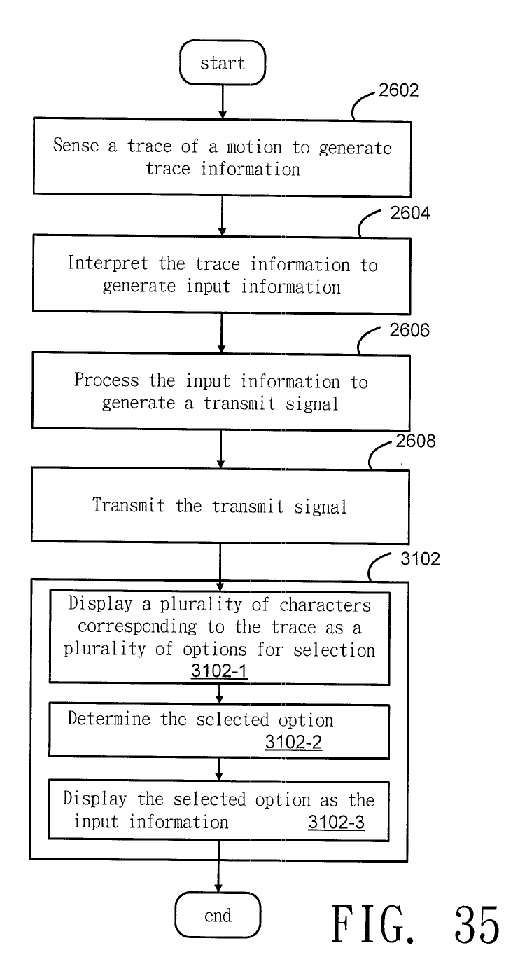

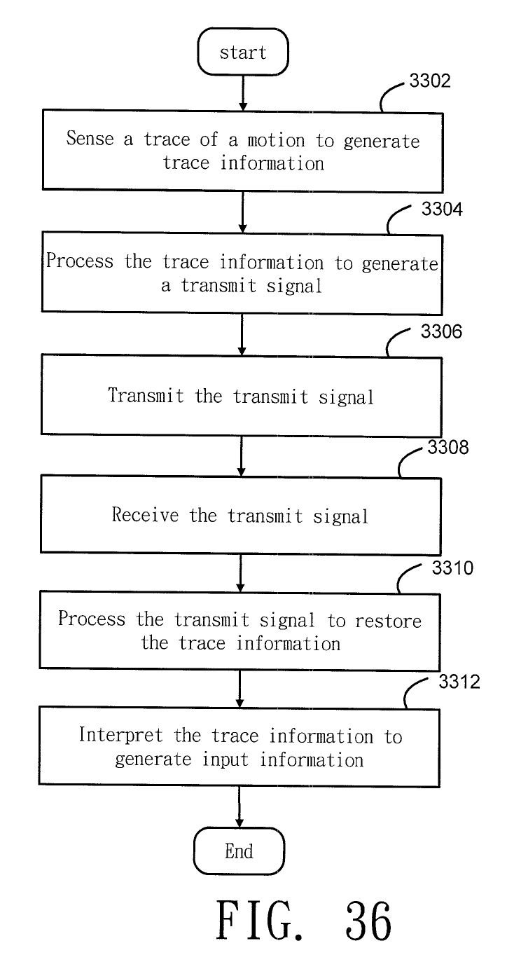

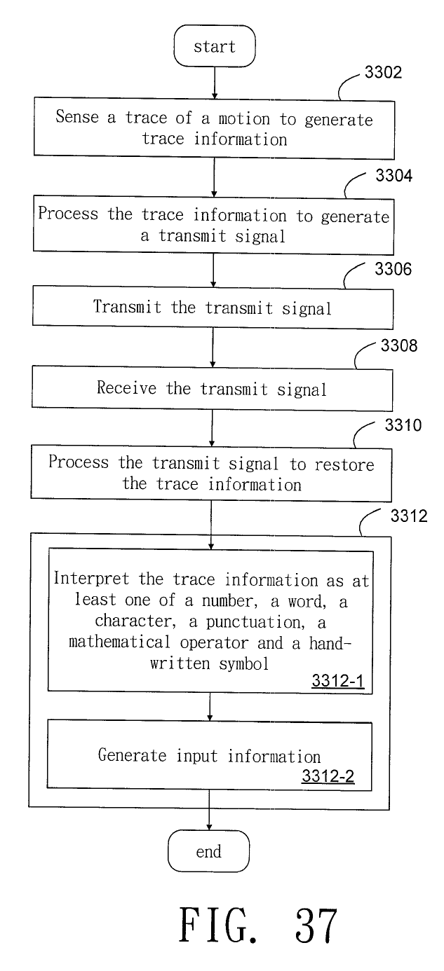

FIG. 34 is a flow chart of a method of applying the trace-generating device for controlling/inputting information according to another example of the present invention. Referring to FIG. 34, the method of controlling/inputting information described in and in references to FIG. 34 may the same as or similar to the method of controlling/inputting information described in and in reference to FIG. 29, except that the method may further include a step 3102. In step 3102, a controlled device which receives the transmit signal may drive the display device to display the input information.

FIG. 35 is a a flow chart of a method of applying the trace-generating device for controlling/inputting information according to another example of the present invention. Referring to FIG. 35, the method of controlling/inputting information described in and in references to FIG. 35 may the same as or similar to the method of controlling/inputting information described in and in reference to FIG. 34, except that step 3102 may further include steps 3102-4, 3102-2 and 3102-3. In step 3102-1, the display device may display at least a number of: a number of numbers, a number of words, a number of characters, a number of punctuations, a number of mathematical operators and a number of hand-written symbols, as a number of selecting options. Subsequently, in step 3102-2, the trace-generating device and the signal processing module or the controlled device will wait to receive further input information from the user as a selection of one of the number of selecting options. Then, in step 3102-3, the display device displays the selected option as the input information.

FIG. 36 is a flow chart of a method of applying the trace-generating device for controlling/inputting information according to another example of the present invention. Referring to FIG. 36, the method of controlling/inputting information includes steps 3302 to 3312. In step 3302, a trace-generating device may detect a trace, and generate trace information. Subsequently, in step 3304, a signal generating module may process the trace information to generate a transmit signal. For example, the signal generating module may convert the trace information into a transmit signal. Subsequently in step 3304, a first antenna may be used for transmitting the signal. Subsequently, in step 3308, a second antenna located at a remote location may be used for receiving the transmit signal and send the received signal to a signal processing module. In step 3310, the signal processing module may process the received signal in order to obtain a stroke information corresponding to the trace information. Subsequently, in step 3312, the signal processing module may further interpret the trace information to generate input information.

FIG. 37 is a flow chart of a method of applying the trace-generating device for controlling/inputting information according to another example of the present invention. Referring to FIG. 37, the method of controlling/inputting information described in and in references to FIG. 37 may the same as or similar to the method of controlling/inputting information described in and in reference to FIG. 3, except that step 3312 may further include steps 3312-1 and 3312-2. The signal processing module may interpret the stroke information as at least one of a number, a word, a character, a punctuation, a mathematical operator, and a hand-written symbol in step 3312-1, and generate the trace information in step 3312-2.

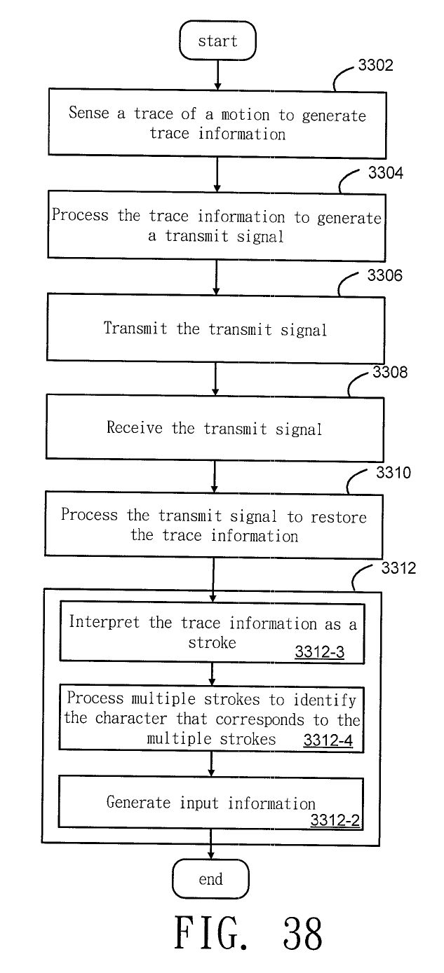

FIG. 38 is a flow chart of a method of applying the trace-generating device to a method of controlling/inputting information according to another example of the present invention. Referring to FIG. 38, the method of controlling/inputting information described in and in references to FIG. 38 may the same as or similar to the method of controlling/inputting information described in and in reference to FIG. 36, except that step 3312 may further include steps 3312-3, 3312-4 and 3312-2. In step 3312-3, the signal processing module may interpret the trace information as a stroke. The signal processing module may process multiple strokes in order to identify at least one of a number, a word, a character, a punctuation, a mathematical operator and a hand-written symbol that corresponds to the multiple strokes in step 3312-4, and generate the input information in step 3312-2.

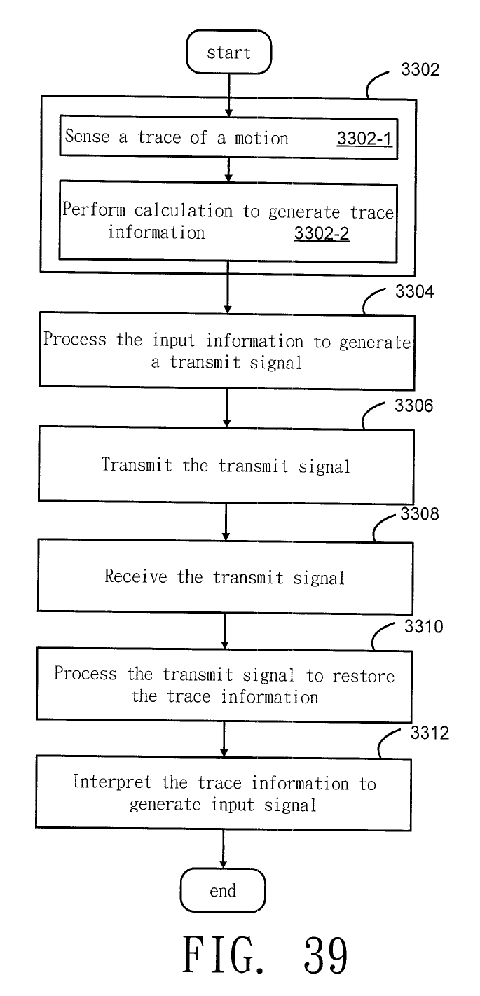

FIG. 39 is a flow chart of a method of applying the trace-generating device for controlling/inputting information according to another example of the present invention. Referring to FIG. 39, the method of controlling/inputting information described in and in references to FIG. 39 may the same as or similar to the method of controlling/inputting information described in and in reference to FIG. 36, except that step 3302 may further include steps 3302-1 and 3302-2. In step 3302-1, the trace-generating device may use a MEMS to detect a trace of the trace-generating device itself for generating the trace information. In one example, the MEMS may include an accelerometer and an electronic compass for detecting the changes in the coordinate of the trace-generating device. In step 3302-2, the trace-generating device may record the trace, in order to generate trace information.

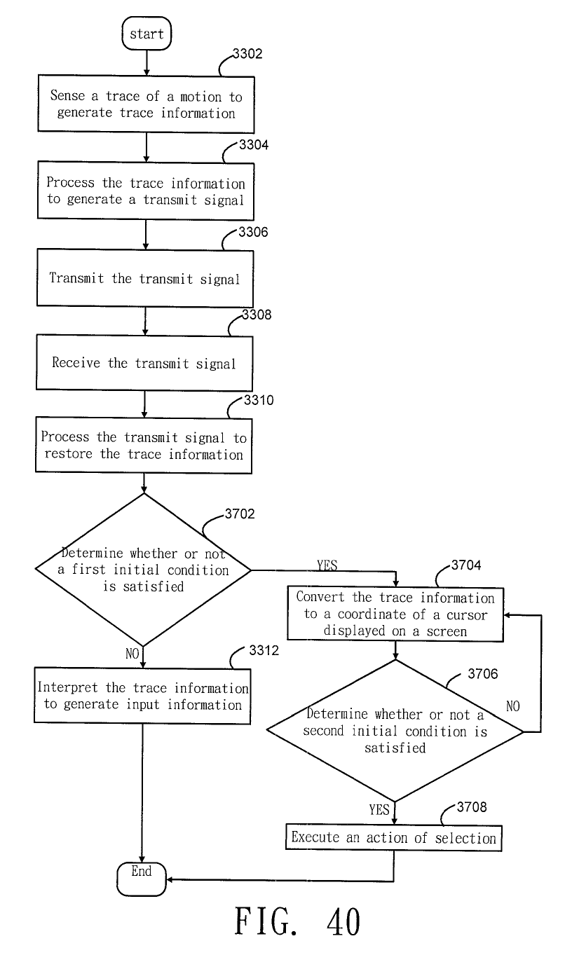

FIG. 40 is a flow chart of a method of applying the trace-generating device for controlling/inputting information according to another example of the present invention. Referring to FIG. 40, the method of controlling/inputting information described in and in references to FIG. 40 may be the same as or similar to the method of controlling/inputting information described in and in reference to FIG. 30, except that the method of controlling/inputting information described in and in reference to FIG. 33 further includes the steps of 3702, 3704, 3706 and 3708. After step 3310, in step 3702, the signal processing module may determine whether or not a first initial condition has been established. Similar to the steps in FIG. 36, if the first initial condition has not been established (NO), proceeds to steps 3312. If the first initial condition has been established (YES), proceeds to step 3704. In step 3704, the signal processing module may convert the trace information to coordinates of a position of a cursor displayed in a screen, so as to cause changes in the position of the cursor on the screen corresponding to the changes in the trace information. In one example, the first initial condition may indicate, as the input information, the trace information or the subsequent input (subsequent trace information generated based on the movement of the trace-generating device subsequent to the aforementioned trace information) by the user is for the purpose of moving the cursor or using the cursor to select an item displayed on the screen. Therefore, when the first initial condition is not established, the method of controlling/inputting information may be used for inputting a word or a symbol. On the contrary, when the first initial condition is established, the method of controlling/inputting information may be used for controlling the movement of the cursor and performing the action of making selections.

In another example, the method of controlling/inputting information may further include step 3706. In step 3706, the signal processing module may further determine whether or not a second initial condition has been established. If the second initial condition has not been established (NO), return to step 3704. If the second initial condition has been established (YES), proceed to step 3708. In this example, the second initial condition is for determining whether the trace information indicates the movement of the coordinates of the cursor (when the second initial condition is not established) or the cursor is being used for selecting an item displayed on the screen (when the second initial condition is established). In step 3708, when the second initial condition is established, the action of selecting is executed.

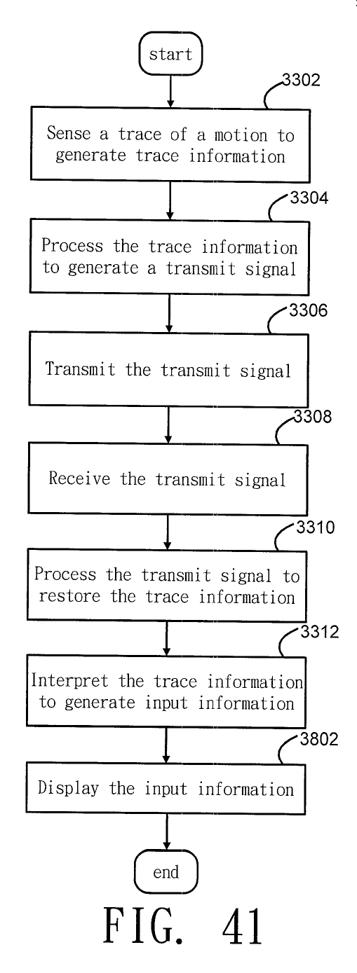

FIG. 41 is a flow chart of a method of applying the trace-generating device for controlling/inputting information according to another example of the present invention. Referring to FIG. 41, the method of controlling/inputting information described in and in references to FIG. 4I may the same as or similar to the method of controlling/inputting information described in and in reference to FIG. 36, except that the method of controlling/inputting information described in and in reference to FIG. 33 further includes the step of 3802. In step 3802, when a controlled module, which received the signal, generates the input information using the signal processing module, the controlled module may send the input information to a display device driving module so as to drive a display device to display the input information.

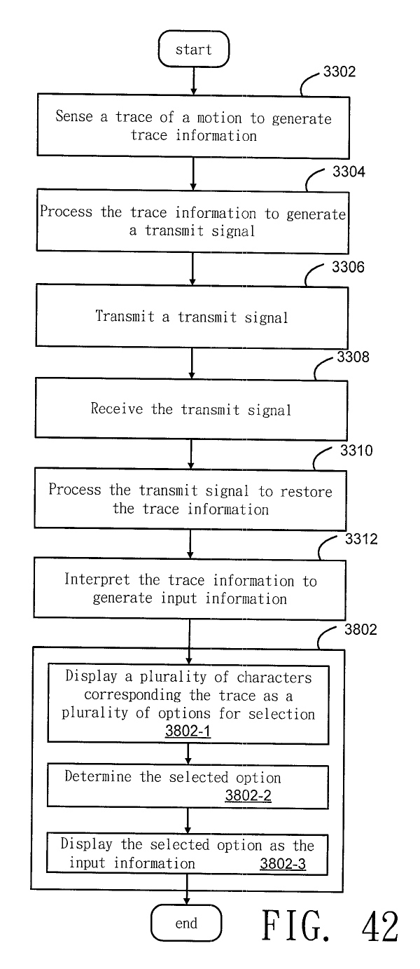

FIG. 42 is a flow chart of a method of applying the trace-generating device for controlling/inputting information according to another example of the present invention. Referring to FIG. 42, the method of controlling/inputting information described in and in references to FIG. 42 may the same as or similar to the method of controlling/inputting information described in and in reference to FIG. 36, except that step 3802 may further include steps 3802-1, 3802-2 and 3802-3. In step 3802-1, the display device may display at least a number of: a number of numbers, a number of words, a number of characters, a number of punctuations, a number of mathematical operators and a number of hand-written symbols, as a number of selecting options. Subsequently, in step 3802-2, the trace-generating device and the signal processing module or the controlled device will wait to receive a further input information from the user as a selection of one of the number of selecting options. Then, in step 3802-3, the display device displays the selected option as the input information.

One skilled in the art should be able to easily understand that when performing the aforementioned hand-writing recognition, it may not be necessary for the recognition program to have a library containing strokes of all possible characters, or a library, program or function for storing or interpreting all the possible changes in the coordinate, traces or paths.

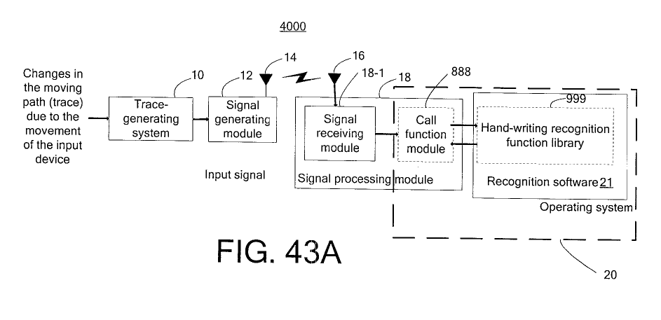

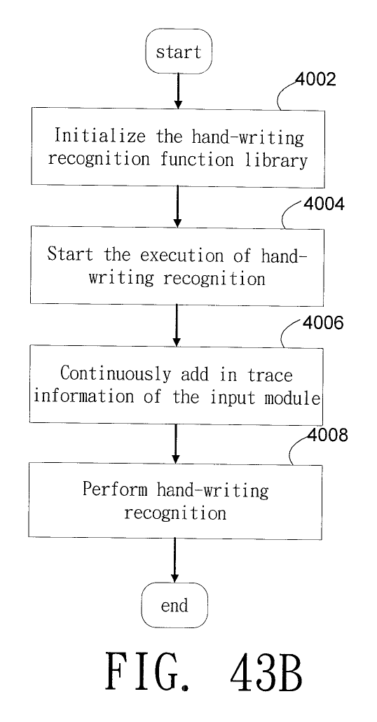

FIG. 43A is a schematic diagram of applying the trace-generating device to a control/information input system 4000 according to an example of the present invention. Referring to FIG. 43A, except that a signal processing module 18 of the control/information input system 4000 may include a signal receiving module 18-1 and a call function module 888, the control/information input system 4000 may be similar to the control/information input system 100b described in FIG. 1B, or be similar to other control/information input system described above. As shown in FIG. 43A, an operating system 20 (such as Windows Mobile 5.0 etc. known by one skilled in the art) may have a recognition software 21 (or hand-writing recognition function library 999) for Chinese, English, numbers or symbols built-in. In one example, the recognition software 21 may include a hand-writing recognition function library 999. In another example, the hand-writing recognition function library 999 may be included in the operating system 20. Therefore, the operating system 20 may have the function of performing hand-writing recognition on input characters. In this example, the call function module 888 may call the hand-writing recognition function library 999 to perform recognition on the digital signal sent to the call function module by the signal receiving module 18-1, so as to interpret the character, number or symbol corresponding to the trace information. In one example, the call function 888 may be executed in a C or C++ program, a eVC++ program or a .NET program of the operating system 20.

FIG. 43B is a flow chart of the operation of the signal processing module 18 of the control/information input system 4000 of the present invention as shown in FIG. 43A. Referring to FIG. 43B, the operation of the signal processing module 18 may include the call function module 888 initializing the hand-writing recognition function library 999 in step of 4002. Subsequently, in step 4004, with operating system 20, the recognition software 21 or the hand-writing recognition function library 999 starts to execute the hand-writing recognition function. Subsequently, in step 4006, the input module including the trace-generating device 10 and the signal generating module 12 continuously add trace information to the signal processing module 18. Finally, at step 4008, the recognition software 21 or the call function module 888, with the operating system 20, executes the hand-writing recognition library 999 for performing hand-writing recognition, so that the character, number or symbol corresponding to the trace information may be identified.

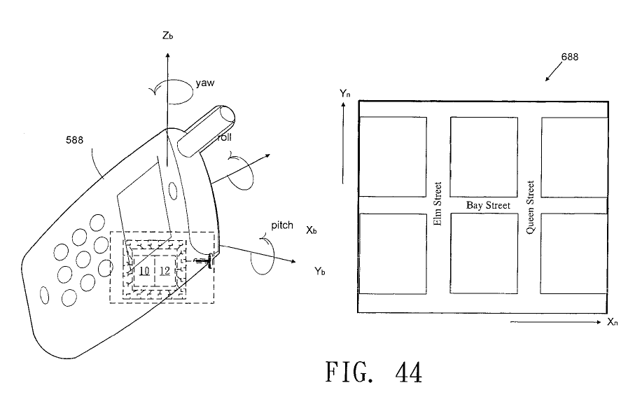

FIG. 44 is a schematic diagram of applying the trace-generating device 10 to assist a satellite navigation device. The satellite navigation device may include a cellular phone or a navigation device including a global positioning system (GPS). Referring to FIG. 44, when a user using the GPS of a cellular phone or navigation device enters a location that cannot be reach by the satellite signal or the assisted GPS signal, such as a tunnel or indoors (such as large shopping malls), the trace-generating device of the present invention may use the position, at which the satellite signal was last received or before the assisted GPS signal disappeared, as a starting point, convert the body frame of the cellular phone or the navigation device of the user to the navigation frame of a map (the map displayed by the cellular phone or the navigation device) and generate traces on the map, so as to achieve the function of assisting the satellite navigation device.

In other examples, one skilled in the art should be able to easily understand that the trace-generating device of the present invention may be worn on the head, body or limbs of the user in order to detect the movement changes of the respective body parts. Therefore, the trace-generating device of the present invention may be applied in the film industry, such as the making of 3D animations. For example, the trace-generating device of the present invention may be applied to simulating the movements and behaviors of a dummy or an actor. Furthermore, the trace-generating device of the present invention may be applied to human-machine interface related applications. For example, a person missing hands to hold a pen or use a keyboard or a remote control may wear the trace-generating device of the present invention on his wrist or other parts of his limbs, and carry out controls or enter information by moving these parts.

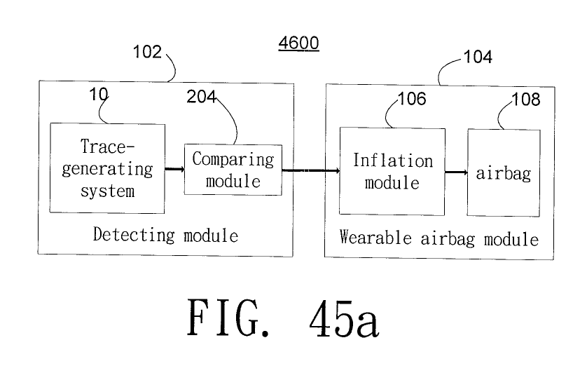

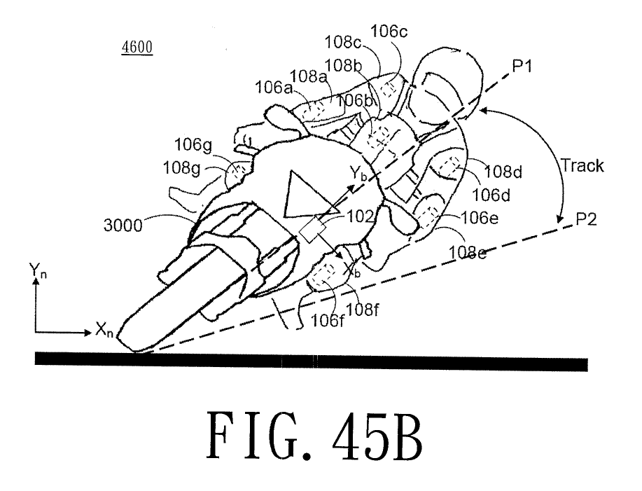

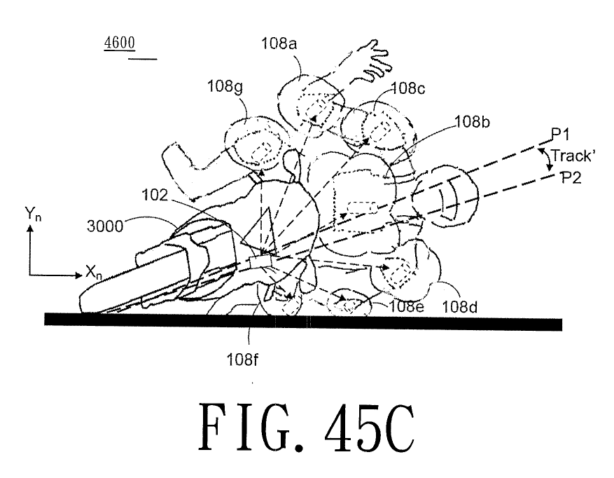

FIG. 45A is a schematic diagram applying the trace-generating device 10 to a wearable airbag protecting system 4600. Referring to FIG. 45A, the wearable airbag protecting system 4600 may include a detecting module 102 and a wearable airbag module 104. The detecting module 102 may include the trace-generating device 10 and a comparing module 204. The wearable airbag module 104 may include an inflation module 106 and an airbag 108. The trace-generating device may be used for measuring the trace (change in coordinates) in the tilt of a transportation (such as a motorcycle 3000, please refer to FIG. 45B), and generating trace information on the tilt (please refer to “Track” in FIG. 45B) for describing the tilt of the transportation. The comparing module 204 may be used for comparing the degree of the tilt to a tilt limit. The tilt limit may be, for example, the maximum tilt which the motorcycle 3000 may have or the limit the detecting module 102 may detect. When the tilt reaches or exceeds the tilt limit, the wearable airbag protecting system 4600 may cause the inflation module to inflate the airbag 108.

Referring to FIGS. 45B and 45C, FIGS. 45B and 45C are the schematic diagrams of the operation of the wearable airbag protecting system 4600 using the trace-generating device according to an example of the present invention.

Multiple wearable airbag modules may be worn on different body parts of a user in order to protect the respective body parts. The wearable airbag module may include inflation modules 106a, 106b, 106c, 106d, 106e, 106f and 106g, and airbags 108a, 108b, 108c, 108d, 108e, 108f and 108g. Using the trace-generating device 10 in the detecting module 102, the trace (or coordinates) generated by the tilt of a first imaginary sectional plane P1 of a motorcycle 300 may be measured. The comparing module 204 may compare to see if the trace arrives at or exceeds a reference point, such as a second imaginary plane P2. If, as shown in FIG. 45C, when the trace (or coordinate) arrives at or exceeds the second imaginary plane P2, the comparing module 204 may generate an inflation signal (as indicated by the unlabeled broken line), so the inflation modules 106a, 106b, 106c, 106d, 106e, 106f and 106g, will generate gas (not labeled) and inflate the airbags 108a, 108b, 108c, 108d, 108e, 108f and 108g, in order to protect the user. One skilled in the art should be able to easily understand that the first imaginary plane P1 may be any imaginary plane passing through the transportation vehicle, and the second imaginary plane P2 may be an imaginary plane corresponding to the tilt limit. The purpose of the invention is to measure the tilt of the transportation vehicle (motorcycle 3000). The scope of the present invention includes any methods that measures the tilt of any transportation vehicle (motorcycle 3000) and compare the tilt to a tilt limit, in order to determine whether or not to inflate the airbag of a wearable airbag module.

In addition, one skilled in the art should be able to easily understand that implementation method of the wearable airbag protecting system described above may be modified and applied to protective clothing of other transportations vehicles or for elderly/athletes, but is not limited to be used when riding a motorcycle.

In addition, in some of the explanatory examples of the present invention, the methods of the present invention may be described with specific steps. However, since the method is not limited to the specific order of the steps, the scope of the method should not be limited to the specific order of the steps. One skilled in the art should be able to easily understand that the method may be performed in other orders. Therefore, the order of the steeps described in the description should not be construed as a limit to the scope of the present invention. In addition, the scope of the present invention should not be limited to only the steps in the order described. One skilled in the art should be able to easily understand that the order of the steps may be changed and would still not depart from the essence and scope of the present invention.

One skilled in the art should be able to easily understand that the examples described above may be modified without departing from the concept of the present invention. Therefore, the present invention should not be limited to the examples described herein, but to the scope defined by the claim of the present application.

What is claimed is:

1. A trace-generating device for generating information on trace of motion, the device comprising:
a first module to calculate an initial roll angle (φ) and an initial pitch angle (θ) in response to an output of an accelerometer;
a second module to calculate an initial magnetic vector (\vec{m}ₙ) corresponding to a navigation frame of a controlled device located remote to the device in response to an output of an electronic compass, the initial roll angle and the initial pitch angle; and
a third module to calculate an estimated pitch angle and an estimated yaw angle in response to the output of the accelerometer, the output of the electronic compass, the initial roll angle and the initial pitch angle from the first module, and the initial magnetic vector from the second module.

2. The device of claim 1, which is configured to set an initial yaw angle (Ψ) to a constant or zero, wherein
the output of the accelerometer includes a first acceleration (aₓ^{b}) in an X_{b}-axis direction, a second acceleration (a_{y}^{b}) in a Y_{b}-axis direction, and a third acceleration (a_{z}^{b}) in a Z_{b}-axis direction, and
the output of the electronic compass includes a first terrestrial magnetism (mₓ^{b}) in the X_{b}-axis direction, a second terrestrial magnetism (m_{y}^{b}) in the Y_{b}-axis direction, and a third terrestrial magnetism (m_{z}^{b}) in the Z_{b}-axis direction, the X_{b}-axis direction, the Y_{b}-axis direction, and the Z_{b}-axis direction corresponding to directions of three-axes of a body frame of the device.

3. The device of claim 2, wherein the second module is further configured to calculate the initial magnetic vector in response the initial yaw angle, and the initial magnetic vector comprises a terrestrial magnetism (mₓⁿ) in an Xₙ-axis direction, a terrestrial magnetism (m_{y}ⁿ) in a Yₙ-axis direction, and a terrestrial magnetism (m_{z}ⁿ) in a Zₙ-axis direction, the Xₙ-axis direction, the Yₙ-axis direction, and the Zₙ-axis direction corresponding to directions of three-axes of the navigation frame of the controlled device.

4. The device of claim 3, wherein the third module further comprises a fourth module, a fifth module and a sixth module, and wherein
the fourth module is configured to receive a first estimated state vector ({right arrow over (\hat{X}ₖ₋₁) and a first estimated error covariance matrix (Pₖ₋₁) from the sixth module, set a first state vector (\vec{X}ₖ⁻) to be equal to the first estimated state vector, and calculate a second estimated error covariance matrix (Pₖ⁻) based on the first estimated error covariance matrix and at least one of a bias of the accelerometer and a bias of the electronic compass (Q);
the fifth module is configured to receive the first state vector and the second estimated error covariance matrix from the fourth module, and calculate a Kalman gain (Kₖ) based on the first state vector, the second estimated error covariance matrix, a measurement noise variance of the accelerometer and a measurement noise variance of the electronic compass (R); and
the sixth module is configured to calculate a second estimated state vector ({right arrow over (\hat{X}ₖ) based on at least one of the output of the accelerometer, the output of the electronic compass, the initial magnetic vector from the second module, or the first state vector, wherein the first estimated state vector comprises the first estimated pitch angle and the first estimated yaw angle, and calculate a third estimated error covariance matrix (Pₖ) based on the Kalman gain and the second estimated error covariance matrix.

5. The device of claim 4, wherein the third module is further configured to calculate the estimated pitch angle and the estimated yaw angle based on at least one of an accelerometer bias of the accelerometer or a compass bias of the electrical compass.

6. The device of claim 2, wherein the first module is configured to solve a first equation:
$$[ \begin{matrix}{a}_{x}^{b} \\ {a}_{y}^{b} \\ {a}_{z}^{b}\end{matrix} ] = [ \begin{matrix}cos θ & 0 & sin θ \\ sin φ sin θ & cos φ & - sin φ cos θ \\ - cos φ sin θ & sin φ & cos φ cos θ\end{matrix} ] [ \begin{matrix}0 \\ 0 \\ - g\end{matrix} ] = [ \begin{matrix}- g sin θ \\ g sin φ cos θ \\ - g cos φ cos θ\end{matrix} ]$$
where g is gravitational acceleration, in order to obtain an initial state vector (\vec{X}ₖ) including at least one of the initial roll angle, the initial pitch angle or the initial yaw angle.

7. The device of claim 6, wherein the initial magnetic vector comprises a terrestrial magnetism (mₓⁿ) in an Xₙ-axis direction, a terrestrial magnetism (m_{y}ⁿ) in a Yₙ-axis direction, and a terrestrial magnetism (m_{z}ⁿ) in a Zₙ-axis direction, the Xₙ-axis direction, the Yₙ-axis direction, and the Zₙ-axis direction corresponding to directions of three-axes of the navigation frame of the controlled device, and the second module is configured to solve a second equation:
$$[ \begin{matrix}{m}_{x}^{n} \\ {m}_{y}^{n} \\ {m}_{z}^{n}\end{matrix} ] = {[ \begin{matrix}cos θ & 0 & sin θ \\ sin φ sin θ & cos φ & - sin φ cos θ \\ - cos φ sin θ & sin φ & cos φ cos θ\end{matrix} ]}^{T} [ \begin{matrix}{m}_{x}^{b} \\ {m}_{y}^{b} \\ {m}_{z}^{b}\end{matrix} ] .$$

8. The device of claim 1, which is incorporated in one of a microcontroller, a digital signal processing (DSP) module and an Application-Specific Integrated Circuit (ASIC).

9. The device of claim 1, which is incorporated in one of a chip and a die, wherein the one of chip and the die is attachable to one of a wearable object including a bracelet, bangle, watch, finger stall, ring, cap, nose cover or earring, and a hand-held object including a pen, mouse, cellular phone or remote control.

10. The device of claim 1, wherein the controlled device includes one of a television, desktop computer, notebook computer, digital camera, camcorder, projector, mobile device, personal digital assistant, navigator, media player, E-book reader, portable computer display, information appliance, portable music player, TV gaming console, hand-held gaming console, electronic dictionary and computer in a car television.

11. A trace-generating device for generating information on trace of motion, the device comprising:
a first module configured to calculate an initial roll angle (φ) and an initial pitch angle (θ) in response to an output of an accelerometer;
a second module configured to calculate an initial magnetic vector (\vec{m}ₙ) corresponding to a navigation frame of a controlled device located remote to the device in response to an output of the electronic compass, the initial roll angle and the initial pitch angle; and
a third module configured to calculate an estimated pitch angle and an estimated yaw angle in response to an output of a 1-D gyroscope, the output of the accelerometer, the output of the electronic compass, the initial roll angle and the initial pitch angle from the first module and the initial magnetic vector from the second module.

12. The device of claim 11, which is configured to set an initial yaw angle (Ψ) to a constant or zero, wherein the output of the accelerometer includes a first acceleration (aₓ^{b}) in an X_{b}-axis direction, a second acceleration (a_{y}^{b}) in a Y_{b}-axis direction, and a third acceleration (a_{z}^{b}) in a Z_{b}-axis direction;
the output of the electronic compass includes a first terrestrial magnetism (mₓ^{b}) in the X_{b}-axis direction, a second terrestrial magnetism (m_{y}^{b}) in the Y_{b}-axis direction, and a third terrestrial magnetism (m_{z}^{b}) in the Z_{b}-axis direction; and
the output of the 1-D gyroscope includes a roll angle about the X_{b}-axis direction, the X_{b}-axis direction, the Y_{b}-axis direction, and the Z_{b}-axis direction correspond to directions of three-axes of a body frame of the device.

13. The device of claim 11, wherein the second module is further configured to calculate the initial magnetic vector based on the initial yaw angle, and the initial magnetic vector comprises a terrestrial magnetism (mₓⁿ) in an Xₙ-axis direction, a terrestrial magnetism (m_{y}ⁿ) in a Yₙ-axis direction, and a terrestrial magnetism (m_{z}ⁿ) in a Zₙ-axis direction, the Xₙ-axis direction, the Yₙ-axis direction, and the Zₙ-axis direction corresponding to directions of three-axes of the navigation frame of the controlled device.

14. The device of claim 13, wherein the third module further comprises a fourth module, a fifth module and a sixth module, and wherein the fourth module is configured to receive a first estimated state vector ({right arrow over (\hat{X}ₖ₋₁) and a first estimated error covariance matrix (Pₖ₋₁) from the sixth module, set a first state vector (\vec{X}ₖ⁻) to be equal to the first estimated state vector, and calculate a second estimated error covariance matrix (Pₖ⁻) based on the first estimated error covariance matrix and at least one of a bias of the accelerometer and a bias of the electronic compass (Q);
the fifth module is configured to receive the first state vector and the second estimated error covariance matrix from the fourth module, and calculate a Kalman gain (Kₖ) based on the first state vector, the second estimated error covariance matrix, a measurement noise variance of the accelerometer and a measurement noise variance of the electronic compass (R); and
the sixth module is configured to calculate a second estimated state vector ({right arrow over (\hat{X}ₖ) based on at least one of the output of the 1-D gyroscope, the output of the accelerometer, the output of the electronic compass, the initial magnetic vector from the second module, and the first state vector, wherein the first estimated state vector comprises the first estimated pitch angle and the first estimated yaw angle, and calculate a third estimated error covariance matrix (Pₖ) based on the Kalamn gain and the second estimated error cavoariance matrix.

15. The device of claim 14, wherein the third module is further configured to calculate the estimated pitch angle and the estimated yaw angle based on at least one of an accelerometer bias of the accelerometer, a compass bias of the electrical compass and a gyroscope bias of the 1-D gyroscope.

16. The device of claim 12, wherein the first module is configured to solve a first equation:
$$[ \begin{matrix}{a}_{x}^{b} \\ {a}_{y}^{b} \\ {a}_{z}^{b}\end{matrix} ] = [ \begin{matrix}cos θ & 0 & sin θ \\ sin φ sin θ & cos φ & - sin φ cos θ \\ - cos φ sin θ & sin φ & cos φ cos θ\end{matrix} ] [ \begin{matrix}0 \\ 0 \\ - g\end{matrix} ] = [ \begin{matrix}- g sin θ \\ g sin φ cos θ \\ - g cos φ cos θ\end{matrix} ]$$
where g is gravitational acceleration, in order to obtain an initial state vector (\vec{X}ₖ) including at least the initial roll angle, the initial pitch angle and the initial yaw angle.

17. The device of claim 16, wherein the initial magnetic vector comprises a terrestrial magnetism (mₓⁿ) in an Xₙ-axis direction, a terrestrial magnetism (m_{y}ⁿ) in a Yₙ-axis direction, and a terrestrial magnetism (m_{z}ⁿ) in a Zₙ-axis direction, the Xₙ-axis direction, the Yₙ-axis direction, and the Zₙ-axis direction corresponding to directions of three-axes of the navigation frame of the controlled device, and the second module is configured to solve a second equation:
$$[ \begin{matrix}{m}_{x}^{n} \\ {m}_{y}^{n} \\ {m}_{z}^{n}\end{matrix} ] = {[ \begin{matrix}cos θ & 0 & sin θ \\ sin φ sin θ & cos φ & - sin φ cos θ \\ - cos φ sin θ & sin φ & cos φ cos θ\end{matrix} ]}^{T} [ \begin{matrix}{m}_{x}^{b} \\ {m}_{y}^{b} \\ {m}_{z}^{b}\end{matrix} ] .$$

18. The device of claim 11, which is incorporated in one of a microcontroller, a digital signal processing (DSP) module and an Application-Specific Integrated Circuit (ASIC).

19. The device of claim 11, which is incorporated in one of a chip and a die, wherein the one of chip and the die is attachable to one of a wearable object including a bracelet, bangle, watch, finger stall, ring, cap, nose cover or earring, and a hand-held object including a pen, mouse, cellular phone or remote control.

20. The device of claim 11, wherein the controlled device includes one of a television, desktop computer, notebook computer, digital camera, camcorder, projector, mobile device, personal digital assistant, navigator, media player, E-book reader, portable computer display, information appliance, portable music player, TV gaming console, hand-held gaming console, electronic dictionary and computer in a car television.
